(19) United States
(12) Patent Application Publication
(10) Pub. No.: US 2008/0065532 A1
(43) Pub. Date: Mar. 13, 2008

(54) REVENUE-PRODUCING BANK CARD SYSTEM & METHOD PROVIDING THE FUNCTIONALITY & PROTECTION OF TRUST-CONNECTED BANKING

(76) Inventor: Alan L. De La Motte, Hillsboro, OR (US)

Correspondence Address: KOLISCH HARTWELL, P.C., 520 SW YAMHILL STREET, Suite 200, PORTLAND, OR, 97204, US

(21) Appl. No.: 11/754,287

(22) Filed: May 26, 2007

Related U.S. Application Data
(63) Continuation-in-part of application No. 11/478,519, filed on Jun. 28, 2006.
Application No. 11/478,519 is a continuation of application No. 11/286,261, filed on Nov. 22, 2005, now abandoned.
(60) Provisional application No. 60/654,208, filed on Feb. 17, 2005.
(60) Provisional application No. 60/630,234, filed on Nov. 22, 2004.
(60) Provisional application No. 60/630,233, filed on Nov. 22, 2004.

(51) Int. Cl. G06Q 40/00

(52) U.S. Cl. 705/39

(57) ABSTRACT

A revenue-producing, charge card system also manages account balances to create an investment profit for the card holder. A trust account has a trust-account balance reflecting a first amount of funds, is constructed to subsequently record debits and credits related to the balance, and is constructed for access via remote communication. A bank account has a bank-account balance reflecting an initial zero balance, is constructed to further record debits and credits related to the balance, and is constructed for access via remote communication. A debit card is constructed for communication with the trust account and the bank account, and a switch is in communication with the trust account and bank account. The trust account and the bank account are constructed for intercommunication via the switch so that a card user can pass debits and credits to the trust account through the bank account so that the funds of the trust account can be managed via the trust account. There are also methods of producing revenue thorough a charge card, a revenue-producing machine for users who have bank accounts, and a revenue-producing, debit-card system for a user who has a bank account that is connected to a trust-like structure combined with a debit card connected to the trust-like structure. In addition, there is a controller, for a networked trust account and a networked bank account that are capable of communicating via a network, that maximizes revenue to the holder of both accounts, and a corresponding method. In addition, there is a principal-protected, revenue-producing investment system, an international financial system, and a method of providing an alternative international fiduciary financial system.

### CROSS-REFERENCE TO RELATED APPLICATIONS

This application is a continuation-in-part of U.S. patent application Ser. No. 11/478,519, filed Jun. 28, 2006 and entitled “Trust-connected Debit Card Technology”, which application is a continuation of U.S. patent application Ser. No. 11/286,261, filed Nov. 22, 2005 and entitled “Trust-Linked Debit Card Technology”, which paragraphs priority to U.S. Provisional Patent Application Ser. No. 60/654,208, filed Feb. 17, 2005 and entitled “System & Method for a Non-Banking Entity: (A) to Issue Bank Debit Cards to Customers Via the Issuance and Sale of Card-Linked Notes, and (B) to Control, for Investment Purposes, the Daily Float of the Aggregate Cash Deposits Maintained on Account, While Offering Card Customers 100% Protection Against Loss of Principal Through an Institutional Trust Arrangement; U.S. Provisional Patent Application Ser. No. 60/630,234, filed Nov. 22, 2004 and entitled “System & Method to Cause a Low-Risk Home Equity Loan to be Made to a Homeowner Where the Loan Proceed is Invested Wholly on Partially Through a Trust Arrangement so that the Investment Profits can then be Used to Automatically Repay the First Mortgage and the Home Equity Loan. The Positive Differential Assured Between the Low Interest Cost of the Loan and the Return on Investment is Used to Reduce the Homeowner's Debts” and U.S. Provisional Patent Application Ser. No. 60/630,233, filed Nov. 22, 2004 and entitled “System & Method for a Non-Banking Entity (e.g. A Card Issuer): (A) to Issue Bank Debit Cards or Stored Value Cards to Customers; and (B) to Control, for Investment Purposes, the Daily Float of the Aggregate Cash Deposits Maintained on Account, While Offering Card Customers 100% Protection Against Loss of Principal Through a Bank Trust Arrangement”.

### TECHNICAL FIELD

The present invention relates generally to international finance and investment, banking, and the use of bank cards

### BACKGROUND

How Banks Operate:

The central bank of every country is interconnected via its membership in the Bank of International Settlement (BIS) in Basel, Switzerland. The BIS provides settlement services between each country's central bank via each central bank's account with the BIS.

Each country's central bank licenses the country's wholesale and retail banks to distribute money into the economy through loans that can then be discounted to create liquidity. Each wholesale and retail bank is required to maintain a reserve account with the central bank in which they are required to leave a reserve deposit.

When banks make loans, they effectively serve as agents of the central bank to put new money into circulation in the economy. A central bank's discounting process allows a wholesale or retail bank to borrow against a tangible property it receives as collateral for a loan (for US banks, see the “Borrower in Custody” program of the New York Federal Reserve Board).

Loans deplete a bank's liquidity, leading them to refinance themselves either by borrowing from other banks that offer their excess liquidity through the overnight LIBOR market, or they can directly discount their assets (collateral) with a loan obtained directly from the country's central bank.

Banks' primary revenues are from making loans at an interest that is greater than their cost of money. Loans normally require a security interest in some form of collateral of the borrower (e.g. real estate). Thus banks technically act as loan agents and aggregators of tangible assets (wealth) for a country's central bank.

Interest rates are set around the world by central bankers. Interest rates fluctuate daily for each currency based on supply and demand, and on the basic economic performance of a country as evidenced by locally published indicators. Differing country's interest rates provide cross-currency arbitrage opportunities such as the interest rate charged for loans in a particular country compared to that offered for investments in another. The exploitation of such arbitrage opportunities has historically been only the purview of financial institutions, including securities firms and in recent years, certain hedge funds that are sufficiently sophisticated to exploit the opportunities for profit.

How Banks Make Money & What Risks are Associated with Bank Deposits

Debit cards have replaced checks as the most convenient and secure access to bank depositors' funds at automatic teller machines (“ATMs”) and direct purchases for two primary reasons: 1) it is faster and more convenient 2) it is safer than carrying cash. Debit card usage now represents 60-70% of all card (debit or credit) transactions worldwide.

Though debit cards offer convenient and secure services to account holders, debit card users rarely receive interest on their checking account balances, and if they do, it is usually minimal. However bank customers still have to pay monthly service charges, overdraft fees, returned check fees and a variety of other fees that fuel banking profits.

In addition, the aggregation of these same account balances allow banks worldwide to invest depositors' funds through loans at rates not only sufficiently high to cover the bank's cost of funds and operating expenses, but also yield profits that would surprise the most sophisticated bank depositor . . . yet rarely are any of these profits shared with a bank's customers.

The very significant profits banks earn are made possible by 1) the ability they have to treat a customer deposit (a liability to the bank) as an asset of the bank and 2) access to the fractional reserve banking (“FRB”) system afforded banks by the central bank. FRB allows banks to keep only a certain percentage of their deposits “on reserve” (e.g. 10% to pay depositors when they demand their funds) while the balances may be loaned or invested.

FRB allows banks to earn significant profits through the application of two principles of banking: (a) leverage (currently 10:1 in the USA; 20:1 in Canada; 12.5:1 in Europe, etc) of depositor funds that can be loaned and (b) favorable interest rate differences or, the “discounting” of loans at an interest rate that is lower (the wholesale rate at which a bank borrows from its Central Bank) than the rate at which funds are lent or placed into the market (retail rate).

For example, a $1,000 deposit in a US non-interest bearing checking account can be leveraged ten times (10:1 leverage) by the bank through the FRB process. FRB allows central bankers to stimulate or slow down a country's economy by lowering or raising the interest rate charged its member banks, without significantly impacting a bank's ability to make significant profits. The compounding of the leverage and discounting principals result in huge profits for the banking industry, assuming that loan defaults are minimized.
As an example, a bank receives deposits of $1000, for which it may pay a minimal interest rate (3%) and lends out $900 (at 6%) which the borrower then deposits in the bank. This $900 deposit qualifies as a new deposit that can be lent by the bank after the $100 (reserve set aside). Were all the initial transactions related to the $1000 kept in the same bank, the deposits at 3% and loans at 6% would generate significant profits for the bank (Loans $900, $810, $729, $656, $590, $531, $478, $430, $387, $348, $314, $282).

In this example, after payment of a one time 3% for deposits, the return on a $1000 initial deposit is $462 to the banking system. Thus we see that it is the process of loaning money that gives justification to the printing of new money that is then placed in circulation. Thus the central banks, operating through their member banks, distributes money into the economy through the lending that occurs at the wholesale and retail banking levels. The business of printing money at minimal costs and lending it out at interest is indeed the most profitable business there is.

| Initial | Interest | | Fractional | Loan | Interest |
|---|---|---|---|---|---|
| Deposit | Paid | Loan % | Reserve | Amounts | Charged |
| | 3.00% | | | | 6.00% |
| $1,000.00 | $30.00 | 90% | $100.00 | $900.00 | $54.00 |
| $900.00 | ASSUMES A $1,000 ONE YEAR CD | 90% | $90.00 | $810.00 | $48.60 |
| $810.00 | THAT PAYS 3% INTEREST P.A. | 90% | $81.00 | $729.00 | $43.74 |
| $729.00 | | 90% | $72.90 | $656.10 | $39.37 |
| $656.10 | | 90% | $65.61 | $590.49 | $35.43 |
| $590.49 | | 90% | $59.05 | $531.44 | $31.89 |
| $531.44 | | 90% | $53.14 | $478.30 | $28.70 |
| $478.30 | | 90% | $47.83 | $430.47 | $25.83 |
| $430.47 | | 90% | $43.05 | $387.42 | $23.25 |
| $387.42 | | 90% | $38.74 | $348.68 | $20.92 |
| $348.68 | | 90% | $34.87 | $313.81 | $18.83 |
| $313.81 | | 90% | $31.38 | $282.43 | $16.95 |
| $282.43 | | 90% | $28.24 | $254.19 | $15.25 |
| $254.19 | | 90% | $25.42 | $228.77 | $13.73 |
| $228.77 | | 90% | $22.88 | $205.89 | $12.35 |
| $205.89 | | 90% | $20.59 | $185.30 | $11.12 |
| $185.30 | | 90% | $18.53 | $166.77 | $10.01 |
| $166.77 | | 90% | $16.68 | $150.09 | $9.01 |
| $150.09 | | 90% | $15.01 | $135.09 | $8.11 |
| $135.09 | | 90% | $13.51 | $121.58 | $7.29 |
| $121.58 | | 90% | $12.16 | $109.42 | $6.57 |
| $109.42 | | 90% | $10.94 | $98.48 | $5.91 |
| $98.48 | | 90% | $9.85 | $88.63 | $5.32 |
| etc. | | | etc. | etc. | etc. |
| | $30.00 | | $911.37 | $8,202.34 | $492.14 |
| | | | | Profit . . . | $462.14 |

In this example, the profit to the banks is a rather significant 46.2% on depositors' funds. Yet banks do not share this level of profit, even with their most wealthy customers.

Understanding the backdrop against which this invention plays out is important because it demonstrates the following principles which are addressed and solved by this invention to the benefit of the consumer:
1. Banks need depositors' money so that they can lend it out at a profit.
2. Banks naturally assume loan risks with depositors' funds and there is always a risk that a bank might make bad loans that lead to insolvency.
3. Banks refinance themselves first by borrowing money from each other. One bank that has excess liquidity agrees to lend its excess to another bank that has a need for it. The London Inter-Bank Overnight Rate (LIBOR) exchange exists for banks to be able to place bid and ask offers.
4. Banks may also borrow money from its central bank under the “Borrower in Custody” program which allows banks to pledge securities to the central bank in exchange for a loan that slightly discounts its assets (e.g. pledged assets) based on the inherent credit risk.
5. Because banks are highly leveraged and the leverage is mostly “at-risk,” a depositor automatically assumes the indirect risk that the bank might make enough bad loans and thereby become insolvent; in which case the depositor is only insured for up to $100,000 in the US and C$65,000 in Canada. Any depositor with balances over and above the insured threshold is treated by bankruptcy courts as a general creditor and whose paragraph is second to secured creditors. Even in instances of “full deposit insurance,” there is always the potential for the insurer to drag out the time between a paragraph and actual payment, thus unduly depriving the account holder of the immediate access to funds on call in the holder's account.

One bank's recent marketing ploy was summarized in the slogan,: “When banks compete, you win.” The consumer is left with the question, “win what”

The implementation of this invention by sponsors/licensees worldwide will effectively block or at least limit banks the ability to book depositors' funds as their own asset available for loans and for leverage. When this happens, inexpensive, to the bank, depositors' funds will cease, increasing the need for banks to increase the price for those funds needed for overnight and longer term financing. When this happens consumers will have the competitive edge in consumer-bank relationships. No longer will depositors be satisfied with “free checking” and/or a toaster oven in exchange for a $10,000 three month certificate of deposit. Banks will be forced to compete with hedge fund-like returns produced by the trusts.

Individually consumers have no chance of changing a powerful global banking monopoly. However, if enough consumers switch from a debit card to a Trust-Connected Card™, bankers who have heretofore operated under the protection of a tight fisted monopoly will have to start competing for funds by bidding against their colleagues for excess aggregated cash only available via the trusts. When this happens it is the trust beneficiaries, the holders of the Trust-Connected Card™s, who will win since they receive a share of profit in the form of monthly dividends.

Through the power of amalgamated trust funds, not only are consumers completely protected from the risk of bank insolvency or the collapse of banks, but they now have the ability to become, indirectly through the trust, a special group private banking client of banks worldwide, who will vie for this business, a privilege that heretofore only the very rich and powerful citizens of the world have enjoyed.

How Current Bank-Issued Debit Cards Work

Debit cards are linked to regular demand deposit checking accounts, in which debits (charges) and credits (deposits) are posted directly to the card holder's account at the bank. In that account balances are considered assets of the bank, banks profit from their customers' deposits as explained above.

As “demand deposits,” these funds can be called at anytime, but once deposited these funds become an asset of the bank, fully available to the bank to aggregate, loan, and/or invest.

Debit cards have replaced checks as the most convenient, secure access to demand deposits via automatic teller machines (“ATMs”) and direct purchases for two primary reasons: 1) Faster and more convenient 2) safer than carrying cash. Debit card usage now represents 60-70% of all card (debit or credit) transactions worldwide.

Though debit cards offer convenient and secure services to account holders, debit card users rarely receive any interest on their account balances, and in some instances still pay monthly service charges.

However, the aggregation of these same account balances allow banks worldwide to invest depositors' funds through loans at rates sufficiently high to cover the bank's cost of funds and operating expenses, plus yield profits (as noted above) that would surprise the most sophisticated bank depositor . . . yet rarely are any of these profits shared with a bank's customers.

### SUMMARY OF THE INVENTION

The invention may be summarized as a revenue-producing, charge card system that also manages account balances to create an investment profit for the card holder. A trust account has a trust-account balance reflecting a first amount of funds, is constructed to subsequently record debits and credits related to the balance, and is constructed for access via remote communication. A bank account has a bank-account balance reflecting an initial zero balance, is constructed to further record debits and credits related to the balance, and is constructed for access via remote communication. A debit card is constructed for communication with the trust account and the bank account, and a switch is in communication with the trust account and bank account. The trust account and the bank account are constructed for intercommunication via the switch so that a card user can pass debits and credits to the trust account through the bank account so that the funds of the trust account can be managed via the trust account.

In a second embodiment, the invention is a method of producing revenue through a charge card method that also manages account balances to create an investment profit for the card holder. The method includes forming a trust account that has a trust-account balance reflecting a first amount of funds, is constructed to subsequently record debits and credits related to the balance, and is constructed for access via remote communication. The method also includes the steps of using a bank account that has a bank-account balance reflecting an initial zero balance, is constructed to further record debits and credits related to the balance, and is constructed for access via remote communication, and making a debit card constructed for communication with the trust account and the bank account. Also included is the step of configuring a switch in communication between the trust account and bank account. The trust account and the bank account are constructed for intercommunication via the switch so that a card user can pass debits and credits to the trust account through the bank account so that the funds of the trust account can be managed via the trust account.

A third embodiment of the invention is a revenue-producing machine for users who have bank accounts. The machine includes (i) a trust-account component that has daytime and overnight balances, is configured to allow balances to be invested, and includes a user-specific trust sub-account that is configured to provide cash required to settle transactions of the user, and (ii) a transaction actuator connected to the trust account and constructed to allow a user to make transactions chosen from the group consisting of debit and credit transactions.

A fourth embodiment of the invention is a revenue-producing, debit-card system for a user who has a bank account that is connected to a trust-like structure combined with a debit card connected to the trust-like structure.

A fifth embodiment of the invention is a controller, for a networked trust account and a networked bank account that are capable of communicating via a network, that maximizes revenue to the holder of both accounts. The controller includes an account actuator, and both can be constructed using software, firmware, hardware, or a combination thereof. The account actuator is constructed to communicate with the trust account and bank account as the holder desires so that the holder can actuate both via the network to make transactions. The controller may also include a trust-account originator and a bank-account originator.

A sixth embodiment of the invention is a method of maximizing revenue to the holder of a networked trust account and a networked bank account that are capable of communicating via a network. This method includes the steps of selecting a networked trust account and a networked bank account, and making and using a controller for maximizing revenue to the holder of both accounts. The making step may include constructing an account actuator to communicate with the trust account and bank account as the holder desires so that the holder can actuate both via the network to make transactions. The method may further including originating a trust account and originating a bank account.

A seventh embodiment of the invention is a principal-protected, revenue-producing investment system that includes the following components: (i) an investment mechanism consisting of a unit-participation trust having funds to invest and being divisible into plural trust units, each being ownable by a trust unit holder, (ii) a master trust that includes plural sub-trusts, (iii) a funds-flow mechanism constructed to permit the pooling of investment funds from the sub-trusts to the master trust, (iv) a trust-ownership-conversion structure that converts ownership units into any number of demand deposit sub-accounts and nested sub-accounts, (v) an ownership-interest-determining mechanism for computing the beneficial ownership interest of each trust unit holder at any point in time and for apportioning profits proportionally to trust unit holders, and (vi) an implementation mechanism in communication with the investment mechanism, the master trust, the funds-flow mechanism, the trust-ownership-conversion structure and the ownership-interest-determining mechanism to provide for investment of funds that produce revenue.

The implementation mechanism of the seventh embodiment may include: (i) a selection subsystem for selecting and appointing plural investment professionals for the funds on deposit in the trust and its sub-trusts, (ii) an allocation system for allocating pooled trust assets to plural investment managers, and (iii) a rule-based controller constructed to govern all investment functions according to pre-selected rules.

An eighth embodiment of the invention is an international financial system that includes: (i) trust structure that has daytime and overnight balances available for investment purposes, (ii) network-communication structure that is constructed to allow national and international communication between the trust structure and conventional banks having plural bank accounts, and (iii) transaction-communication structure connected to the trust structure and constructed for communication via the network-communication structure. The trust structure can be configured to allow balances to be invested, the network-communication structure affords communication to and from a bank account of one of the conventional banks, and the bank account is configured for pass-through activity to provide a net-zero-balance feature. The trust structure includes a user-specific sub-structure that is configured to handle cash, and the user-specific sub-structure is configured to provide cash required to settle charges resulting from transactions of the user, and to credit the user-specific sub-account.

A ninth embodiment of the invention is a method of providing an alternative international fiduciary financial system that manages investments and risks associated with the transfer of funds between different entities while enabling non-banking entities to provide traditional banking services without violating per say national and international banking laws. The method includes the steps of: (i) providing plural unit participation trusts, with having a trust corpus, having similar terms and conditions defined in a trust agreement, being configured as sub-trust accounts of a trust, and being connected to corresponding bank accounts, with the corresponding bank accounts being further connected to corresponding check writing facilities and debit cards, (ii) supplying plural account holders, (iii) configuring trust units as plural units of ownership of the trust, and (iv) selecting plural trust beneficiaries, and constructing at least one sub-trust with choosing plural service providers to the trust and a non-bank promoter of the trust.

### BRIEF DESCRIPTION OF THE DRAWINGS

FIGS. 1-6 are schematic and descriptive flow diagrams useful for understanding the first, second, fourth and eighth embodiments of the invention.

FIGS. 7-9 are schematic and descriptive flow diagrams useful for understanding the third, fifth, and sixth embodiments of the invention.

FIGS. 10-15 are schematic and descriptive flow diagrams useful for understanding the seventh embodiment of the invention.

FIGS. 16-24 are schematic and descriptive flow diagrams useful for understanding the ninth embodiment of the invention.

Attachment A is a copy of the text and drawings from co-pending U.S. patent application Ser. No. 11/478,519, filed Jun. 28, 2006 and entitled “Trust-connected Debit Card Technology”.

Attachment B is a document that provides further details of the rule-based controller and rules for determining permitted investments using the systems and methods of the invention.

Attachment C is a document that provides an example of an application of the systems and methods of the invention showing specifically a principal protected day trade involving a repo and reverse repo strategy with leverage and hedging.

### DESCRIPTION OF THE PREFERRED EMBODIMENT

Prior to describing the above figures, several sections follow to provide an overview of the invention, a glossary of terms, and preliminary descriptions of various features of the invention such as the trust (also referred to herein as trust structure) component.

From an overview, the invention involves a system for managing funds to earn a profit on idle funds. In one embodiment, the system of the invention uses a trust account, a debit card and a bank account to accomplish its purpose. For this particular embodiment, the debit card is connected to the bank account. However, the trust account and the bank account are further connected so as to pass debits and credits between the debit card and the trust account via the bank account. In this manner, any funds to be managed are managed via the trust account while the bank account functions on the front line to meet all regulatory banking rules and laws for the issuance of traditional demand deposit bank accounts with the distribution of a debit card that is connected to that bank account.

In another embodiment, the invention includes a switch, which may be implemented in any suitable manner, including hardware, software, firmware or any combination thereof. In this embodiment, credits and debits directed to the bank account are redirected, or routed, to the trust account. For example, if one were to make a purchase using a debit card, the debit would be routed to the connected bank account following conventional procedures. However, in this embodiment, a novel switch reroutes the debit to the trust account for further processing as described below.

The switch may be accomplished, for example, by a mechanism in which, when a debit is incurred via use of a debit card, the connected accounts are checked to see which accounts have funds available. In this embodiment, the bank account is maintained at a zero balance, and therefore the debit is routed instead to an account with a positive balance, i.e. the corresponding trust account.

In another embodiment, a debit card may be issued in the name of any non-banking entity. For example, the non-banking entity may comprise at least one of the following: an individual, a non-profit entity; a for-profit entity; or a government entity. For example, a for-profit entity could be an employer and the debit card would be issued to an employee of the employer. Likewise, the debit card may be set up to allow the employee to charge business travel expenses to the employer. In another embodiment, a debit card may be issued in the name of any non-banking entity and co-branded with the name of the bank issuing the debit card. In this embodiment, therefore, any non-banking entity can take on aspects similar to a bank with incurring the associated regulatory overhead.

It is noted that for this particular embodiment, the trust account is set up to allow funds of the trust to be invested in so-called, to-be-described “permitted investments”, at least during banking hours. However, the trust account is also set up to allow funds that remain in the trust account outside banking hours to be swept out for short term investment and swept back to the account by the opening of the next banking day, for example. It is noted that non-banking hours include evenings, weekends and legal holidays during which funds or moneys belonging to the trust can earn interest and profits in the same way that banks currently profit from the use of their customers' aggregated demand deposit account balances.

For this particular embodiment to operate effectively, the bank account, the debit card and the trust account are connected, or otherwise in communication, via a system infrastructure. Furthermore, and although above the trust account was described as being connected to a bank account, the invention can also be designed with one or more user-specific sub-trust accounts that are each configured to post debits and/or credits to the sub-trust account. In this situation, the sub-trust account, rather than the trust account, is connected to a bank account and debit card. More specifically, in this particular embodiment, the sub-trust account is set up to post credits for at least one of the following: cash, cash equivalent marketable instruments, securities, non-liquid assets, or any combination thereof. Likewise, in many instances, credits of cash can include regularly recurring deposits, such as for example, payroll check deposits or social security check deposits.

In the embodiment described above, one advantage of a user-specific sub-trust account includes having the capability to provide for the withdrawal of cash to settle charges resulting from purchase transactions executed via the debit card., such as alluded to by example above. More specifically, again, as alluded to previously, a bank account is set up to book a debit from the use of the debit card and to also book simultaneously an offsetting credit from the corresponding sub-trust account so that the balance in the bank account shows a zero balance. Of course, in an alternative embodiment, the bank account might simply maintain a consistent minimum positive balance or merely a consistent balance without loss of generality. Likewise, even assuming the balance changes, offsetting adjustments may be made to correctly account for this, if desired. Another advantage of this particular embodiment is that the bank account may be further set up to report information regarding debit card usage for the debit card linked to that bank account, which may be convenient at times. Likewise, the bank account may be further set up to report all debit card transactions for the debit card linked to that bank account on a regularly recurring basis, such as weekly, monthly, or quarterly, as examples. Also, for this particular embodiment, the bank account may be further set up to regularly report profits of the corresponding sub-trust account on a recurring basis.

In this particular embodiment, the trust account should typically include multiple sub-trust accounts and each sub-trust account can be set up to further include any number of nested sub-accounts. The sub-trust accounts and each nested sub-account, likewise, are respectively linked to a corresponding bank account and a corresponding debit card. Furthermore, one desirable feature associated with this particular approach, the nested sub-accounts and the sub-trust accounts may be set up to be aggregated on a regular basis to earn revenue from investing the aggregate amount of funds at the trust level.

Likewise, in another embodiment, this structure may be implemented through a “nesting” of sub-accounts. In other words, a particular sub-account may operate like a trust account, as just described, with respect to a group of its own sub-accounts. In this example, the group of sub-accounts is nested by that particular sub-account. Therefore, the nested sub-trust accounts may be set up to have their funds aggregated on a regular basis to earn revenue at the nesting sub-trust account level from investing the aggregate amount of the funds, in this example embodiment. Therefore, a debit card corresponding to a particular bank account linked to a nesting sub-trust account is able to earn a return from the aggregation of funds for investment at the nesting sub-trust level, a desirable feature particular in comparison with conventional debit cards.

Previously, an embodiment employing a switch was discussed. Although embodiments may be implement that do not employ a switch, in those embodiments that do, the switch may be conveniently incorporated as a component of the system infrastructure. In this embodiment, for example, for a debit card purchase transaction, the available balance of the sub-trust account linked to the bank account corresponding to the particular debit card may be accessed and the available balance may be compared with the amount of the debit card purchase transaction. Thus authentication and acceptance may occur if the available balance is sufficient; however, denial may occur if the available balance is not sufficient in such an embodiment.

A glossary of the terms used herein follows.

“Affiliate” means, with respect to any Person, any other Person controlling or controlled by or under common control with such specified Person. For the purposes of this definition, “control” when used with respect to any specified Person means the power to direct the management and policies of such Person, directly or indirectly, whether through the ownership of voting securities, by contract or otherwise; and the terms “controlling” and “controlled” have meanings correlative to the foregoing.

“Available Funds” means the aggregate amount at a particular point in time of cash on deposit in the Sub-Accounts of a Trust which is available for overnight investment by the Trustee.

“Beneficiary” (or a “Trust Participant” in the case of a Participation Trust) is Person who owns a fraction of the Trust Estate as evidenced by Trust-Issued Receipts, Trust Notes or Trust-Participation Receipts, in pro-rata of his total holdings relative to the total Trust Estate.

“Cardholder” means any Person who is the holder of a Trust Sub-Account and who, by virtue of having adopted the Trust Agreement in which he is a beneficiary, has received a Floating Trust Participation Receipt for his initial deposit as well as a debit card that links directly to the Trust Sub-Account of the Cardholder.

“Custodian” means a bank or securities firm that is designated to act as custodian for Available Funds of the Trust and other Trust Funds.

“Distributable Funds” represents: (a) the portion of a Participant's funds on deposit in Participant's Sub-account and earmarked as being the amount (or percentage of total deposits) needed to be available at all times on simple demand (with no notice) to settle daily TCD Card payments or cash withdrawals; or (b) the amount of dividends, interest or profits earned by the Trust and posted to the Sub-account of the Participant. Distributable Trust Funds can be left on deposit in the Trust Sub-account until needed, in which case they continue to earn interest for the Cardholder/Participant.

“Floating Trust-Participation Receipt” is a Trust Participation Receipt that is initially delivered to a Trust Participant to evidence that party's beneficial interest at any point in time in the Trust Estate to the extent of his holdings therein. Since a Participant's account balance in a Trust Sub-Account will fluctuate daily when deposits and withdrawals are posted, the receipt amount evidencing available funds on account is floating as defined in the receipt certificate. Therefore, rather than being for a set receipted amount, such Floating Trust-Participation Receipt, when issued and delivered upon the opening of a Participant's Trust Sub-Account, will establish the method and basis of calculating, booking and reporting the balance of a Sub-Account at any point in time.

“General Investment Guidelines” shall mean the investment of Available Funds in accordance with the investment principles and guidelines defined in the Trust Agreement in the “Permitted Investments” section, the Trust Participation Agreement or the Trust Indenture.

“Instruction/s” means any investment orders issued from time-to-time in writing by third-party Asset Manager and addressed to the Trustee that is a “Permitted Investment” under the Trust Agreement or the Trust Indenture. Such written Instructions, when issued and delivered, obligates the Trustee and/or the Custodian to execute them.

“Invest-able Deposits” represent the portion of a Participant's Sub-account balance that has been earmarked (as a specified amount or as a percentage of total deposits) which the Trust is permitted to invest on the Participant's behalf and where such funds are callable, with some form of advance notice and without penalty, or for a specific pre-determined period.

“Investment Profits” mean the gross profits earned from any and all Permitted Investments of a Trust, less any and all pre-determined and pre-approved investment management expenses.

“Manager” or “Asset Manager” means any person or entity appointed from time to time by the Settlor of a Master Trust or a Sub-Trust to give investment Instructions to the Trustee in accordance with the terms and conditions of a Trust Agreement or a Participation Agreement.

“Master Trust” means a Trust which itself is the sole beneficial owner of 100% of the Trust Estate of other similar trusts.

“Nested Sub-Account” means a nested account of a Trust Sub-Account opened in the name of the principal account Beneficiary but which benefits a Related Party (e.g. employees of a company who use a debit card to automatically debit their travel expenses to the Trust Sub-Account of their employer, children or spouses of a cardholder who use the card, foreign parents of a migrant worker who are in need or support abroad, etc.).

“Non-Cash Contributions” means the contribution made by a Person to the Trust Estate effected by means of a transfer or assignment of all legal rights, title and interest to a specific non-cash asset, in exchange for a Trust Participation Receipt that can only be redeemed at maturity via the return of the original non-asset to the original contributor (e.g. a second mortgage in a residential home or rental property of a Beneficiary, restricted stocks of public corporations, stocks of public companies that fall below the minimum pricing threshold to qualify for a margin facility, etc.).

“Participant” means any Person or Entity that has deposited or caused money to be deposited to a Trust Sub-Account. Such a Participant is also the Beneficiary and the holder of the Trust-connected Debit Card (the Cardholder).

“Participation Agreement” means any duly executed and delivered Participation Agreement between a Settlor and a Participant to establish the basis of that Person or Entity's relationship to the Trust. It establishes the method of making deposits, withdrawals, and payments, as well as establishing the basis upon which the Person or Entity's beneficial interest in the Available Funds will be booked, profits and dividends accounted for, posted to the Person's account and reported on monthly statements of account.

“Participation Trust” means a statutory Master Trust or a Sub-Trust (normally named: The XYZ Participation Trust) formed by an individual, a company, a non-profit organization, or an affinity group for the ultimate benefit of the intended Beneficiaries. This would include, for example, an employer that contributes a nominal amount to the Trust corpus but intends for the Trust to be operated for the benefit of its employees. In this instance, the employer would be able to automatically cause employee-approved payroll deposits or bonuses to be posted electronically directly to that employee's Trust Sub-Account each month. Each time a deposit is made to the employee's Trust Sub-Accounts a double accounting book-entry is made to post the credit to the Beneficiary's account and to register a debit to cash (the Trust Estate), and to issue a Trust-Participation Receipt in favor of the Beneficiary.

“Permitted Investments” means investments authorized by the Trust Indenture or the Trust Agreement executed by the Trustee pursuant to orders received from a duly authorized Asset Manager and which complies with all investment guidelines including clear definition of an acceptable investment in terms of the type of investment products bought and sold, the duration of any investment, the credit risk, the settlement method, the exit strategy, and the overall risk tolerance.

“Person” means (a) any natural person, (b) any corporation, limited liability company, partnership, trust, joint stock company, unincorporated association, non-profit organization, joint venture or other entity established to conduct business or (c) any federal, national, state, provincial, municipal, local, territorial or other governmental department, commission, board, bureau, agency, regulatory authority, instrumentality or judicial or administrative body, whether domestic or foreign.

“Registrar” means an institution duly appointed to perform all accounting functions for the Trust and to report monthly the account activity for each Participant.

“Related Person” means any Person who is a related family member, a trustee, or an attorney-in-fact of such Person.

“Settlor” (also known as the Creator or Grantor) is the person or entity that enters into an agreement with a Trustee to form a new Trust.

“Sub-Trust” means a Trust whose Trust Estate is entirely owned by a Master Trust. In the case of the TCD Card System, Sub-Trusts can be individual Trusts formed for the purpose of accommodating specific organizations desiring to issue branded Trust-connected Debit Cards (e.g. employers, retailers, banks & financial institutions, affinity groups, credit unions, etc. desiring to offer the benefits of a TCD Card to their employees, members, customers or clients).

“Trust” in law means a legally-created fiduciary relationship in which a qualified person or legal entity (one free of conflict of interest) called a “Trustee” holds title to property for the benefit of one or more Persons, called a “Beneficiary” or “Beneficiaries”. The agreement that establishes the Trust, contains its provisions, and sets forth the powers of the Trustee is called the Trust Agreement or the Trust Indenture. The person or entity creating the Trust is the Creator, Settlor, Grantor or Donor; the property itself is called the “corpus”, the “Trust Funds” or the “Trust Estate” which is distinguished from any income earned by it.

“Trust Account” means a bank account or Trust account of a Master Trust or a Sub-Trust.

“Trust Sub-Account” means the sub-account of a Trust Account normally opened in the name of an individual Beneficiary or Participant.

“Trust-issued Receipt” is a Trust receipt issued by the Trustee of the Trust in favor of a Beneficiary to evidence the Beneficiary's pro-rata beneficial ownership in the Trust corpus up to the amount shown on the receipt. A Trust-Issued receipt operates much like a stock certificate of a corporation with the main difference being that in the case of a Trust, the assets of the Trust are managed by an independent Trustee in accordance with the pre-defined terms and conditions of the agreement governing the Trust.

“Trust-Participation Receipt” is a receipt issued by the Trust in favor of a Participant, that operates much like the Trust-Issued Receipt, except that it is issued in favor of a non-related third-party that causes deposits to be made to a Sub-account opened in the Participant's name under the master account of the Trust in accordance with the terms and conditions of a “Trust Participation Agreement,” thereby causing the Participant to be de-facto a Beneficiary of the Trust to the extent of the Participant's holdings in the Trust.

“Trust-connected Debit Card” is a term used to describe the debit card product which is the subject of this invention.

“Trust Company” means a regulated and licensed organization usually combined with a commercial bank, which is engaged as Trustee, fiduciary or agent for individuals or businesses in the administration of Trust funds, estates, custodial arrangements and other related services.

“Trust Estate” means all rights, title and interests the Trust has in the aggregate of all cash deposits of Beneficiaries to their Trust Sub-Accounts at any point in time calculated as the total of all assets less the total of all liabilities, including set-aside reserves that are subject to a fiduciary duty of the Trustee. It is also the amount that is normally available for investment purposes, and it includes any and all accumulated and accrued interest, dividends or profits earned by the Trust as well as any other asset otherwise acquired by the Trust.

“Trust Funds” means the aggregate of all cash funds and other assets deposited to the credit of the Trust by the Settlor, Grantor, Beneficiaries or Participants.

“Trust Indenture” is a legal agreement that establishes the Trust and appoints a Trustee to manage the assets of the Trust. It is an agreement entered into between a Settlor and a qualified Trustee which normally contain protective clauses for bond holders or Beneficiaries, including how funds are to be managed. Its provisions set forth the powers of the Trustee and establish the interest of the Beneficiaries or Participants in the assets held in Trust.

“Trust Note” is a debt instrument that obligates the Trust to pay the holder of the note the principal and interest, if any, when due, in accordance with the terms of the Note. A Trust can create an indebtedness secured by Trust Assets, unless such activity is specifically prohibited by the Trust Agreement.

“Trustee” is a qualified (meaning free of a conflict of interest) person or legal entity, such as a Trust Company that holds title to property for the benefit of one or more Persons, called a “Beneficiary” or “Beneficiaries”. A Trustee is usually charged with investing Trust property productively for and on behalf of the Beneficiaries in accordance with the specific instructions of the Trust Agreement or Trust Indenture. The Trust Agreement will usually define whether the Trustee can make investment decisions of his own or whether he is only to execute investment orders submitted by a third-party asset manager.

A. Why the Use of a Trust Structure

Trusts are governed by trust laws which protect the interest of the beneficiaries of a trust. Like banks, trust companies are subject to regulatory oversight and to strict operating guidelines.

Trust funds constitute fiduciary funds held in the custody of a trustee of the trust. Trustees act in a fiduciary capacity only, may not treat fiduciary funds as an asset of the trustee, and therefore hold funds in trust for trust beneficiaries and agree contractually to perform certain services which are described in full in a trust agreement (the governing instrument of the trust).

Furthermore, funds held in a custody account by a trustee are not available or accessible to creditors of the bank or the trust beneficiaries in the event the trustee becomes insolvent. In contrast, if a bank becomes insolvent, depositors with an account balance in excess of the insured limit (e.g. $100,000 in the US and C$65,000 in Canada) could find themselves as one of many creditors looking to recoup their deposits which exceed the insured limits.

By providing an interconnected network of trusts (commonly referred to a unit participation trusts) and by supporting the network with the appropriate settlement mechanisms, it is possible to create a parallel financial system that uses the same technologies in traditional banking, but which effectively removes from the banks the ability to make money on its depositors funds without paying fair compensation for the use of these funds.

The system described in the present invention effectively creates a new financial system which is juxtaposed on the current banking system and is connected to it by necessity for two primary reasons only: (a) to facilitate profitable investments, and (b) to enable the issuance of debit cards which are regulated banking products.

In this new parallel fiduciary system, a central bank is replaced by a master unit participation trust, member banks are replaced by unit participation sub-trusts, regular bank accounts become sub-trust accounts, and debit cards are replaced by trust-connected debit cards.

Each trust is governed by a uniform trust agreement which governs all trusts. Therefore, as all trusts have the same operating guidelines and permitted investments, money can flow from one trust to another without increasing or changing the risk.

Only one bank per country is required to accommodate the entire trust network within the country's banking infrastructure.

B. The Unique Application of a Trust Structure

In this new “trust-connected financial transaction card system” (the “System”), each sub-trust is able to compete with banks for retail depositors' funds and the sponsors of a sub-trust formation is able to participate in the new system, offering the same basic services and products banks offer.

In this new trust System, any employer can sponsor a trust for the purpose of offering a trust-connected debit card to its employees, and any church organization for instance can benefit from offering trust-connected services to its members.

In this new trust System, trust funds can easily and freely flow from one trust to another through loans followed by a settlement and offsetting process;

In this new trust System, trust funds can easily be aggregated at the account level, the sub-trust level, and the master trust level so that the aggregated pool of assets can be invested in permitted investments which are standard for all trusts.

In this new trust System, aggregated trust funds can be invested as large asset pools, thus affording each trust beneficiary, however small, the ability through the trust, to participate indirectly in investment strategies which heretofore have only been available for ultra wealthy bank clients.

In this new trust System, retail banks will compete for the overnight use of the aggregated pool of cash available only through the master trust. In the competition created between banks, for the first time ever, consumers will regain effective control of their money.

In this new trust System, trust beneficiaries receive their share of trust profits which are distributed to them monthly in the form of trust dividends.

In this new trust System, funds on deposit in a trust sub-account are fully protected from creditors and are not subject to the risk of bank insolvency.

In this new trust System, a commercial or wholesale bank can become a sponsor or promoter of a trust, thereby agreeing to forego its normal way of making money with depositors' funds, and instead share in the profits of the trust.

In this new trust System, the poor who maintain a small balance on deposit are treated with equity and receive the same benefits and return on investment as those who maintain much larger balances.

In this new trust System, trust accounts can be designed to offer the same basic functionality and services as those offered for traditional bank checking accounts (e.g. check writing features).

In this new trust System, trust accounts can be designed to hold liquid or illiquid assets (e.g. investment grade securities or the equity value a person has in a home).

In this new trust System, trusts can be formed and interconnected so that the excess liquidity of one trust can flow seamlessly to another trust (in exchange for a share of profits or a pre-determined interest rate) in which it can be invested.

In this new trust System, a multiple asset managers and broker dealers can be appointed to handle the investments of the assets of each trust, thus capitalizing on worldwide investment arbitrage opportunities.

In this new trust System, investment strategies of the trusts and the master trust are synchronized and standardized so as to provide a virtually riskless system to create a profit.

In this new trust System, a pre-determined method of segregating investment profits among trust sponsors (e.g. employers) and account holders (e.g. employees) gives every participant opportunity to profit from their account balances.

C. Formation of a Trust

This new System uses a Unit Participation Trust structure in which each trust is governed by a trust agreement and is subject to fiduciary trust laws.

A Master trust is formed by executing a trust agreement between the trustee and the grantors (licensor and license of the Invention). A sub-trust can be formed through the execution of a simple adoption agreement in which the trustee and a new sponsor both accept that the new trust will be governed by the same trust agreement that governs the master trust. A copy of the trust agreement of the master trust is simply attached to the adoption agreement.

A sponsor appoints fiduciary trustees and agents (trustees, custodians, registrars, paying agents, transfer agents, exchange rate agents, underwriting agents, etc) as well as broker dealers & asset managers to give investment orders to the trustee.

A sponsor may be any individual, corporation, any other legal entity or government. A corporate sponsor can be any for-profit group (e.g. an employer, a retailer, a financial institution) or any not-for-profit entity (e.g. a church, an affinity group, a labor union, and association, etc.).

Each sub-trust issues “trust-preferred variable rate notes” (the “notes”) rather than trust certificates. The notes evidence the indebtedness of the trust to the account holder. However the notes also give the account holder a fractional ownership interest in the trust up to the amount of account holder's account balance at anytime.

Notes do not pay a fixed interest rate as normal debt instruments would, but instead are structured to receive trust dividends in pro-rata share of the fractional interest an account holder has in the trust (a share of the total investment profits of a trust).

Each sub-trust has one or more sub-accounts for each beneficiary. Each account holder in the sub-trust becomes a de-facto fractional beneficial owner of the sub-trust. The account holder's proportional beneficial interest equals the aggregate balance of all accounts relative to the total trust corpus.

The trust corpus (total trust assets) represents the total aggregated balance of all sub-accounts.

Each account holder/beneficiary holds a trust note, the value of which increases each time a deposit (credit) is made to a sub-account and decreases each time a withdrawal (debit) is posted to it.

Account/Note holders have an option to call their notes fractionally or in whole at any time. The call option is revolving in the sense that each withdrawal from an account gives birth to a new call option for the next withdrawal.

Each sub-account may have multiple nested sub accounts (e.g. for spouses, children, employees of the same company, etc.). Funds may flow freely from the primary sub-account of the account holder to nested sub-accounts

A Trust-Connected Card™ (debit card) can be attached to each nested sub-account as requested.

D. The Trust-Connected Debit Card

The “trust connected debit card” (hereinafter, “Trust-Connected Card™) is a debit card with a new income-producing feature. Availability in any country requires only the participation of a single bank, licensed to issue and distribute debit cards.

In the description of this invention, each time the name Trust-Connected Card™ is used, it means a customary debit card which is linked to a trust sub-account that has a positive balance.

The Trust-Connected Card™ system comprises a trust account, a standard debit card (a plastic card or any other electronic devise capable of being used at a merchant location to effect a retail purchase, a banking or an ATM transaction); and a pass-through bank account.

Bank accounts and trust sub-accounts can be opened in the name of individuals or corporations so that, for instance each traveling employee can carry his own Trust-Connected Card™

The Trust-Connected Card™ can be used equally by individuals, corporations and governments to create a new profit center or to substitute existing banking arrangements.

Since only banks are allowed to issue and distribute debit cards, the Trust-Connected Card™ is directly linked to the corresponding bank account as would be the case for any bank-issued debit card. In such a way, the requirements of banking laws are fully met; the only difference being that because the deposit account is configured as a net-zero balance pass-through account, the card issuing bank never has access to the trust accounts deposits and therefore cannot use Trust-Connected Card™ funds as an asset of the bank. This process entirely protects account holders from the bank insolvency and bankruptcy.

The deposit and trust accounts are interlinked through an electronic switch which makes use of a computer system, software-driven functionality, and an account database to seamlessly post debits and credits between accounts.

The Trust-Connected Card™ is the primary tool used to drive this new trust-based financial system or economy. Each Trust-Connected Card™ is linked to a global transaction-processing, authentication, transaction-clearing, and transaction-settlement system that enables a card holder to use the Trust-Connected Card™ worldwide for ATM cash withdrawals or to make merchant purchases.

The Trust-Connected Card™ delivers standard debit card functionality to its holders, including 24×7 access to their account balance in the trust sub-account as well as full online banking functionality to permit the movement of funds to other banks or between accounts, the payment of bills and/or to manage the account and obtain account statement.

The sub-trust sub-account is designed to accept any form of deposit of cash, checks, bank wire transfers or recurring automatic deposits (e.g. payroll deposits or social security payments).

Trust sub-accounts are also configured to have nested sub-accounts that can be used by the primary account holder for a variety of purposes, including pre-determined account access to a child, a spouse, a relative or parent, and in the case of corporations, traveling employees of a company.

Each time a Trust-Connected Card™ is used to withdraw cash from the trust sub-account, the deposit account-trust account connection provides: (1) the account/user verification and authentication; (2) the acceptance or rejection of a transaction depending on the sufficiency of the trust sub-account to cover the authorized debit; (3) a debit from the trust sub-account of the transaction amount; (4) a credit to the temporary settlement account for the same amount; (5) a simultaneous offsetting credit and debit to the pass-through zero balance bank account; and (6) a final debit of the temporary settlement account when the transaction is settled at regular intervals throughout the day.

The Trust-Connected Card System™ is also designed to drive and process a check-writing and check-clearing process through the switch (through the use of the banking license or the participating bank) so that checks can also post directly and seamlessly to a trust sub-account rather than to a traditional deposit account. The processing a debit request at the presentment of a check is the same as that required when a debit card charge authorization request is presented to the accounts connection process.

Trust sub-accounts can be further configured online by the account holder to accept pre-established preferences of the account holder, including one-time or recurring instructions to debit the account (e.g. to automatically pay the balance due on a credit card when due or to pay recurring bills or to wire money to a designated third-party).

The unique benefit of the Trust-Connected Card™ is that it henceforth will allow cardholders to earn trust dividends on investments made on their behalf in principal-protected permitted investments that are designed to limit or entirely eliminate all downside risks.

The Trust-Connected Card™ can be issued in conjunction with a parallel credit card so as to give the card holder the option of either making a debit card or a credit card transaction when the card is used at a merchant location. When the credit card is used to make a retail purchase, the issuing bank makes money from transaction fees, but the bank also extends to its customers a standard 20 to 25 day credit period during which there is no interest charged on the account. Holders of both a Trust-Connected Card™ and a parallel credit card will be able to further use the free 25 day credit offered by banks and to use their trust sub-account to automatically settle such credit card balances when due.

The Trust-Connected Card™ can also be co-branded as part of an agreement between the licensor of the System (the licensor), the issuing bank and any individual, company or entity desiring to market and distribute its own brand of trust-connected banking products and debit cards.

Through a profit-sharing arrangement stipulated in each trust agreement, the licensor, the card-issuing bank, the trust sponsor (e.g. an employer, a church, an affinity group, a labor union, a retailer, an entrepreneur, a government entity, a school district, etc.) and the primary trust sub-account holder will be able to share in the investment profits of the trust based on percentages that can be changed based on circumstances and the agreements reached between the parties in each case. This means for instance that any employer would be able to cause a co-branded Trust-Connected Card™ to be issued to their employees for payroll deposit purposes, whereby both the employee and the employer will be able to share in the income of the sub-trust so that the employer can apply its share of profits as a benefit to its employees or to cover increasingly more expensive costs of benefits and health insurance.

A trust sub-account and the corresponding bank account can be configured for any number of nested sub-accounts for the purpose of: (1) allowing each nested sub-account holder to have its own individual account and a corresponding Trust-Connected Card; (2) allowing any number of new group-sponsored trust participants to obtain a Trust-Connected Card™ by opening the appropriate accounts as a dependent of a primary sub-account holder; (3) allowing a revenue-sharing opportunity to exist for those who desire to sponsor others by allowing their sponsored friends to have a nested trust sub-account immediately under their primary sub-account.

A trust sub-account can be configured to hold both cash and non-cash balances in order to allow a trust sub-account holder or a nested trust sub-account holder to transfer all rights, title and interest in non-cash assets to a trust or a sub-trust and to receive in exchange a trust preferred variable rate note (the “Note/s”) of equal amount (e.g. the market value of stocks and bonds, the appraised value of equity held in a home, a life insurance policy, an annuity, a-revenue producing intellectual property or other non-cash assets) so as to earn an income on such assets. Since each Note may be put back to the trust at any time, with the only trust obligation being the is to return the contributed asset/s to its original transferor without liens or encumbrances, illiquid assets can be aggregated within a trust structure so that a secured line of credit can be obtained for the purpose of investing same in the permitted investments of the trust.

Permitted Investments of a Trust

Introduction to Principal-Protected Investments

Conventional wisdom has it that in order to achieve a high return on investment it is necessary to take a proportionately high risk. Inversely that same logic concludes that a low return is always accompanied by an equally low risk.

This present invention disproves this notion and shows instead that it is possible to make a consistently high rate of return with little or no investment risk through the use of fixed income arbitrage strategies which are disclosed herein and which forms an integral part of this invention.

The principal-protected permitted investment rules of the trust are embodied in each trust agreement which govern the management of the trust by an independent fiduciary trustee.

Trustees have a fiduciary responsibility to manage the trust in accordance with their mandate as laid out in the trust agreement. If they deviate from prescribed terms and conditions, they could be liable to trust beneficiaries for damages. For this reason, trustees maintain insurance for errors and omissions, and, are additionally bonded and insured to cover any other potential liability.

Trust investment decisions and implementation functions are separated and allocated to different parties to ensure maximum safety and security. An investment manager (“Manager”) or broker/dealer submits a trade order to a Rules Validation Agent, and the agent confirms or rejects the trade order depending on whether all the permitted investment rules are met. When approved, trade orders that are then submitted to the Trustee for execution through the Prime Broker or Custodian of the trust.

Permitted Investments include three basic strategies designed to maximize the utilization of funds around the clock, around the world, year-round. These include:
1. Daytime investments in fixed income trading involving either a matched trade arbitrage or a repo/reverse repo strategy requiring a totally hedged portfolio strategy that guarantees a profit.
2. Aggregation and sweep of overnight funds to highly rated counterparties empowered to use the funds of the trust in different parts of the world to settle fixed income transactions that closed during the day. By providing the cash and the structure for precise execution to take place, the trust is able to earn a fee each time trust funds are used by the counterparty to settle a transaction.
   General Background On Repo & Reverse Repo Strategies

A repurchase agreement is a sale of securities coupled with an agreement to repurchase the same securities at a higher price on a later date which can be from one day all the way to maturity. A repo is thus broadly similar to a collateralized loan. For example, a dealer can borrow $10,000,000 overnight at an interest rate of 3 percent per annum by selling securities to a mutual fund and simultaneously agreeing to repurchase the securities the following day for $10,000,833 ($10,000,000+1/360×3 percent of $10,000,000). The payment from the initial sale is the principal amount of the loan; the excess of the repurchase price over the sale price is the interest paid on the loan. As with a collateralized loan, the lender has possession of the borrower's securities during the term of the loan and can sell them if the borrower defaults on its repurchase obligation.

A repo is economically similar to a secured loan, with the lender of money receiving securities as collateral to protect against default. However, the legal title to the securities clearly passes from the seller to the investor. The cash provider is referred to as an “investor” or “repo buyer”; the provider of the collateral (i.e. the security) is the “repo seller”. Coupons (installment payments that are payable to the owner of fixed income securities) which are paid while the repo buyer owns the securities are, in fact, usually passed directly onto the repo seller (i.e. cash receiver).

There are three types of repo maturities: overnight, term, and open repo. Overnight refers to a one-day maturity transaction. Term refers to a repo with a specified end date. Open simply has no end date and can extend to maturity if desired.

A repo consists of two legs or transactions. The first leg of the repo consists of a repo seller (the party looking for liquidity) transferring securities to and receiving funds from the repo buyer (the party wishing to place its liquidity); and the close leg consists of the repo buyer transferring securities to and receiving principal and interest from the repo seller. Based on these characteristics, repos are considered loans collateralized by securities. There is little that prevents any security from being employed in a repo; so, Treasury or Government bills, corporate and Treasury/Government bonds, and stocks/shares, may all be used as securities involved in a repo.

A reverse repo is the same repo transaction except that it is viewed from the perspective of the repo buyer (the provider of liquidity) instead of from that of the repo seller (the provider of the security).

Although the underlying nature of the transaction is that of a loan, the terminology differs from that used when talking of loans due to the fact that the cash receiver does actually repurchase the legal ownership of the securities from the cash provider at the end of the agreement. So, although the actual effect of the whole transaction is identical to a cash loan, in using the ‘repurchase’ terminology, the emphasis is placed upon the current legal ownership of the collateral securities by the respective parties. Federal regulators treat repos as financing transactions, i.e. loans, although courts in some bankruptcy cases have treated them as securities transactions.

Repo traders have been traditionally known as “matched-book repo traders”. The concept of a matched-book trade follows closely to that of a broker that takes both sides of an active trade, essentially having no market risk, only a credit risk for a very brief period of time. Elementary matched-book traders engage in both the repo and a reverse repo within a short period of time, capturing the profits from the bid/ask spread between the reverse repo and repo rates. Presently, matched-book repo traders employ other profit strategies, such as non-matched maturities, collateral swaps, liquidity management. By locking in simultaneously the pricing on both ends of a trade, these traders are assured a profit every time they execute a trade.

This invention uses a similar process; except that in this case a fixed income product is pre-engineered to deliver new issues discount which are reflected in a greater yield to maturity than that of the anticipated refinancing interest rate. Through the use of volume discounts achieved for large underwritings coupled with a process to buy and resell (or refinance) each instrument that is underwritten, it is possible to create the financial products that deliver the arbitrage advantage in each case.

General Background Matched Trades

In a “principal-protected¹, matched-trade,” a trader (or underwriter) purchases a security or underwrites a new issue for which one or more investors-buyers have been identified and the terms of a resale (the secondary private placement) have been locked-in at a price greater than the cost of the instrument or the discount price of the underwriting (the net “spread”). By contracting for the resale of the securities prior to purchase, the trader is executing a type of arbitrage transaction, which essentially eliminates market, liquidity, credit, and other risks which would be present in traditional trading of privately placed securities.
¹ A “Riskless-Principal” transaction (or “Principal-Protected”) is one “whereby one party enters into a transaction and thereafter or contemporaneously enters into an offsetting transaction so that the risk or payments under the two transactions net out.” US House of Representatives, Currency Committee on Banking and Financial Services, Rep. James A. Leach, Chairman, House Banking and Financial Services Committee, “On Commodity Futures Modernization Act,” Friday, Dec. 15, 2000.

The Permitted Investment Rules for Engineering Consistently Profitable Arbitrage Trades

The pre-defined fixed income trading/arbitrage strategy is designed to achieve long-term capital appreciation, high-yield returns and protection of capital as described in detail herein. The basic investment strategy for each trust consists of five core principles and objectives:

1. The underwriting of fresh issues of fixed income products that will result in profitable yield arbitrage opportunities when underwriting discounts (volume discounts) are taken into account.

2. The immediate mining of arbitrage profits and the capture of built-in underwriting discounts or pricing inefficiencies relative to the markets.

3. The application of matched-trade² strategies (only place a buy order when a target portfolio is pre-sold or refinanced at lower yield to maturity) executed within the context of “principal-protected” transactions.
2 “Matched Trade” means a transaction where all the following conditions are met: (a) the financial instrument is pre-sold before it is purchased; (b) the settlement risk is eliminated through some form of guarantee of payment against delivery, (c) the price of the resale is greater than the purchase price, (d) the trade will result in an immediate profit, and (e) there is no long-term credit or interest rate fluctuation risk.

4. Income maximization through the overnight sweep of cash funds made available to third party financial institutions for a pre-set transactional fee to facilitate the settlement of their own repo & reverse repo transactions.

5. The maximization of profits through the use of leverage in transactions that are pre-determined to result in a positive yield arbitrage.

To accomplish the above objectives, it is necessary to engineer each transaction with precision so that each part of the process or trade occurs sequentially and when the entire process is implemented, will result in a guaranteed profit with no downside risk of loss of principal. To further accomplish these objectives, the following are required:
1. The underwriting of a tailor-made fixed income security that meets precise specifications and investment grade risk rating objectives. This process can also make use of any regular fixed income product that can be purchased at a price (measured in yield to maturity) that carries a favorable pricing structure.
2. The purchase of the product in (1) above using less than the face value of the instrument (e.g. $100 when the instrument has a face value of $1,000).
3. The application of leverage to the purchase of the security (e.g. a 9:1 leverage where one can borrow $9 for every $1 of risk capital put up in a transaction, thus making a $10 pool of cash available for a trade).
4. The execution of a loan agreement that pledges the instrument purchased to the lender during the period of time during which transaction is outstanding. In the above case, an instrument having a $10 value is pledged for a $9 loan during the time between the purchase time and the resale time.
5. The execution of a Global Master Repurchase Agreement (“GMRA”) in which a repo buyer (e.g. a lender) establishes a pre-authorized repo facility in favor of the repo seller (e.g. a borrower) to facilitate the purchase of pre-defined securities. The GMRA must govern all trades executed between the repo buyer and repo seller and must further include specific provisions that address the following issues:
   a. It must define the minimum acceptable credit risk (e.g. the credit rating) for each security offered;
   b. It must establish draw down parameters;
   c. It must specify a rate of interest based on the LIBOR rate that the repo buyer will charge for each day that an instrument is financed (the interest carry) up to and until the date a repurchase of the security occurs;
   d. It must establish the type of repo transactions permitted (e.g. open repo, which means that there is no fixed repurchase date);
   e. It must preferably contain a right of substitution of one security for another similar security;
   f. It must address how interest collected on coupons attached to securities sold to the repo buyer will pass-through to repo seller or used to offset partially or wholly the interest carry cost.
6. The refinancing of the purchase through one of the two following methods (to provide liquidity for the next trade):
   a. A resale of the instrument to a third-party buyer as part of a matched trade execution. In such a sale, the seller has no further liability. The instrument is acquired and immediately (usually within seconds) resold at a profit.
   b. A resale of the instrument to a third-party buyer with an obligation to buy back the instrument at a future date which varies from one day all the way through to maturity of the instrument. Also known as a repo or reverse repo transaction, this process taps into the liquidity markets to provide cheap variable rate financing that floats with the LIBOR market rate for intra-bank lending. The use of open repo strategies can provide liquidity for any pre-determined period of time and as long as maturity, if desired.
7. The creation of a hedge which is designed to eliminate any and all downside risk, namely the risk that a margin call may be made upon the repo seller by the repo buyer if the LIBOR interest rate goes up, thereby causing a decrease in the value of the security held as collateral. The hedge specifically involves the establishment of the following:
   a. The over-collateralization of an open repo transaction (e.g. a 98% loan to value where a security worth $100 is offered as collateral in exchange for a $98 loan) combined with the establishment of a non-recourse provision that limits the credit risk exposure of the repo seller.
   b. The establishment of a stop-loss-limit which pre-determines the maximum acceptable mark-to-market loss in the event a fixed income security held as collateral must be liquidated due to a decrease in value resulting from an increase in the interest carry.
   c. The establishment of a liquidation price trigger which, when reached, will result in the immediate liquidation of the instrument at such a price as to produce a delta between the actual exit price achieved in the market and the maximum price established by the stop-loss-limit.
   d. The use of the delta in (c) above to cover the cost of a non-recourse premium paid the repo buyer to limit the downside exposure that a repo seller has in a repo transaction. The delta ensures that the repo buyer will make a profit on the transaction (the value of the premium charged for a non-recourse contract) the moment the liquidation trigger price if achieved.
8. The use of interest rate swaps or swaptions to maximize profits by hedging the risk that interest rates will increase by converting, if desired, a variable rate repo financing with a fixed rate interest rate that effectively caps the upside profitability of a trade but that also locks in the pre-determined level of profitability.
9. In the case of a repo financing, the apportionment of the delta (positive cash flow) derived by deducting the net price paid for a security from the net proceeds derived from repo sale of that same security, between the following cost centers:
   a. A locked-in profit.
   b. A build-in premium for the repo buyer in exchange for a non-recourse financing.
   c. A maximum acceptable loss up to the liquidation trigger price.
      The System Service Providers
      Commercial Banks, Credit Unions, Trust Companies, and Insurance companies that provide one or more commercial bank accounts linked to the Master Trust.
      Custodial Institution or Custodian means any financial institution providing global custody services to the Trust.
      Institutional Trustees that provide Trust administration services for every Master Trust and sub-Trust.
      Manager means a registered investment advisor, institutional asset manager or a licensed broker-dealer appointed from time to time by the Licensor to govern the investments of one of the Funds of the Trust in accordance with the terms and conditions of the License, an asset management agreement and the Trust Agreement.
      Paying Agent means the Trustee or any other Paying Agent subsequently appointed by the Trust to: (a) receive any and all Payments from the Trustee; (b) effect monthly wire transfers of payments to each Trust beneficiary in accordance with the Trust Agreement; and (c) prepare and submit quarterly and annual tax returns for payments recipients.
      Private Label Debit Card Issuers that issue cards, make money transfers, transmit debit and credit transactions, and provide the connection between traditional bank demand deposit accounts and associated trust sub-accounts.
      Providers of Transaction Processing Services that provide global transaction processing, ATM/POS networks, Pin-secured account access, and transaction clearing and settlement.
      Rule Validation Agent shall mean the agent, as appointed by the Licensor from time to time pursuant to written notification to the Trustee and the Manager, who evaluates all Trade Orders issued by the Manager to ensure that each Trade Order complies with the terms of the General Investment Guidelines and that each Global Master Repurchase Agreement, Underwriting Contract or Standby Credit Facility Agreement has been reviewed and opined by counsel and a Legal Opinion is on file for each contract.
      Securities Firms that provide “permitted investment” services to the Trustee and Master Trust in accordance with the terms and conditions of the Trust Agreement. These Securities Firms earn a fee for services.
      Trust Sponsors & Promoters that issue their own trust-connected Debits cards and market them to their customer base (corporations, employers, retailers, affinity groups, non-profit organizations, etc.)

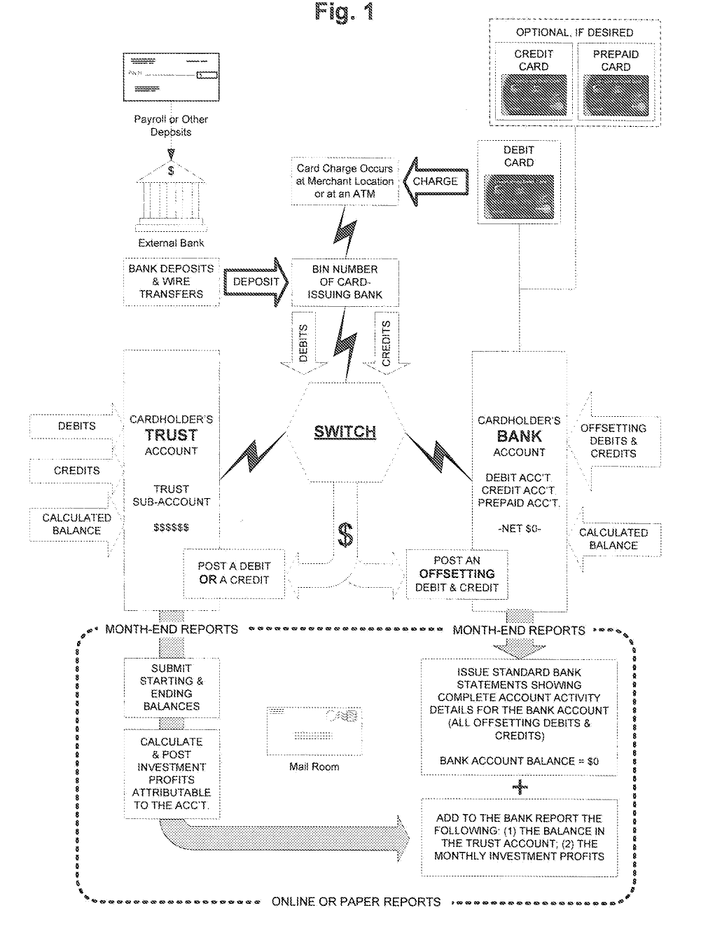

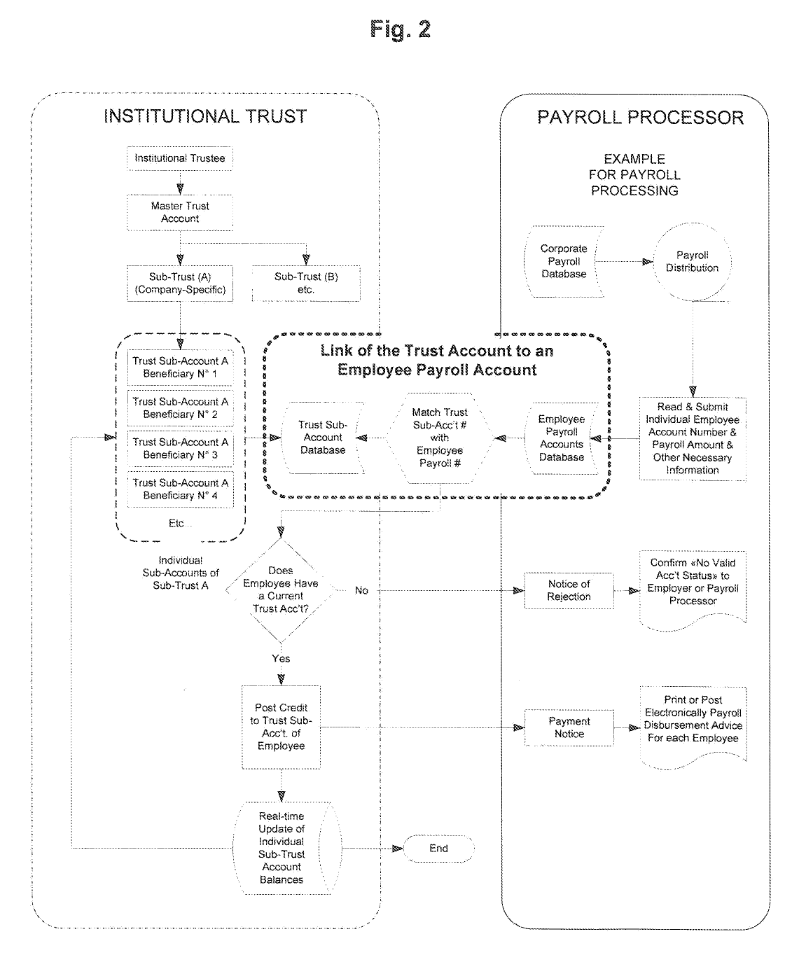

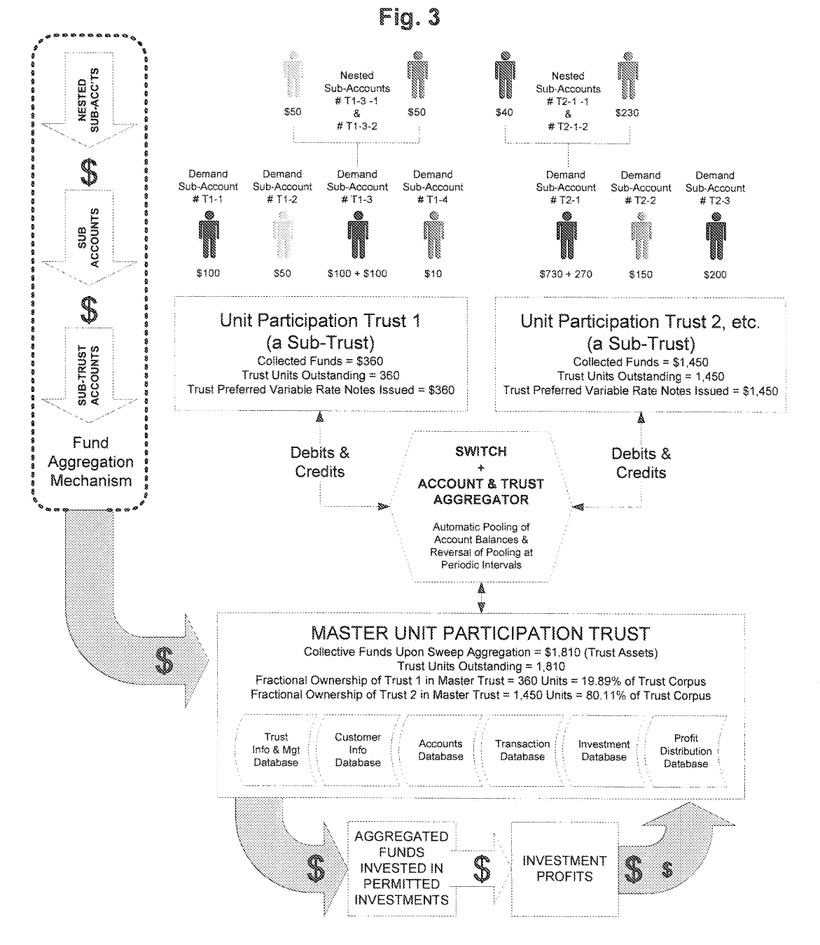

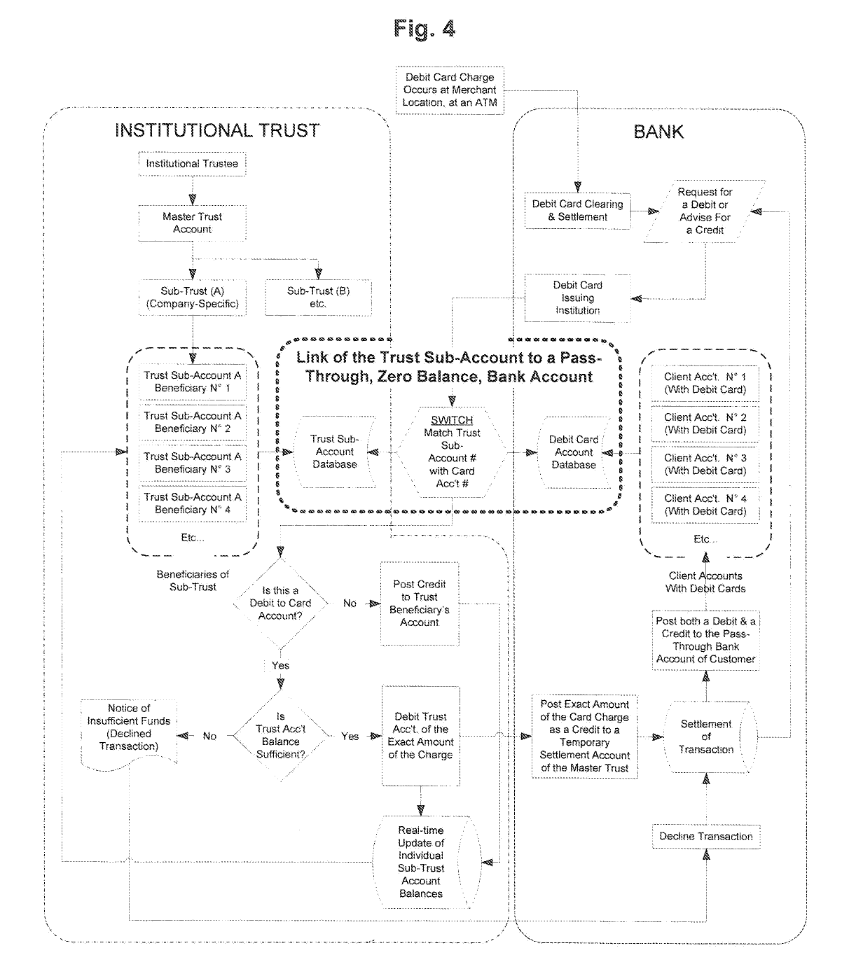

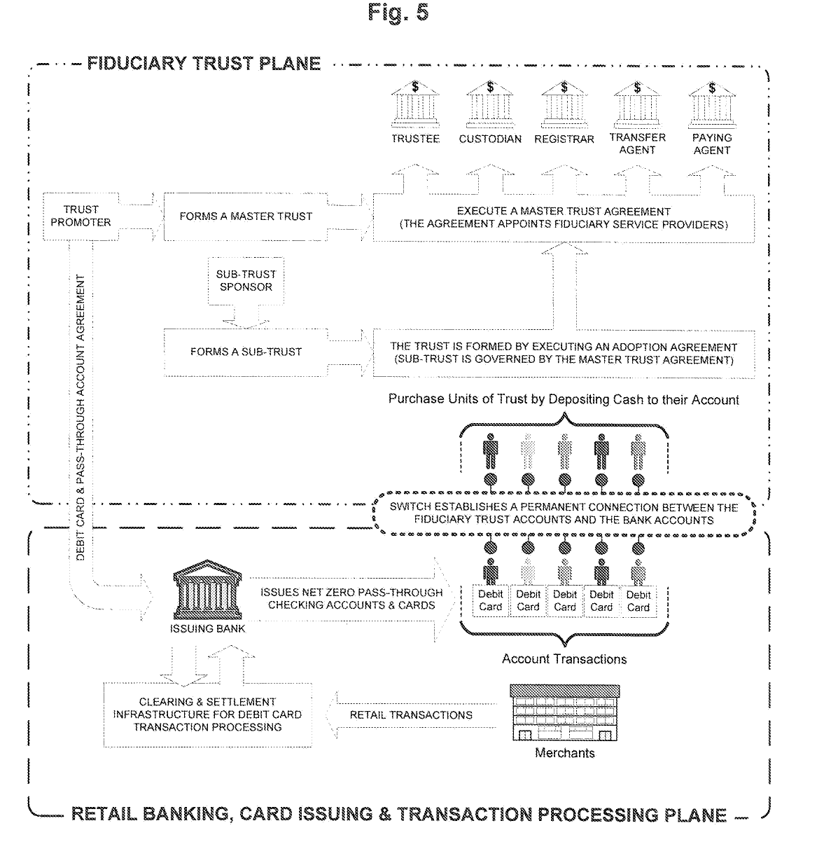

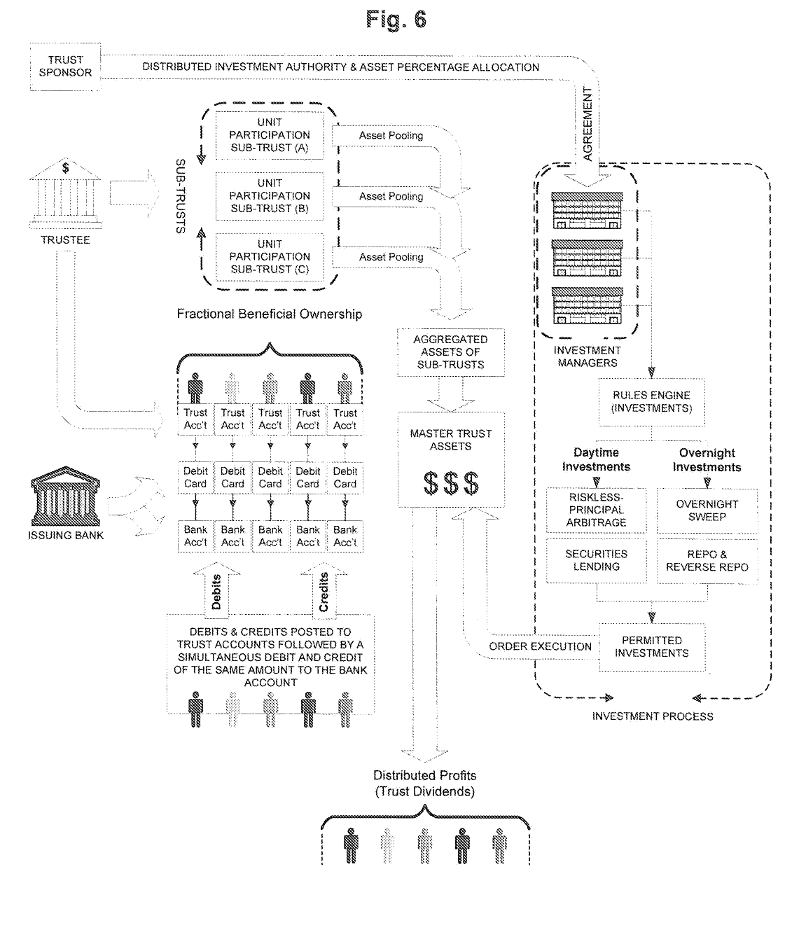

Turning now to the figures for further description of the several embodiments of the invention, FIGS. 1-6 show a revenue-producing, charge card system that also manages account balances to create an investment profit for the card holder. A trust account has a trust-account balance reflecting a first amount of funds, is constructed to subsequently record debits and credits related to the balance, and is constructed for access via remote communication. A bank account has a bank-account balance reflecting an initial zero balance, is constructed to further record debits and credits related to the balance, and is constructed for access via remote communication. A debit card is constructed for communication with the trust account and the bank account, and a switch is in communication with the trust account and bank account. As shown in the mentioned figures, the trust account and the bank account are constructed for intercommunication via the switch so that a card user can pass debits and credits to the trust account through the bank account so that the funds of the trust account can be managed via the trust account.

Still referring to FIGS. 1-6, the debit card is issued by a licensed banking institution but the promoter, marketer, distributor, or sponsoring entity is not a bank. The entity is chosen from the group consisting of an individual, a non-profit entity; a for-profit entity; a governmental organization or non-governmental organization. The for-profit entity may be an employer and the debit card could be issued to an employee of the employer. The debit card can be configured to allow the employee to charge business travel expenses to the employer. In addition, the debit card can be co-branded with the name of the employer and the name of a bank that issues the debit card.

Continuing with the description of FIGS. 1-6, the trust account and its dependent accounts are configured to allow funds that remain in the trust account outside banking hours to be swept out for short term investment and swept back and posted in the account at the opening of the next banking day. The trust account also includes a user-specific sub-trust account having a sub-trust account balance reflecting a third amount of funds and being constructed to post debits and credits to the sub-trust account. Each sub-trust account is configured to accommodate an unlimited number of nested sub-accounts. In addition, each primary sub-account and nested sub-account specify permitted investments that allow funds to be aggregated at a trust level and invested in permitted investments that maximize returns through the application of pre-selected investment strategies that continuously invest funds.

The sub-trust account and each nested sub-account is set up and configured to: (a) receive cash for crediting the user-specific sub-account; (b) post credits for at least one of the following: cash, cash equivalent securities, non-liquid assets (e.g. equity in a home or the value of a stock portfolio), or any combination thereof; and (c) is configured to provide cash to settle charges resulting from card transactions of the cardholder. The credits of cash include regularly recurring deposits such as payroll deposits and/or social security check deposits.

The user-specific sub-trust account is also set up to provide for the withdrawal of cash to settle charges resulting from retail, banking and ATM transactions executed via the use of the debit card.

Still referring to FIGS. 1-6, the bank account is configured for pass-through activity and record-keeping only. At all times, the balance in the bank account is zero and is specifically set up to book a simultaneous credit and a debit for the exact amount of the charge (debit) made on the debit card. Plural sub-trust accounts and plural nested sub-accounts can be set up and configured to: (a) receive cash for crediting the user-specific sub-account; (b) post credits for at least one of the following: cash, cash equivalent securities, non-liquid assets (e.g equity in a home or the value of a stock portfolio), or any combination thereof; and (c) provide cash to settle charges resulting from card transactions of the corresponding cardholder.

The bank account can be configured to report information regarding debit card usage for the debit card linked to that bank account, and can be further set up to report all debit card transactions for the debit card linked to that bank account on a regularly recurring basis. In addition, the bank account can be further set up regularly to report the profits of the corresponding sub-trust account on a recurring basis.

In the system shown in FIGS. 1-6, the trust account includes multiple sub-trust accounts that are respectively connected to a corresponding bank account via the switch. Funds of the sub-trust accounts are seamlessly aggregated on a regular basis, and the aggregated amount of all sub-account balances can be invested to earn revenue from investing in “permitted investments” and for overnight permitted sweep investments. One or more of the sub-trust accounts can be respectively set up to have their own sub-trust accounts so as to be nested by the one or more sub-trust accounts. One or more of the nested sub-trust accounts can also be set up to have their funds aggregated on a regular basis to earn revenue from investing the aggregate amount of the funds.

The debit card corresponding to a particular bank account connected to a nesting sub-trust account can be configured to earn a return from the aggregation of funds for investment at the nesting sub-trust level. The debit card corresponding to a particular bank account can also be configured to earn a return from the aggregation of funds for investment at the trust level.

The system shown in FIGS. 1-6 can also include system infrastructure that includes the switch to connect the bank account and trust sub-account, thereby to allow information and/or debits and credits to flow among the connected accounts, and between the connected accounts and a temporary transaction settlement account. The system infrastructure can also include a Transaction Processing Backbone that includes the switch. The settlement transaction account can be set up to receive credits from multiple sub-trust accounts and to settle debit card transactions for debit cards linked to corresponding bank accounts.

Still referring to FIGS. 1-6, the bank account can be configured as at least one of the following: a demand deposit account, a money market account, a savings account, or a business bank account. The bank account can also be configured with a check writing capability.

The trust account can be configured or formed to include a user-specific sub-trust account set up to segregate: (a) a reserve which is available at all times for settlement of debit card transactions, and (b) an investment account for funds in the sub-trust account beyond the reserve to be aggregated at the trust level and to be invested in permitted investments of the trust. The system infrastructure can be set up to connect multiple user-specific sub-trust accounts having different names and/or legal beneficiaries.

The system infrastructure can be further set up to allow a deposit to a sub-trust account to be posted as follows: (a) a credit to the particular sub-trust account of the depositor; (b) a debit to a master cash account of the trust; and (c) a debit and an immediately offsetting credit to the corresponding bank account linked to the particular sub-trust account via said switch. In addition, the system infrastructure can be further configured to allow a charge made on a debit card to be posted as follows: (a) a debit to the sub-trust account linked to the bank account corresponding to the debit card; (b) a credit to the merchant settlement account; and (c) a debit and an offsetting credit to the bank account corresponding to the debit card and linked to the sub-trust account via said switch.

Completing the description of FIGS. 1-6, the system infrastructure is further set up, for a debit card purchase transaction, to access via said switch the available balance of the sub-trust account linked to the bank account corresponding to the particular debit card and to compare the available balance with the amount of the debit card purchase transaction for authentication and acceptance, if the available balance is sufficient, or, for denial, if the available balance is not sufficient. The bank account and the sub-trust account can be connected, or be in communication, by and via the system infrastructure, and the switch can be configured to route debit card purchase transactions to the account with a higher available balance.

The trust account in FIGS. 1-6 can be formed as at least one of the following: a general, all-purpose unit participation trust, an auction participation trust, a home equity loan participation trust, a real estate deposit participation trust, a commercial equipment lease deposit participation trust, a college savings plan participation trust, a brokerage cash participation trust, a retirement fund participation trust, an endowment fund participation trust, a probate funds participation trust, an escrow participation trust, and/or a health savings participation trust. The charge card can be a debit card, a prepaid card, a stored value card, a gift card, a payroll card, a health savings card, or any other suitable card/transaction device.

The bank account can be configured to provide a credit card to the account holder, whether or not the account holder is connected to the bank account. The bank account can be configured to provide to the account holder, a card such as a prepaid card, a stored-value card, and a gift card, and the card is may or may not be connected to the bank account.

Still referring to FIGS. 1-6, there is also shown a method of producing revenue through a charge card method that also manages account balances to create an investment profit for the card holder. The method includes forming a trust account that has a trust-account balance reflecting a first amount of funds, is constructed to subsequently record debits and credits related to the balance, and is constructed for access via remote communication. The method also includes the steps of using a bank account that has a bank-account balance reflecting an initial zero balance, is constructed to further record debits and credits related to the balance, and is constructed for access via remote communication, and making a debit card constructed for communication with the trust account and the bank account. Also included is the step of configuring a switch in communication between the trust account and bank account. The trust account and the bank account are constructed for intercommunication via the switch so that a card user can pass debits and credits to the trust account through the bank account so that the funds of the trust account can be managed via the trust account.

The making step can involve issuing the debit card in the name of an entity that is not a bank, and the entity can be an individual, a non-profit entity; a for-profit entity; a governmental organization or non-governmental organization. If the entity is for-profit, it could be an employer and the debit card could be issued to an employee of the employer.

The making step can also involve configuring the debit card to allow the employee to charge business travel expenses to the employer, can involve co-branding the debit card with the name of the entity and the name of a bank that issues the debit card.

The forming step can involve configuring the trust account and its dependent accounts to allow funds that remain in the trust account outside banking hours to be swept out for short term investment and swept back and posted in the account at the opening of the next banking day. The forming step can also involve including in the trust account a user-specific sub-trust account having a sub-trust account balance reflecting a third amount of funds and being constructed to post debits and credits to the sub-trust account. The method may also include the step of configuring each sub-trust account, and corresponding nested sub-accounts, to specify permitted investments that allow account balances to be aggregated at a trust level and to be invested in permitted investments that maximize returns through the application of pre-selected investment strategies that continuously invest funds. The method may further include the step of configuring the sub-trust account and each nested sub-account to: (a) receive cash for crediting the user-specific sub-account; (b) post credits for at least one of the following: cash, cash equivalent securities, non-liquid assets (e.g. equity in a home or the value of a stock portfolio), or any combination thereof; and (c) provide cash to settle charges resulting from card transactions of the cardholder. The credits of cash can include regularly recurring deposits, such as for example payroll check deposits or social security check deposits.

The method may further include the step of configuring the user-specific sub-trust account to provide for the withdrawal of cash to settle charges resulting from retail, banking and ATM transactions executed via the use of the debit card. The using step may also involve configuring the bank account for pass-through activity and record-keeping only in such a way that at all times the balance in the bank account is zero and where such account is specifically set up to book a simultaneous credit and a debit for the exact amount of the charge made on the debit card.

The method can also further include the step of configuring the sub-trust accounts and plural nested sub-accounts to: (a) receive cash for crediting the user-specific sub-account; (b) post credits for at least one of the following: cash, cash equivalent securities, non-liquid assets (e.g., equity in a home or the value of a stock portfolio), or any combination thereof; and (c) provide cash to settle charges resulting from card transactions of the corresponding cardholder. The using step can also involve configuring the bank account to report information regarding debit card usage for the debit card linked to that bank account.

The method may also further include the steps of configuring the bank account to report all debit card transactions for the debit card linked to that bank account on a regularly recurring basis, and configuring the bank account to regularly report the profits of the corresponding sub-trust account on a recurring basis.

The forming step can involve having a trust account with plural sub-trust accounts that are respectively connected to a corresponding bank account via the switch. The funds of the sub-trust accounts are seamlessly aggregated on a regular basis; and the aggregated amount of all sub-account balances can be invested to earn revenue from investing in permitted investments and for overnight permitted sweep investments. There may also be the step of configuring at least one of the sub-trust accounts of the multiple sub-trust accounts to have their own sub-trust accounts that can be nested by the at least one sub-trust accounts. At least one of the nested sub-trust accounts can be set up to have their funds aggregated on a regular basis to earn revenue from investing the aggregate amount of the funds. There can also be the step of connecting the debit card corresponding to a particular bank account to a nesting sub-trust account to earn a return from the aggregation of funds for investment in the nesting sub-trust. Also possible is to configure the debit card to a particular bank account to earn a return from the aggregation of funds for investment at the trust level.

The method may also include the step of adding infrastructure that connects the switch to the bank account and trust sub-account, to allow information and/or debits and credits to flow among the connected accounts and between the connected accounts and a temporary transaction settlement account. That adding step may involve infrastructure that includes a Transaction Processing Backbone that includes the switch. The adding step may also involve configuring the settlement transaction account to receive credits from multiple sub-trust accounts, and to settle debit card transactions for debit cards linked to corresponding bank accounts.

The using step of the method may also involve having a bank account with at least one of the following: a demand deposit account; a money market account; a savings account; or a business bank account. The using step may also involve having a bank account with a check writing capability.

The forming step of the method may involve configuring the trust account to include a user-specific sub-trust account that is set up to segregate: (a) a reserve which is available at all times for settlement of debit card transactions, and (b) an investment account for funds in the sub-trust account beyond the reserve to be aggregated at the trust level and to be invested in permitted investments of the trust.

The adding step of the method may also involve infrastructure to connect plural user-specific sub-trust accounts having different names and/or legal beneficiaries. The adding step may also involve infrastructure that is configured to allow a deposit to a sub-trust account to be posted as follows: (a) a credit to the particular sub-trust account of the depositor; (b) a debit to a master cash account of the trust; and (c) a debit and an immediately offsetting credit to the corresponding bank account linked to the particular sub-trust account via said switch. The adding step may also involve infrastructure that is configured to allow a charge made on a debit card to be posted as follows: (a) a debit to the sub-trust account linked to the bank account corresponding to the debit card; (b) a credit to the merchant settlement account; and (c) a debit and an offsetting credit to the bank account corresponding to the debit card and linked to the sub-trust account via said switch.

The adding step may also involve method infrastructure that is configured, for a debit card purchase transaction, to access via the switch the available balance of the sub-trust account connected to the bank account corresponding to the particular debit card and to compare the available balance with the amount of the debit card purchase transaction for authentication and acceptance based upon the sufficiency of the available balance.

When the bank account and the sub-trust account are connected by the infrastructure of the adding step, the configuring-a-switch step may involve configuring the switch to route debit card purchase transactions to the account with a higher available balance.

The forming step of the method may involve a trust account with at least one of the following: a general, all-purpose unit participation trust, a trust for auction participants, a trust for real estate equity, a real estate trust, a trust for commercial equipment leasing, a trust for college savings plans, a trust for holders of stocks and bonds, a trust for a retirement fund, a trust for an endowment fund, a trust to hold probate funds, a trust to hold escrow deposits, and/or a trust to hold health savings accounts.

The making step may include a charge card chosen from the group consisting of a debit card, a prepaid card, a stored value card, a gift card, a payroll card, and a health savings card. The bank account may also configured to provide an optional credit card to the account holder that may or may not be connected to the bank account. The bank account may also be configured to provide to the account holder, a card chosen from the group consisting of a prepaid card, a stored-value card, and a gift card, and the card may or may not be connected to the bank account.

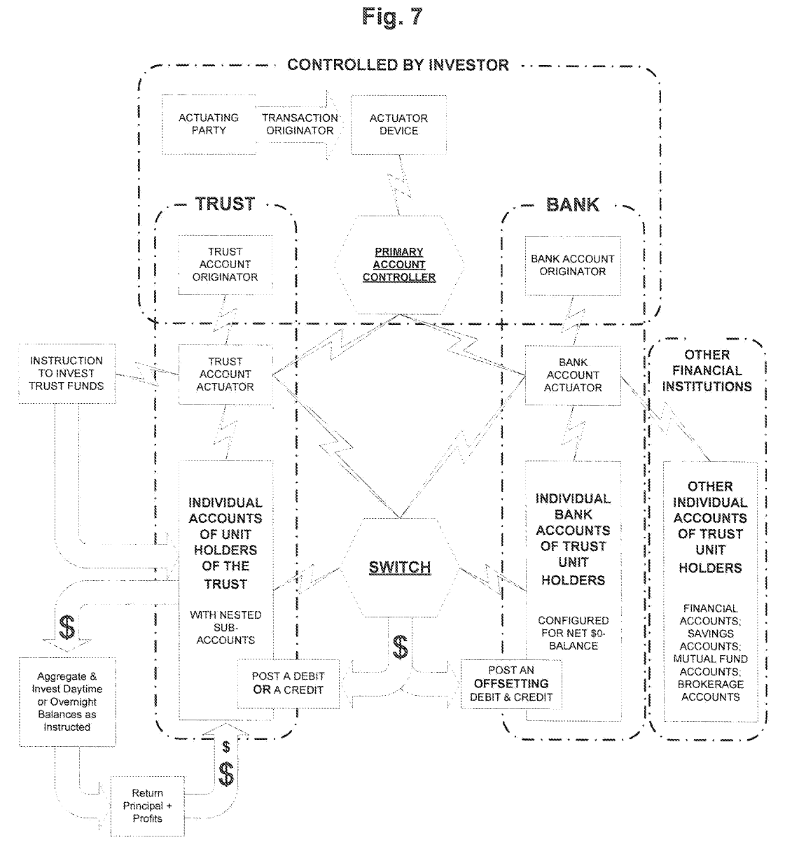

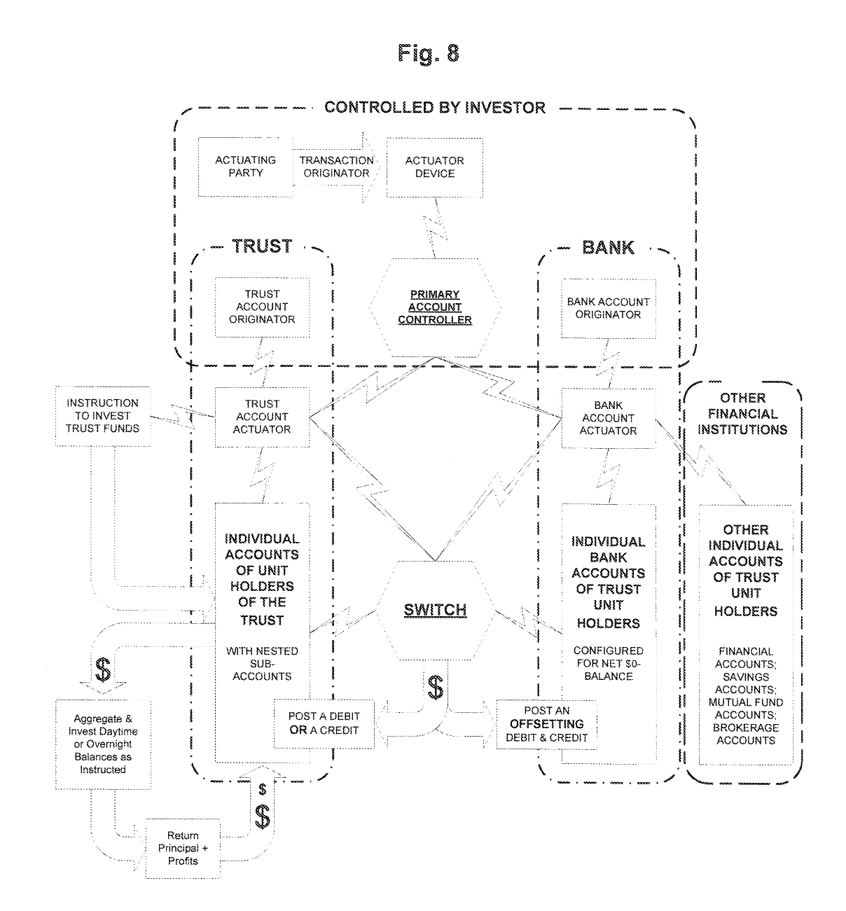

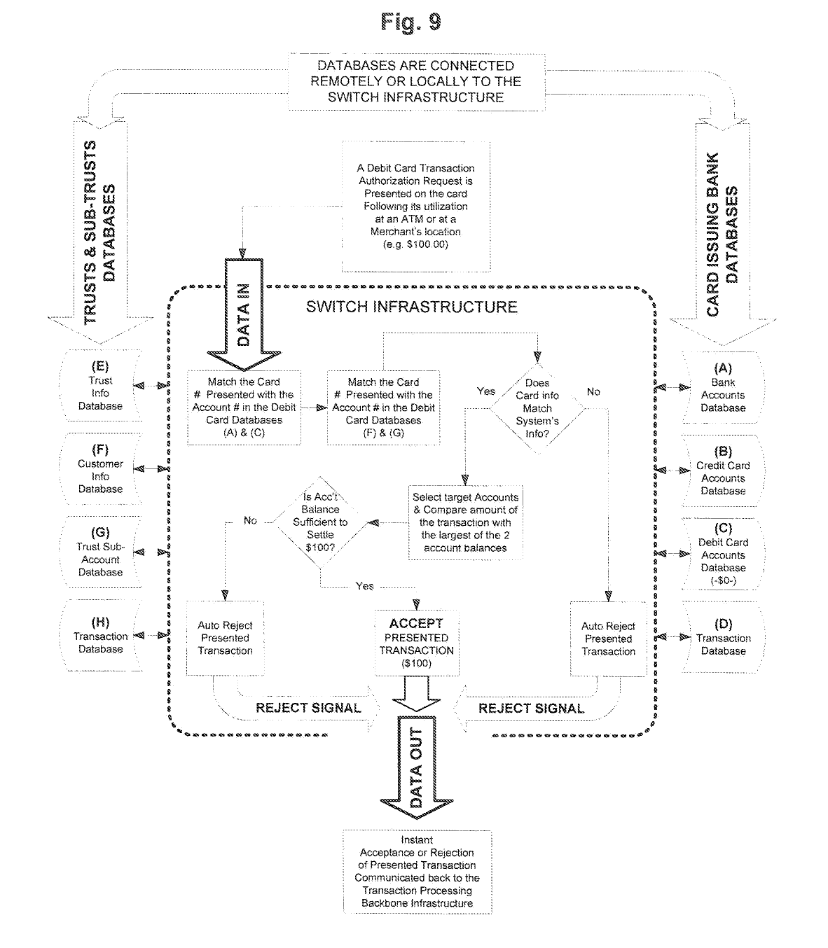

A third embodiment of the invention is a revenue-producing machine for users who have bank accounts. Reference to FIGS. 7-9 will be useful to understand the components of the machine, particularly the transaction actuator which functions as the account actuator shown in those figures. The machine includes (i) a trust-account component that has daytime and overnight balances, is configured to allow balances to be invested, and includes a user-specific trust sub-account that is configured to provide cash required to settle transactions of the user, and (ii) a transaction actuator connected to the trust account and constructed to allow a user to make transactions chosen from the group consisting of debit and credit transactions. The transaction actuator may be constructed as the switch described in connection with the system and method embodiments above. The machine of the invention also includes (iii) a bank-account component configured for pass-through activity only so as to always provide access to a zero balance bank account, and is pre-set to post a simultaneous offsetting debit and credit to the bank account each time the user uses the transaction actuator, and (iv) communication structure for allowing communication between the bank account, the debit card, and the trust account.

The communication structure of the machine includes control circuitry that allows a user to access and manage the trust sub-account and the bank-account component. This control circuitry could be constructed using suitable software, firmware and hardware technology, and also utilizing suitable electronic and telemetric communication technologies. Referring ahead for a moment to certain other components of other embodiments of the invention, a to-be-described trigger mechanism, rule-based controller, account actuator, account originator and trust originator all fit into this same category of being constructed using suitable software, firmware and hardware technology, as well as electronic and telemetric communication technologies. Referring back to the communication structure, it is connectable to plural types of accounts chosen from the group consisting of banking accounts, financial accounts, demand bank deposit accounts, savings accounts, mutual fund accounts, and stock brokerage accounts. The control circuitry can be constructed to allow the user to receive desired monetary transfers into the trust sub-account automatically, and to make desired monetary payments by using money in the trust sub-account.

The communication structure also includes control circuitry that follows pre-selected investment criteria to control how much of the trust sub-account balance is available for aggregation at the trust level for investment purposes. The control circuitry can also be designed to follow pre-selected investment criteria to control what types of investments are made with the money in the trust sub-account, and to store and report characteristics of transaction actuator usage by the user. In addition, the control circuitry can be designed to allow a user to access the user's trust sub-account to view transaction history, current balances, fee schedules, and returns from investments.

A fourth embodiment of the invention is a revenue-producing, debit-card system for a user who has a bank account that is connected to a trust-like structure combined with a debit card connected to the trust-like structure. Reference back to FIGS. 1-6 will be useful to understanding this embodiment. This version is like the embodiment for a revenue-producing charge card system above. The only two differences are that this version includes trust-like structures wherein the unit participation trust structure is replaced by a structured finance architecture involving a bankruptcy-remote special purpose company designed to accommodate any number of stockholders; a trust indenture; a trustee; a custodian; the issuance by the legal entity of callable notes or debentures which may be called at any time and in any fractional amount and where the option to call is revolving so as to give birth to a new call option each time a call is made by withdrawing cash from the stockholder's account; and wherein the architecture is designed for the ultimately purpose of providing a revenue-producing debit card to end users. The second difference is that this version specifically uses a debit card as opposed to the broader concept of a charge card.

Referring to FIGS. 7-9, a fifth embodiment of the invention is a controller, for a networked trust account and a networked bank account that are capable of communicating via a network, that maximizes revenue to the holder of both accounts. The controller includes an account actuator, and both can be constructed using software, firmware, hardware, or a combination thereof. The account actuator is constructed to communicate with the trust account and bank account as the holder desires so that the holder can actuate both via the network to make transactions. The controller may also include a trust-account originator and a bank-account originator. The trust-account originator can be constructed to make a trust account that has daytime and overnight balances, direct overnight balances to be invested according to pre-selected investment criteria, and include a user-specific trust sub-account that is configured to provide cash required to pay charges resulting from card transactions of each user and is configured to receive cash for crediting the user-specific sub-account.

The bank-account originator is constructed to make a bank account configured for pass-through activity to provide a net-zero-balance feature, and to book a simultaneous debit and credit each time the user uses the debit actuator. The bank-account originator is also constructed to make a bank account configured for pass-through activity to provide a net-zero-balance feature, and to book a simultaneous debit and credit each time the user uses the debit actuator.

The account actuator can also include control circuitry that allows a user to access and manage the appropriate trust account, trust sub-account and the bank account. In addition, the account actuator is constructed for communication with plural accounts chosen from the group consisting of banking accounts, financial accounts, demand bank deposit accounts, savings accounts, mutual fund accounts, and stock brokerage accounts.

The account actuator may also include control circuitry for allowing the user to receive desired monetary transfers into the trust sub-account, and to make desired monetary payments by using money in the trust sub-account. Further, the account actuator may include control circuitry that follows pre-selected instructions to report characteristics of account actuator usage by the user.

The account actuator may also include control circuitry that allows a user to access the holder's trust sub-account to view transaction history, current balances, fee schedules, and returns from investments.

The controller may include plural account actuators for corresponding plural holders, with each account actuator being constructed to communicate with the corresponding trust account and corresponding bank account of the corresponding holder, as desired to allow the holder to actuate both the trust account and bank account via the network to make transactions.

Referring again to FIGS. 7-9, a sixth embodiment of the invention is a method of maximizing revenue to the holder of a networked trust account and a networked bank account that are capable of communicating via a network. This method includes the steps of selecting a networked trust account and a networked bank account, and making and using a controller for maximizing revenue to the holder of both accounts. The making step may include constructing an account actuator to communicate with the trust account and bank account as the holder desires so that the holder can actuate both via the network to make transactions. The method may further including originating a trust account and originating a bank account.

The originating step may include constructing a trust account that has daytime and overnight balances, directs overnight balances to be invested according to pre-selected investment criteria, and includes a user-specific trust sub-account that is configured to provide cash required to pay charges resulting from card transactions of each user and is configured to receive cash for crediting the user-specific sub-account.

The originating step also includes constructing a bank account that is configured for pass-through activity to provide a net-zero-balance feature, and is configured to book a simultaneous debit and credit each time the user uses the debit actuator.

The making step also includes constructing an account actuator with control circuitry that allows a user to access and manage the trust account and the bank account. The control circuitry may also be designed to allow a user to access and manage the trust sub-account and the bank account. The making step may also include constructing an account actuator for communication with plural accounts such as banking accounts, financial accounts, demand bank deposit accounts, savings accounts, mutual fund accounts, and brokerage accounts.

The making step may also include constructing an account actuator that includes control circuitry for allowing the user to receive desired monetary transfers into the trust sub-account, and to make desired monetary payments by using money in the trust sub-account. In addition, the making step may include constructing an account actuator that includes control circuitry that follows pre-selected instructions to report characteristics of account actuator usage by the user. The account actuator may also be designed with control circuitry that allows a user to access the holder's trust sub-account to view transaction history, current balances, fee schedules, and returns from investments.

The method may also include the step of adding plural account actuators for corresponding plural holders, and constructing each account actuator to communicate with the corresponding trust account and corresponding bank account of the corresponding holder as desired to allow the holder to actuate both the trust account and bank account via the network to make transactions.

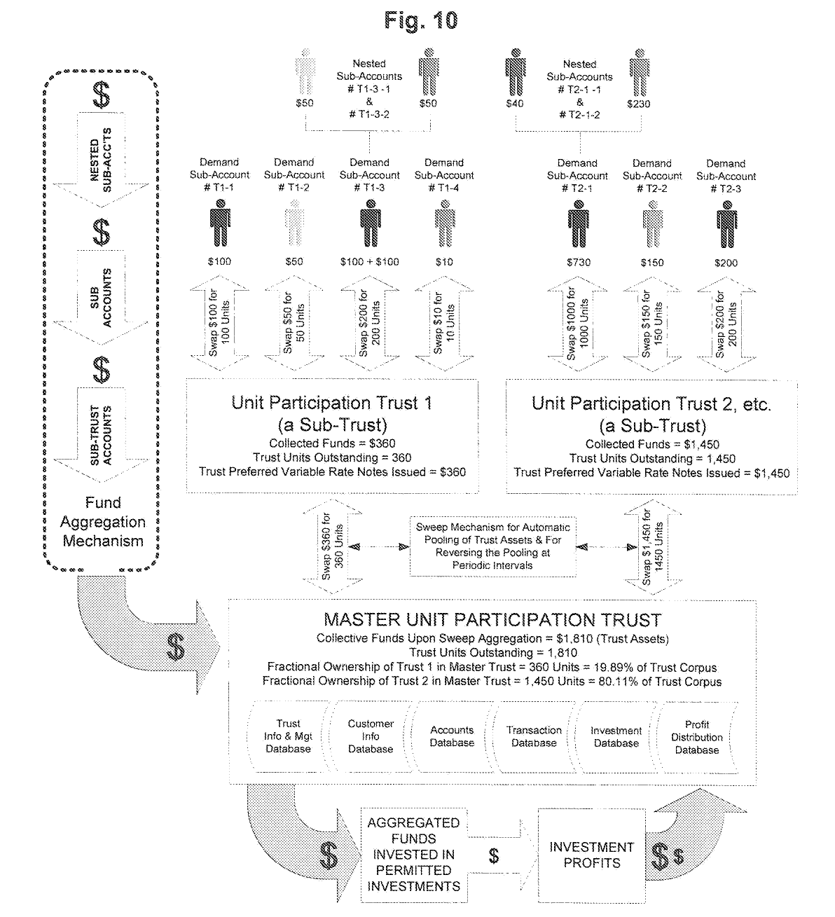

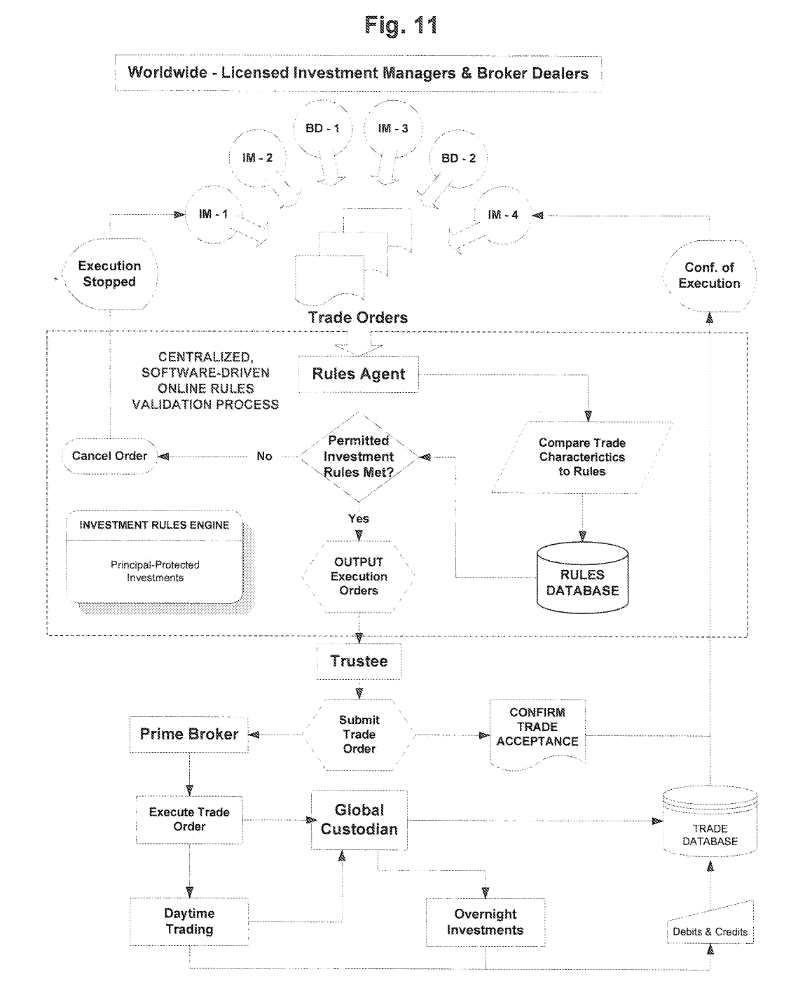

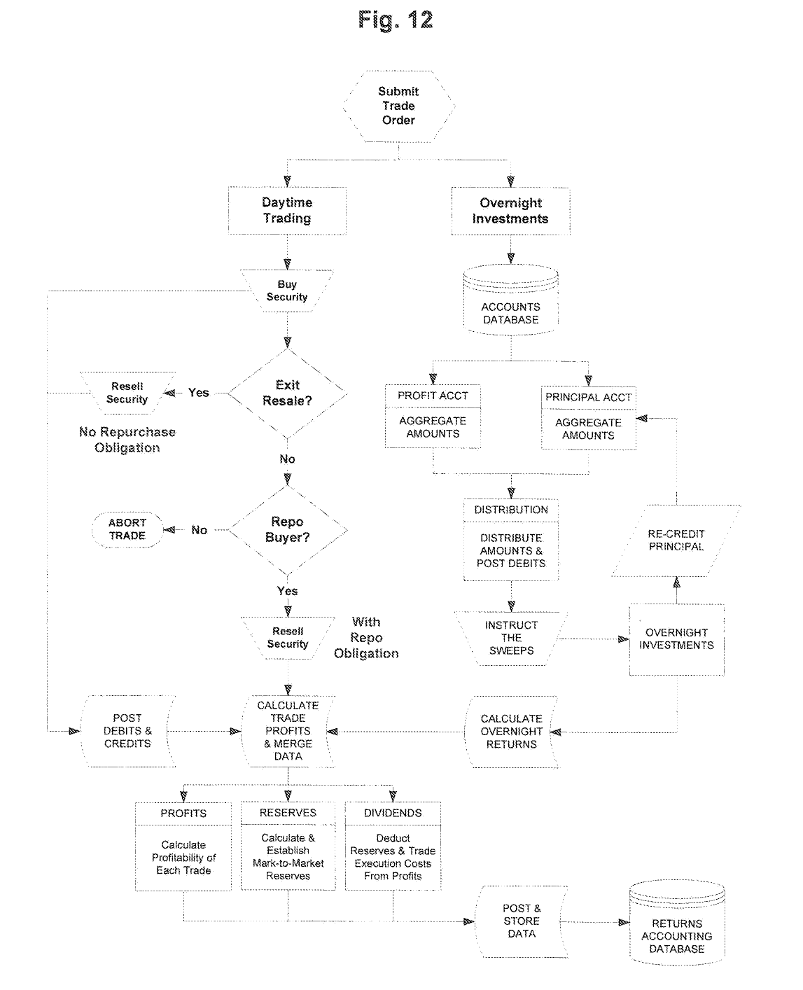

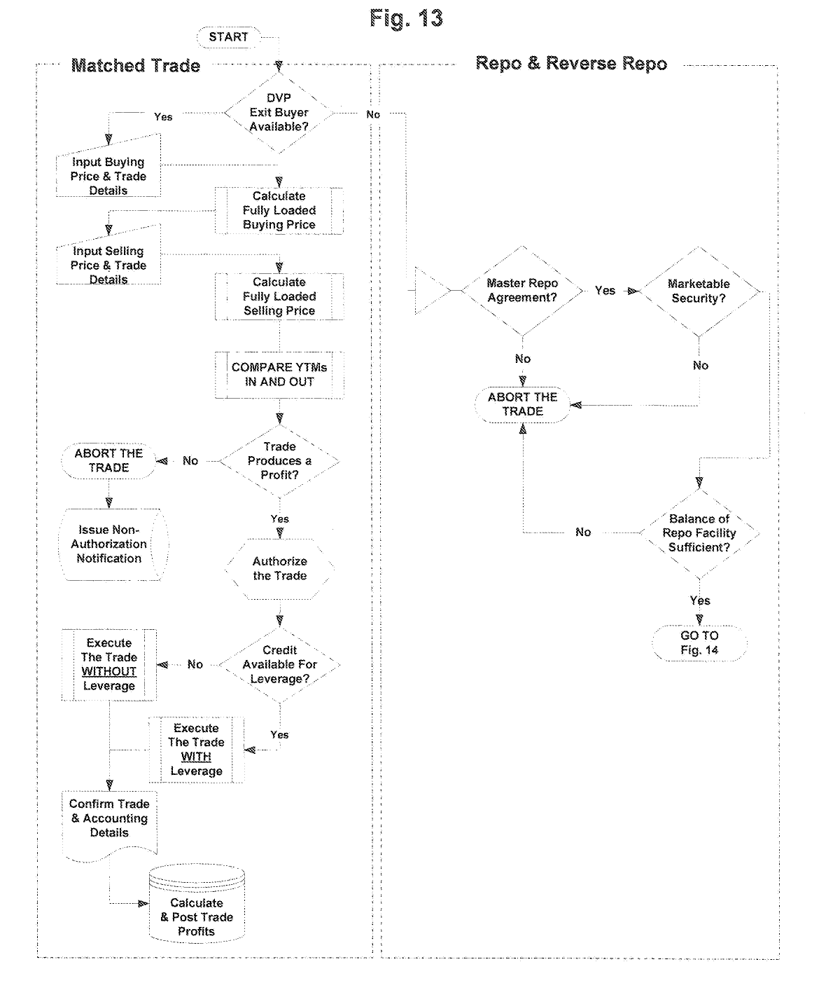

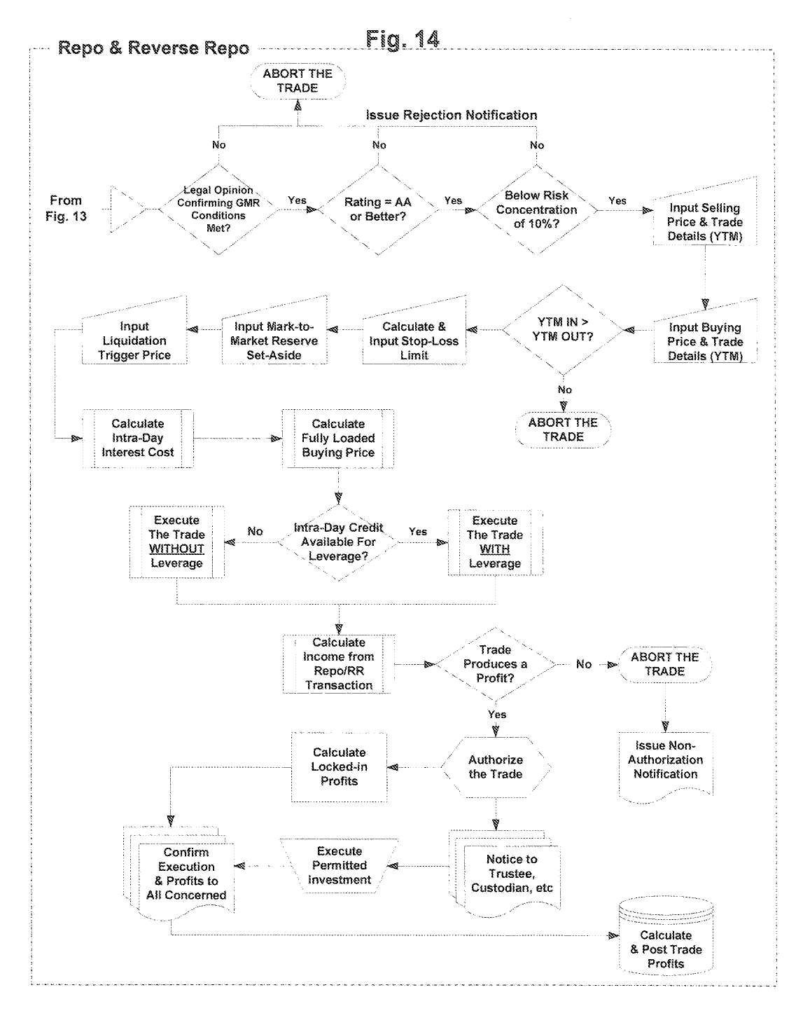

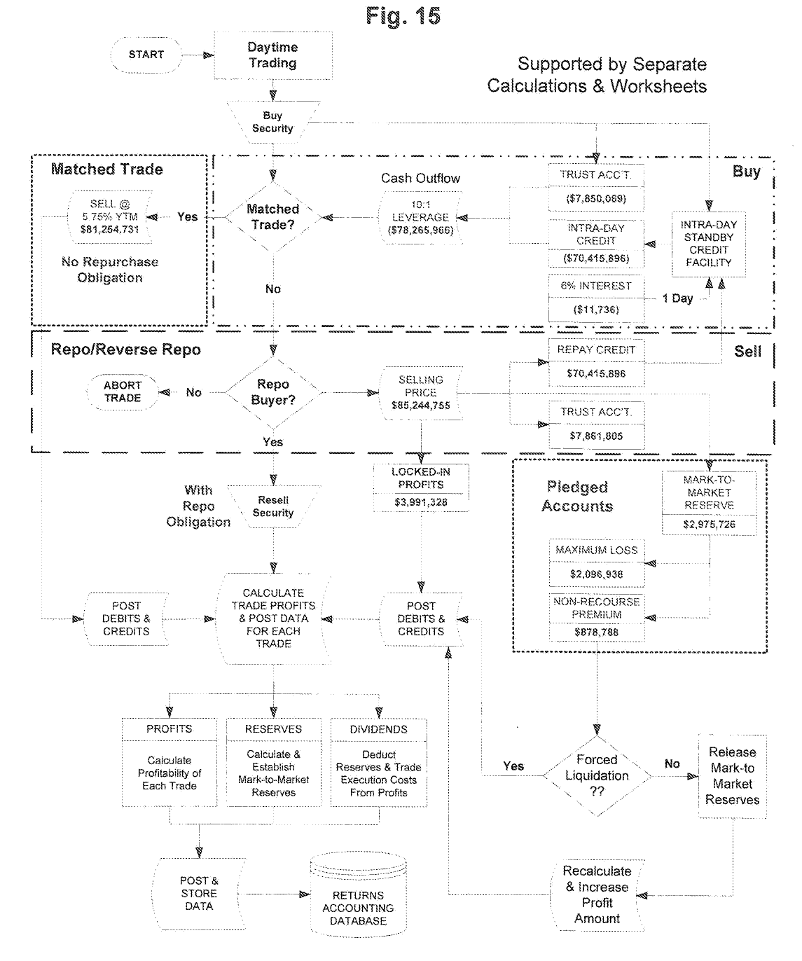

Referring to FIGS. 10-15, a seventh embodiment of the invention is a principal-protected, revenue-producing investment system that includes the following components: (i) an investment mechanism consisting of a unit-participation trust having funds to invest and being divisible into plural trust units, each being ownable by a trust unit holder, (ii) a master trust that includes plural sub-trusts, (iii) a funds-flow mechanism constructed to permit the pooling of investment funds from the sub-trusts to the master trust, (iv) a trust-ownership-conversion structure that converts ownership units into any number of demand deposit sub-accounts and nested sub-accounts, (v) an ownership-interest-determining mechanism for computing the beneficial ownership interest of each trust unit holder at any point in time and for apportioning profits proportionally to trust unit holders, and (vi) an implementation mechanism in communication with the investment mechanism, the master trust, the funds-flow mechanism, the trust-ownership-conversion structure and the ownership-interest-determining mechanism to provide for investment of funds that produce revenue.

The implementation mechanism may include: (i) a selection subsystem for selecting and appointing plural investment professionals for the funds on deposit in the trust and its sub-trusts, (ii) an allocation system for allocating pooled trust assets to plural investment managers, and (iii) a rule-based controller constructed to govern all investment functions according to pre-selected rules.

The rule-based controller is constructed to validate whether an investment is a permitted investment of the trust and whether all the safety and profitability parameters of each proposed investment transaction is met, and to compute and guarantee the locked-in profitability of each permitted investment prior to execution of any investment.

The system may further include a revolving call-option feature, and the trust-ownership-conversion structure may be constructed to convert ownership units into demand sub-accounts through the revolving call-option feature. The investment mechanism may be constructed as a trust-like legal entity that either functions independently or dependently of the master trust. The system may further include a trust-relationship structure that creates a dependency between a single master trust and plural sub-trusts.

The system may also include a legal mechanism that is constructed to permit the assets associated with dependent trusts to flow upstream to the master trust so that the assets of sub-trusts can be aggregated from a nested sub-accounts to a primary sub-account, from a primary sub-account to the trust's consolidated account, and from the trust's consolidated account directly to its own custodial account or to the master trust's consolidated custodial account. The legal mechanism may be constructed to allow the assets of the sub-trusts to be aggregated in desired groups, and it may be constructed to allow the assets of the sub-trusts to be aggregated for the establishment of a single short-term secured credit facility.

The legal mechanism may be constructed to allow the assets of the sub-trusts to be aggregated in the master trust, invested and then redistributed back to the sub-trusts with proportionate profits.

Still referring to FIGS. 10-15, the investment mechanism may also include a unit participation trust including multiple trust-unit holders, and wherein there is an individual, uniquely-designated, trust account for each trust-unit holder that allows the trust-unit holder to embed therein a desired numbered of nested sub-accounts. The individual uniquely-designated trust account can be constructed to allow the trust-unit holder to embed therein a desired number of nested sub-accounts for multiple family members, groups, asset types, and currencies.

The investment mechanism may include a unit participation trust structure that permits assets to be held in any desired currency. The ownership-interest-determining structure may also be constructed to maintain the trust-unit ownership interest of each unit holder at a particular point in time so as to be able to calculate and distribute the fractional investment returns owed each unit holder under the dividend distribution provisions of the trust agreement. The ownership-interest-managing system may also be constructed to segregate the ownership interests of each trust unit holder into two uniquely identified accounts, one for cash balances and one for non-cash assets. Further, the ownership-interest-managing system may be constructed to segregate further the account balances of each trust-unit holder into like-kind asset pools and the funds-flow mechanism is constructed to aggregate, at any point in time, all individual account balances of a unit participation trust into a single like-kind asset account. The ownership-interest-managing system may also be constructed to segregate further the account balances of each trust-unit holder to show a separate balance of cash for each item in the group consisting of currency, stocks & bonds, savings, time deposit, equity ownership in real estate, and life insurance values.

Referring again to FIGS. 10-15, the rule-based controller may also be constructed to invest the aggregated pooled assets into permitted investments of the trust, and to calculate and redistribute the principal and accrued profits back to each sub-account of the trust. The selection system may be constructed to delegate investment responsibilities to plural investment managers and to authorize the managers to direct investments of the aggregated cash balance available at a particular point in time in a master trust account. In addition, the funds-flow mechanism may be constructed to segregate and apportion pooled funds from the group consisting of a master trust and sub-trusts to investment managers who are controlled by the rule-based controller. The rule-based controller can be constructed with a trigger mechanism that authorizes a particular investment to be validated as a permitted investment, and denies the investment if it is not validated.

The rule-based controller may be constructed to receive and analyze the terms and conditions of a transaction to validate the transaction by comparing the particular terms and conditions of the transaction with pre-selected criteria. The rule-based controller may also be constructed to receive and analyze the terms and conditions of a global master repurchase agreement to validate whether the agreement should be entered into with a third-party buyer. In addition, the rule-based controller may be constructed with a system for computing and guaranteeing the profitability of a permitted investment based upon pre-selected criteria.

The pre-selected criteria may include the use of an intra-day credit leverage if available and permitted, the buying and selling prices in a securities transaction, the mark-to-market reserves to cover potential loss of values of a security, stop-loss limits, and premium amounts set aside and committed to secure a non-recourse repo sale execution.

The funds-flow mechanism may be constructed to maintain plural custodial and prime brokerage accounts in the master trust for each sub-trust. The master account may be constructed to be in any desired currency.

The system may be constructed to include plural master trusts, each constructed with plural sub-trusts legally interconnected to facilitate the aggregation of account balances in a single master account where the aggregated pool of trust assets can be invested according to the rule-based controller. The funds-flow mechanism may be constructed to move funds upstream from the dependent sub-trusts to the master trust via the issuance of one item chosen from the group consisting of a secured note, an unsecured note, a pledge of a security, a pledge of collateral, and an accounting entry pursuant to a standby agreement between the master trust and the sub-trust.

In addition, the ownership-interest-determining mechanism may be constructed to hold balance information for liquid asset values and illiquid asset values of trusts and sub-trusts. The ownership-interest-determining mechanism may also be constructed to classify illiquid trust assets that are aggregated in the master account as secured credit when they are pledged. The ownership-interest-determining mechanism may also be constructed to allow individual account holders to join a desired networked group so that individual accounts of group members can be aggregated and pooled for investment purposes. Further, the ownership-interest-determining mechanism may be constructed to have a default currency and to permit sub-account balances to be converted and held in any currency other than the default currency.

Still referring to FIGS. 10-15, the ownership-interest-managing system may be constructed to redistribute investment profits to each original sub-trust account. The ownership-interest-managing system may also be constructed to facilitate the aggregation of the balances of all illiquid asset accounts into a single like-kind master illiquid equity account. In addition, the ownership-interest-managing system can be constructed to allow trusts to hold plural cash and securities accounts of plural sub-trusts, and can be constructed to group plural like-kind master illiquid equity accounts in one of the group consisting of plural master trusts and sub-trusts.

There may also be communication structure for allowing communication between a master bank account, a custodial account and a brokerage account. The rule-based controller may be constructed to define a particular rule applicable to an investment as a critical rule so that if a critical rule is not met the investment will be automatically declined. Further, the rule-based controller may be constructed to permit the underwriting by the trust of fixed income securities that are designed to deliver pre-selected conditions and yields. In addition, the rule-based controller may be constructed to transmit an authorization of a proposed investment to a trustee.

The rule-based controller may also be constructed to transmit the authorization to an asset manager, a custodian and a trust grantor. The rule-based controller may also be constructed to transmit the confirmation of the execution of an investment order to a trustee, asset manager, a custodian and a trust grantor, and may be constructed for electronic communication with investment professionals. The rule-based controller may also be constructed to utilize an electronic numbering system to attach a unique identification code to an authorized investment transaction. The unique numbering system can allow the rule-based controller electronically to access, display and send commercially available information supporting a particular permitted investment transaction. Using the rule-based controller, all the information pertaining to a particular permitted investment can be communicated to inquirers via the communication capability of the rule-based controller following an electronic request using the unique identification number of investment.

Further, the rule-based controller may be constructed to compare data between a global master repo/reverse repo database and a database of proposed investments. The rule-based controller may also be constructed to compare, select and match a particular permitted investment transaction with a repo buyer that offers terms and conditions for the particular investment that meet pre-selected criteria. The rule-based controller may be constructed to allow execution of a repo sale of a security belonging to a master trust to a repo buyer. In addition, the rule-based controller may be constructed: (i) to determine the terms and conditions of a desired repurchase of a security and to pre-establish the interest carry based upon a fixed or variable rate, and (ii) to calculate a profit using the difference in cash flows between the sales proceeds and the buying price, and accounting for deduction of a reserve set aside to cover a pre-set maximum loss established by standing stop-loss liquidation order price.

The rule-based controller may also be constructed to determine whether a permitted investment should be executed as a matched-trade to guarantee an immediate profit and no ongoing repurchase obligations of any kind. Further, the rule-based controller may be constructed to determine whether a permitted investment should be executed as a repo sale that has an ongoing repurchase obligation. The rule-based controller may also be constructed to calculate the profitability of a proposed permitted investment before the rule-based controller sends an execution order to an investment professional.

The system may be designed so that the buying and selling prices of a fixed income security in a permitted investment can be converted from a discount or premium relative to its face value into a yield to maturity (reflected as an annual percentage), and vice-versa. The rule-based controller may also be constructed: (i) to calculate the difference in yields-to-maturity of a security and between two prices (buying and selling) that either reflect a discount or a premium from the face value of a security, and/or (ii) to permit the arbitrage of relative yields or price differentials of fixed income instruments in a buy and resell trade transaction. The rule-based controller may also be constructed to use income from a matched trade or cash flow differences from a buy-resell transaction involving a repo sale of a security, and apply the income to trade settlement expenses, bank charges, brokerage fees, mark-to-market reserve set-aside, repayment of intra-day or longer term credit used in a leveraged trade, interest costs, or premium paid for non-recourse repo sale. The system may also be constructed with a subsystem to assess the commitment of a target buyer in a matched trade transaction or in a contemplated repo sale.

The system may also be constructed with a subsystem: (i) to determine whether the settlement proposed in a matched trade is one of the group consisting of a delivery-versus-payment basis or a payment-versus-delivery basis; (ii) to allow an investment professional to select a method of buying and settling a securities transaction by choosing one from the group consisting of a delivery-versus-payment basis and a payment-versus-delivery basis; (iii) to ascertain the desirability and feasibility of using an intra-day credit facility to leverage a desired matched trade securities transaction; and/or (iv) to compute the potential risk of loss of value of a specified fixed income security, and to deduct from the gross trade profits, a pre-set amount that is sufficient to cover a mark-to-market margin call if the security offered as collateral in a repo sale declines in value over time.

The rule-based controller may be constructed: (i) to ascertain at any moment in time the up-to-date repricing of a fixed income security relative to the current prevailing interest rate market, (ii) to calculate and electronically communicate the up-to-date mark-to-market repricing of securities and the delivery of the repricing data, (iii) to allow a reserve set-aside to be deducted from trade profits upon execution of a trade in order to cover the potential future loss of value of a security in a rising interest rate market from the time a repo sale is executed to the time the security is repurchased from the repo buyer; and/or (iv) to calculate a desirable and pre-determined stop-loss limit in a repo sale of a fixed income security to establish the maximum permitted loss of pre-earned profits in any given repo transaction.

In addition, the rule-based controller may be constructed: (i) to deduct from trade profits an amount sufficient to cover at least one market-to-market margin call up to the amount established by the stop-loss limit; and/or (ii) to aggregate the stop-loss reserves into at least one master account that is pledged to at least one repo buyer until a time when the repurchase obligation in a repo trade is met. The system may also include a trigger mechanism to force the liquidation of a security whenever either: (a) the market-to-market price equals the stop-loss liquidation price, or (b) the mark-to-market price equals the sum of the stop-loss liquidation price plus the premium agreed for a non-recourse liquidation. The rule-based controller may be constructed to calculate, deduct from trade profits, and set aside an amount sufficient for each trade transaction to guarantee that the repo buyer will have no further recourse to the original repo seller in a repo sale transaction, beyond the forfeiture of the set-aside reserve for the transaction in the event the stop-loss order triggers a liquidation sale due to a loss of value of the security.

Still referring to FIGS. 10-15, the system may further include a legal mechanism that is constructed to pledge the premium to a repo buyer supported by the undertaking of the repo buyer to liquidate a collateral security in a repo transaction when the falling market-to-market price of a security reaches the stop-loss limit, on the condition that the liquidation of the security by the repo buyer, when executed, completely relieves the original repo seller from any and all liabilities and obligations to the repo buyer.

The unit participation trust may be replaced by a structured finance architecture involving: (i) a bankruptcy-remote special purpose company designed to accommodate any number of stockholders, a trust indenture, a trustee, a custodian, the issuance by the legal entity of callable notes or debentures which may be called at any time and in any fractional amount and where the option to call is revolving so as to give birth to a new call option each time a call is made by withdrawing cash from the stockholder's account, and (ii) wherein the architecture is designed for the purpose of providing a revenue-producing debit card to end users.

The unit participation trust structure of the system may be replaced by a mutual fund, a mutual banking institution, a unit participation fund or any form of a unit trust. The system may also include a subsystem: (i) for the aggregated investment funds of the trust or its master trust to flow downstream to each trust, then to each primary sub-account, then to each nested sub-account, and/or (ii) enabling the investment profits and interest earned by the master trust or its dependent sub-trusts to flow downstream, first to the sub-trust's consolidated custodial account, then to the primary sub-account of each unit holder, then to each nested sub-account based on the fractional trust units owned at each account holder at a particular point in time relative to the total trust units outstanding at that same point in time.

The system can be constructed to allow holders of primary sub-accounts of a trust to share in the aggregate investment profits attributable to, and distributable to, each if its dependent nested sub-account at any point in time and where the revenue sharing mechanism is engineered be pay a set percentage established by the trust sponsor, promoter or grantor, or left to the discretion of each holder of the primary sub-account.

The system can also be constructed with the trust agreement of the master trust or its dependent sub-trusts being made to provide for different classes of unit holders wherein each unit class can be further structured so as to share in the overall investment profits of the trust in any manner desired by the trust sponsor, grantor or promoter for payment by the trust to the sponsor, grantor, promoter, as well as the holders of primary sub-accounts and nested-sub accounts.

The system may also be constructed with the investment profit sharing percentage being different for each trust and may be changed from time to time. The holders of primary sub-accounts and nested sub-accounts may also be allocated different classes of trust units that have different dividend-sharing benefits and percentages. The sponsors, grantors, and/or promoters of a trust in this system can hold a different class of units that have a different revenue-sharing feature than that of holders of primary sub-accounts and nested sub-accounts.

Referring back to FIGS. 1-6, an eighth embodiment of the invention is an international financial system that includes: (i) trust structure that has daytime and overnight balances available for investment purposes, (ii) network-communication structure that is constructed to allow national and international communication between the trust structure and conventional banks having plural bank accounts, and (iii) transaction-communication structure connected to the trust structure and constructed for communication via the network-communication structure. The trust structure can be configured to allow balances to be invested, the network-communication structure affords communication to and from a bank account of one of the conventional banks, and the bank account is configured for pass-through activity to provide a net-zero-balance feature. The trust structure includes a user-specific sub-structure that is configured to handle cash, and the user-specific sub-structure is configured to provide cash required to settle charges resulting from transactions of the user, and to credit the user-specific sub-account.

The user-specific sub-structure is configured to receive cash or any other form of cash-equivalent instruments or securities for crediting the user-specific sub-account. The bank account may be configured to book a simultaneous offsetting debit and credit each time the user uses the transaction-communication structure, and to report characteristics of card usage by the user.

The system may include plural users, each with bank accounts configured for pass-through activity to provide a net-zero-balance feature. The transaction-communication structure is then constructed as plural transaction cards usable by the corresponding plural users, with each transaction card connected to the trust structure, and with the trust structure configured with a user-specific sub-structure for each user that is configured to provide cash required to pay charges resulting from card transactions of each user and is configured to receive cash for crediting the user-specific sub-account. The bank account is configured to book a simultaneous offsetting debit and credit each time the corresponding user uses the user's transaction card, and to report characteristics of card usage by corresponding users.

The user-specific sub-structures of the trust structure can be configured to be aggregated on a regular basis into an aggregate amount to maximize the capability of each sub-account to earn revenue from investing from the group consisting of intra-day trading, short-term, medium-term, and long-term investments, and overnight sweep investments.

This system embodiment of the invention can also be configured so that when a user uses a corresponding transaction card to perform an activity, such as purchasing an item from a merchant or making a cash withdrawal, the use simultaneously causes a debit to be posted directly to the user-specific sub-structure of the trust associated with the user, a credit to be posted to a temporary merchant settlement account, and posting of offsetting entries consisting of both a credit and a debit of the same amount to the pass-through, net-zero bank account of the user.

The trust structure may be an auction participation trust, a home equity loan participation trust, a real estate deposit participation trust, a commercial equipment lease deposit participation trust, a college savings plan participation trust, a brokerage cash participation trust, a retirement fund participation trust, an endowment fund participation trust, a probate funds participation trust, an escrow participation trust, a health savings participation trust.

The trust structure can also be constructed to include a master trust and dependent sub-trusts which are subdivided into plural trust units, with each trust unit corresponding to a user, and a unit-participation trust constructed to control distribution of the wealth of the master trust among each trust for the benefit of the respective trust beneficiaries.

The user-specific sub-structure is configured to be subdivided into sub-sub-accounts for user-permitted uses. These sub-sub-accounts are like the nested accounts described in connection with previous embodiments.

The trust structure may consists of a unit participation trust where unit holders have a fractional ownership interest in the trust corpus relative to their unit ownership interest relative to the total units of trust issued and outstanding at any point in time. Alternatives to the unit participation trust may include a mutual fund, a mutual banking institution, a unit participation fund, and any form of a unit trust.

For this embodiment, the system of the invention may further include a subsystem for the aggregated investment funds of the trust or its master trust to flow downstream to each trust, then to each unit holder of that trust. There may also be a subsystem for investment profits and interest earned by the master trust or its dependent sub-trusts from investment activities to flow downstream to its dependent trusts and the dependent trust's unit holders/beneficiaries.

The holders of primary sub-accounts of a trust in this system can share in the aggregate investment profits attributable to, and distributable to, each if its dependent nested sub-account at any point in time and where the revenue sharing mechanism is engineered be pay a set percentage established by the trust sponsor, promoter or grantor, or left to the discretion of each holder of the primary sub-account.

The trust agreement of the master trust or its dependent sub-trusts can be constructed to provide for different classes of unit holders wherein each unit class can be further structured so as to share in the overall investment profits of the trust in any manner desired by the trust sponsor, grantor or promoter for payment by the trust to the sponsor, grantor, promoter, as well as the holders of primary sub-accounts and nested-sub accounts. The system the investment profit sharing percentage can be different for each trust and may be changed from time to time. Holders of primary sub-accounts and nested sub-accounts in this system can be allocated different classes of trust units that have different dividend-sharing benefits and percentages.

Sponsors, grantors, promoters of a trust in this system can hold a different class of units that have a different revenue-sharing feature than that of holders of primary sub-accounts and nested sub-accounts. The trust structure could be replaced by a structured finance architecture involving: (i) a bankruptcy-remote special purpose company designed to accommodate any number of stockholders, (ii) a trust indenture, (iii) a trustee, (iv) a custodian, (v) the issuance by the legal entity of callable notes or debentures which may be called at any time and in any fractional amount and where the option to call is revolving so as to give birth to a new call option each time a call is made by withdrawing cash from the stockholder's account, and the architecture could be designed for the purpose of providing participation in the financial system. In this system, a custodial or fiduciary account can replace a conventional bank account.

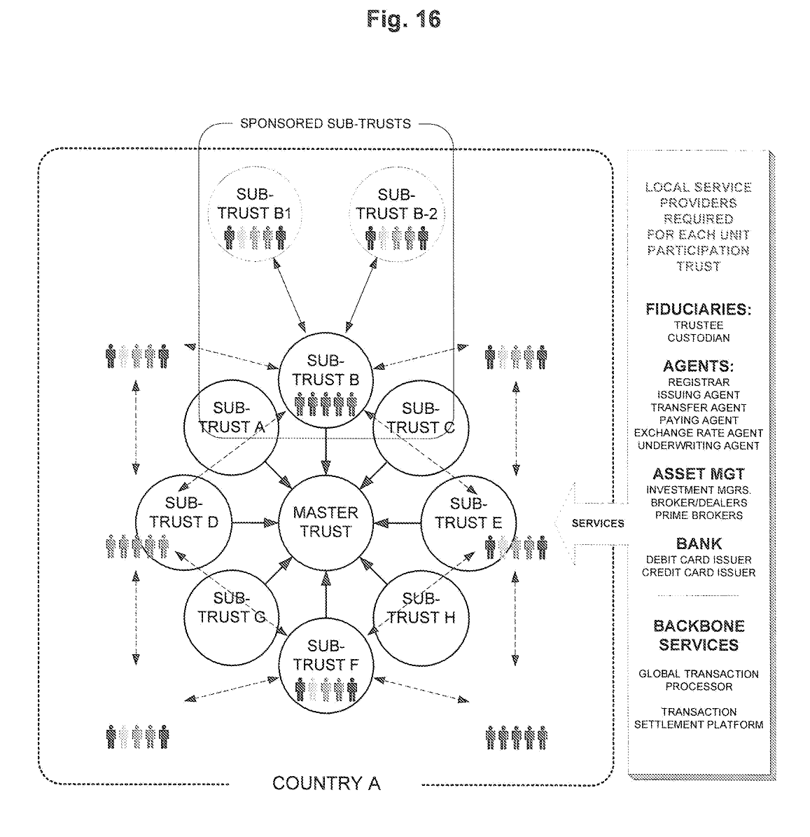

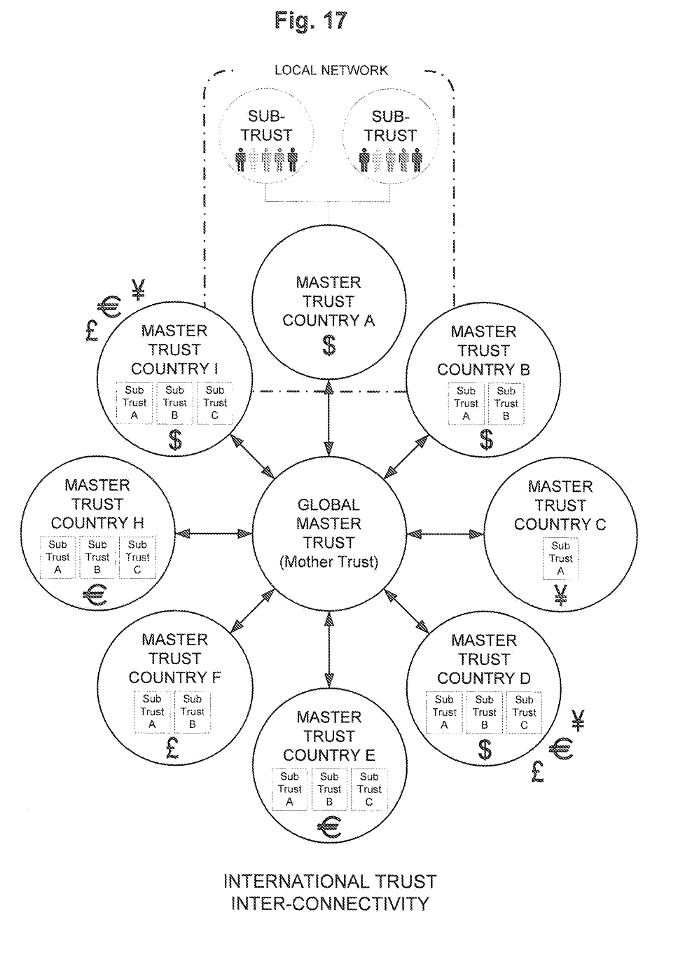

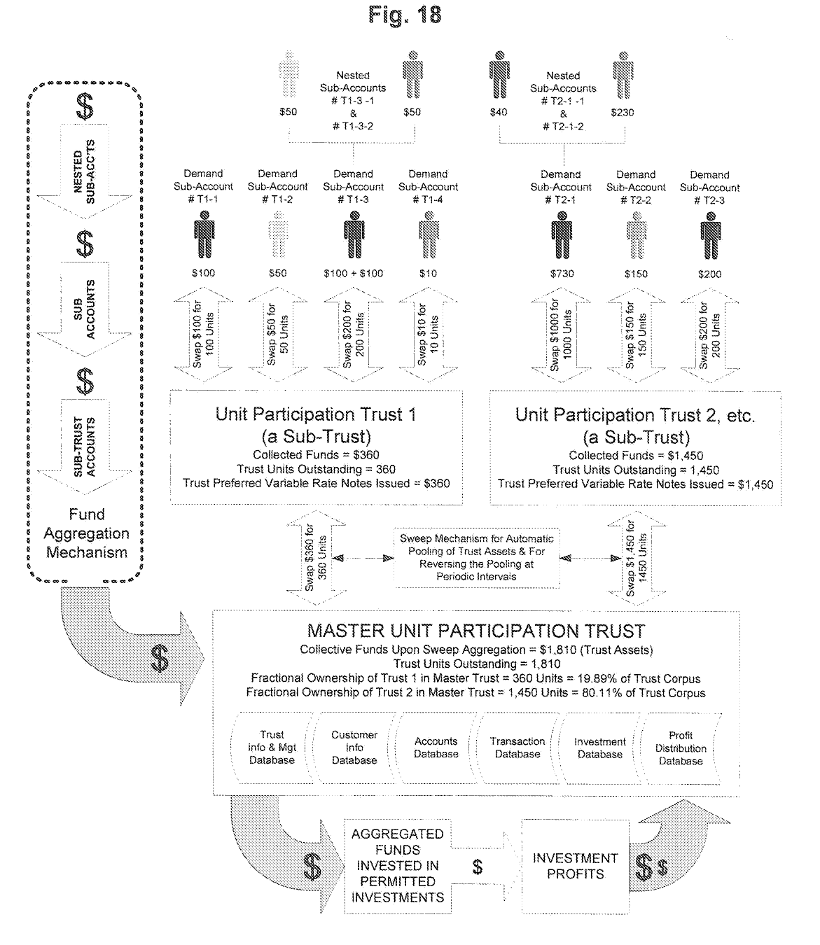

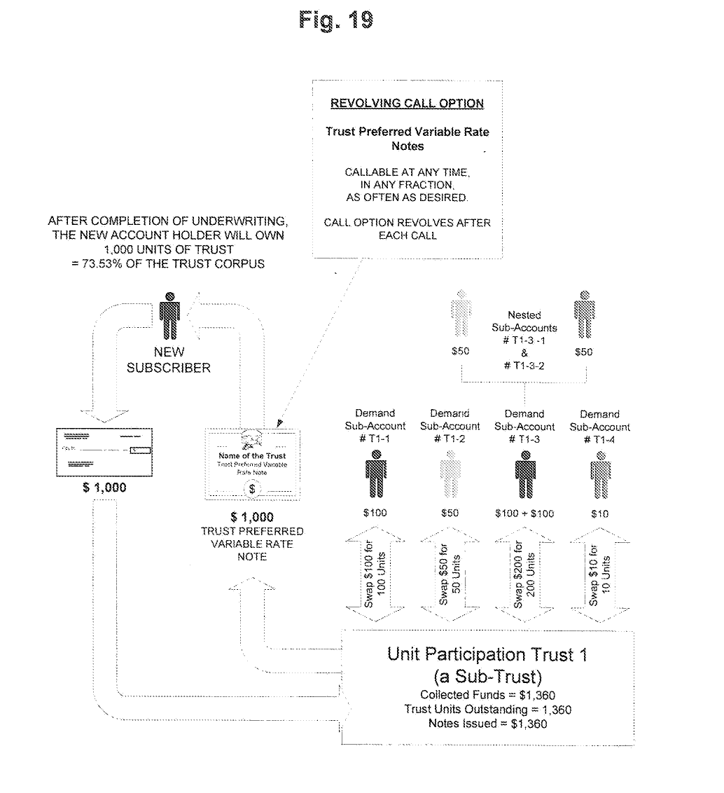

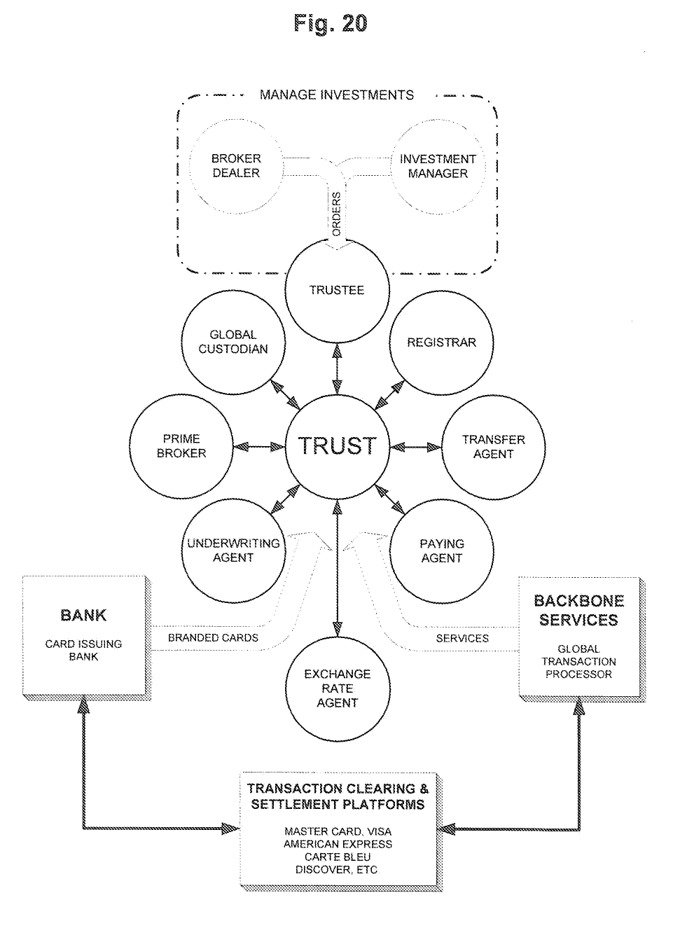

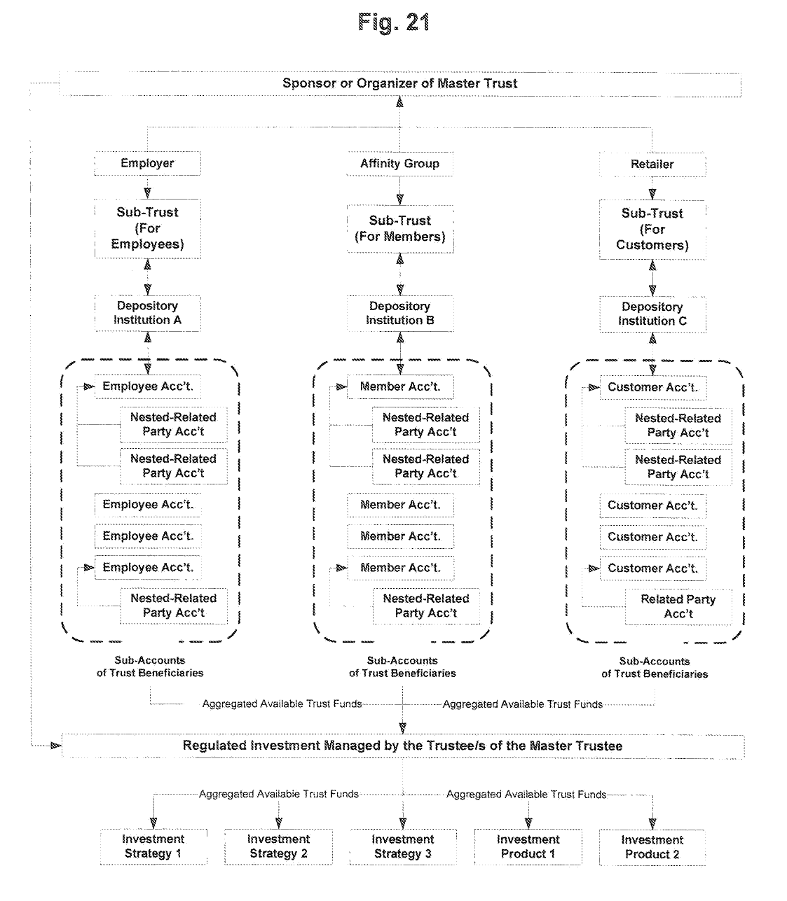

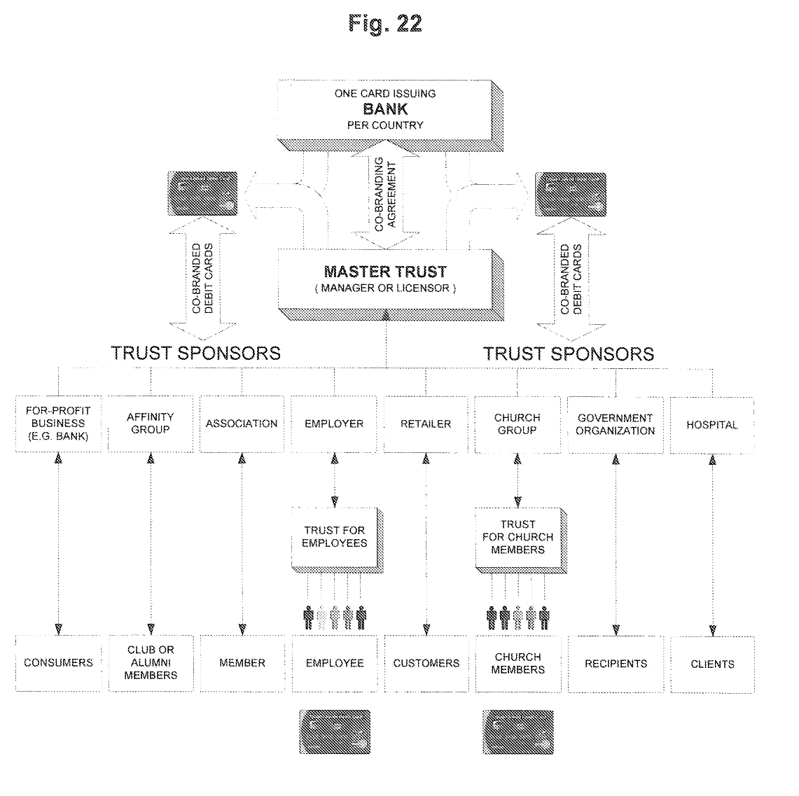

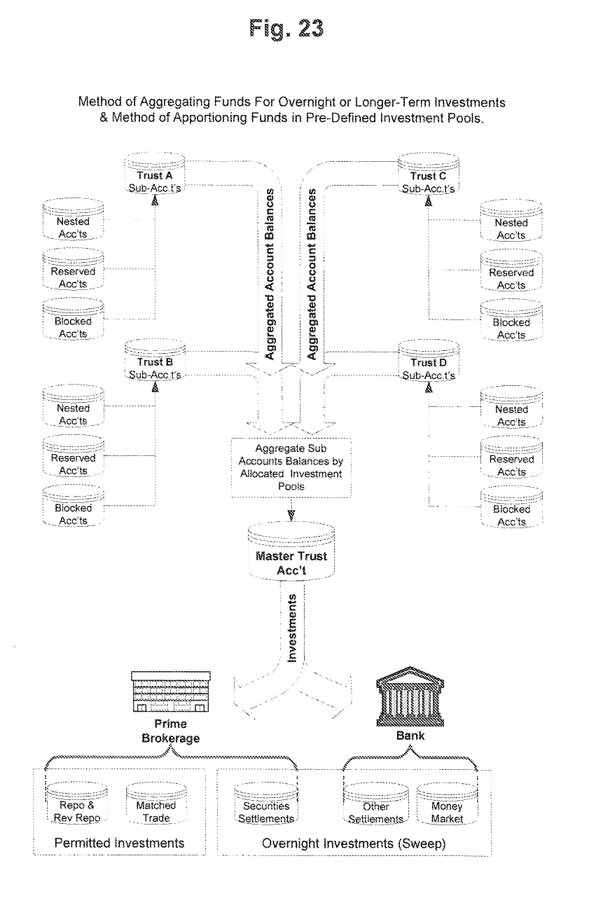

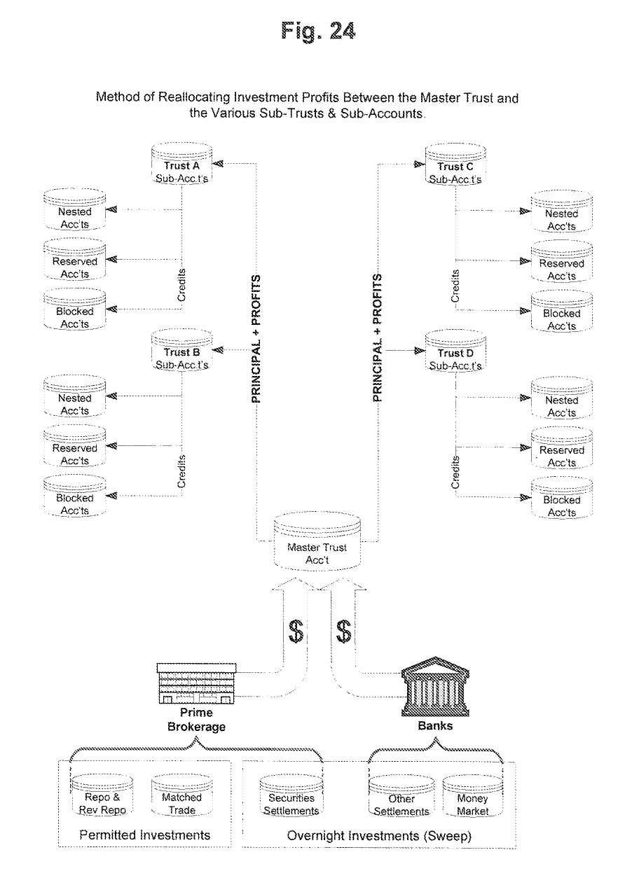

Referring to FIGS. 16-24, a ninth embodiment of the invention is a method of providing an alternative international fiduciary financial system that manages investments and risks associated with the transfer of funds between different entities while enabling non-banking entities to provide traditional banking services without violating per say national and international banking laws. The method includes the steps of: (i) providing plural unit participation trusts, with having a trust corpus, having similar terms and conditions defined in a trust agreement, being configured as sub-trust accounts of a trust, and being connected to corresponding bank accounts, with the corresponding bank accounts being further connected to corresponding check writing facilities and debit cards, (ii) supplying plural account holders, (iii) configuring trust units as plural units of ownership of the trust, and (iv) selecting plural trust beneficiaries, and constructing at least one sub-trust—with choosing plural service providers to the trust and a non-bank promoter of the trust.

The providing step may include making a master trust agreement that governs the trust and is executed between a trust grantor and a trustee. The method may further include the step of providing a legal and fiduciary structure that creates a dependency between the trust and at least one sub-trusts, and the step of aggregating the funds of each sub-trust into the trust to construct an aggregated pool of assets that can be invested by the trust for the benefit of the sub-trusts. The trust may be a trust fund, a bankruptcy-remote special purpose company, a structured investment vehicle, or a unit participation trust.

The configuring step may involve having purchasers of trust units contribute assets to the trust and receive in exchange a trust note evidencing the fractional ownership interest of each purchaser in the trust based upon the value of the contributed assets. The configuring step may also involve converting assets contributed by purchasers into trust units.

The providing step may involve providing a unit participation trust governed by a trust agreement that is structured to enable trust beneficiaries to become fractional beneficial owners of the trust corpus and where one unit of the trust equals one unit of a particular currency. The method may further include the step of providing a legal and fiduciary structure that allows trust units owned by trust-note holders to be redeemed up to the aggregated principal sub-trust account balance. The trust units can also be designed to be redeemed by allowing the exercise of a revolving put option which is defined in the trust agreement.

The step of providing a legal and fiduciary structure may require: (i) that the redeemable face value of each trust note is equal at any point in time to the balance in a trust note holder's trust account, (ii) that the exercise of a put option equates to the withdrawal of assets from a trust note holder's account, and/or (iii) that the posting of a credit to the trust sub-account of a trust note holder automatically increases the face value of the note by the amount of the credit.

In addition, the step of providing a legal and fiduciary structure may require: (i) that the posting of a debit to the trust sub-account of the note automatically decreases the value of the note by the amount of the debit, (ii) that the exercise of a put option at any point in time automatically makes another put option that is legally binding on the trust, (iii) that the a put option is exercisable at any time and in any amount, up to the account balance, and/or (iv) that the exercise of a put option does not require the presentation of the original trust note and can be executed electronically by the posting or a debit to the account.

The method may involve the step of providing a trust-like structure to accommodate plural trust beneficiaries, each having individual sub-trust accounts that further permit the embedding of nested sub-accounts for desired users. There may also be the step of configuring an account/sub-account structure that is designed to hold balance information for asset values. The aggregating step may allow pre-selected assets to be pledged to obtain a secured credit facility.

Still referring to FIGS. 16-24, there can be the step of configuring an account/sub-account structure that is designed to allow individual account holders to join desired networked groups with shared objectives so that individual accounts of group members can be aggregated for investment purposes according to the shared objectives. In addition, there may be the step of forming a master trust with a master account that is associated to plural sub-trusts, whereby each sub-trust is configured to facilitate the aggregation of daily account balances into the master account so that the balance thereof can be invested according to a pre-selected strategy.

The forming step may involve forming a master account in any desired currency, and may involve forming sub-accounts of a master account in a desired currency.

The method may also include the step of selecting a group of service providers to the trust chosen from the group consisting of an institutional trustee, a custodian, a registrar, a paying agent, a transfer agent, an exchange rate agent, an underwriter, an investment manager, a prime broker/dealer, a credit or debit card issuing bank, a global transaction processor, and a transaction processing settlement vendor and/or platform.

The method may also include the step of providing a communication system that allows each user of the financial system to execute desired orders, and a legal structure that segregates the duties, responsibilities and authority of each customer and defines them in the trust agreement.

Still referring to FIGS. 16-24, the method may include the step of providing a communication system for the exchange of data with the customer, and providing a subsystem that effects transfer of funds with the customer.

The method may also include the step of selecting a bank or a non-bank promoter who promotes its own brand of revenue-producing debit cards with a demand deposit checking account feature. The promoter may be a non-banking institution such as a business entity, an affinity group, a consumer group, an employer, a labor union, a retailer, a church, a non-profit organization, and a hospital. The promoter may establish any of various types of trusts, such as a unit participation trust and a sub-trust of a master unit participation trust, for the purpose of operating a bank to be able to offer bank customers an alternative money-making banking product.

Still referring to FIGS. 16-24, the method of this embodiment may include the step of providing a system to create an independent trust for each trust sponsor, and wherein each independent trust is chosen from a unit participation trust or a sub-trust of a master unit participation trust.

The method may involve the promoter engaging in banking through the adoption of a pre-selected master trust agreement. The promoter may also be chosen from bank and non-banking entities, employers, affinity groups, labor unions, retailers, church organizations, non-profit organizations, or governmental entities.

The method may also include a legal structure that allows each trust to become a sub-trust of the master trust, and may include creating a trust sub-account for each trust note holder. The constructing step may involve constructing the sub-account with two balances, one for cash and one for illiquid assets, and may involve constructing the sub-account in any desired currency.

The method may also involve using a switch to connect the sub-account with a debit card, and further, using a switch to connect each sub-account with a corresponding net-zero, pass-through bank account. The method step of using a switch to connect each net-zero, pass-through bank account to one of the group consisting of a debit card and a check, that may be presented for payment against the net-zero pass-through bank account.

The method may also include the step of aggregating or disaggregating the assets of each trust account or sub-account into the master trust account. The disaggregating may include the initial balance of each trust account or sub-account and any additional proportional profit earned on the investments of each trust.

The method may also include the step of consolidating the assets of each sub trust into the master trust, and the step of providing a trust that facilitates the swap of assets in exchange for trust units. The fractional beneficial interest of a trust unit may be evidenced by the issuance of a trust note which is delivered to the account holder upon the opening of an account. Further, each trust unit may be transferable and redeemable by the note holder at any time, in whole or in part.

The note holders of one of the trusts may be fractional beneficial owners of the corresponding trust up to the value of initial contribution of the note holder. Each note holder may have the right to purchase additional trust units by depositing assets to the account of the note holder. The face value of a note may change with each transaction that is posted to it. In addition, the face value of a note may be determined at any point in time by deducting the total of all debits posted to the account of the trust unit holder from the total of all credits posted to it.

The method may involve a financial system that includes plural unit participation trusts that are interconnected with each other by the adoption of a standardized set of pre-selected agreements, terms and conditions, including a trust agreement. Funds of the plural unit participation trusts may be capable of being aggregated regularly to earn revenue on the aggregate amount in the master trust. Each unit participation trust may be constructed with identical rules regarding permitted investments. Excess liquidity in one unit participation trust may be capable of being transferred to another unit participation trust without incurring significantly different investment risk.

The method of this embodiment may involve the transferor unit participation trust having excess liquidity, and/or the transferee unit participation trust may have a liquidity deficit. The unit participation trusts used in this method may be capable of holding both liquid and illiquid assets.

COMPARATIVE ANALYSIS
The table below contrasts the risk & benefits of the two types of debit cards:

| | Traditional Debit Cards | Trust-connected Debit Cards ™ |
|---|---|---|
| | (Linked to a Bank Account) | (Linked to a Trust Sub-Account) |
| a. | A traditional debit card can only be issued | So long as an institutional Trustee serves |
| | by a licensed financial institution. | as Trustee (fiduciary) for the trust (usually |
| | | the trust affiliate of a major bank), any |
| | | corporation or individual that participates in |
| | | the trust arrangements envisioned by this |
| | | proprietary system can cause a TCD Card |
| | | to be issued in favor of other trust |
| | | participants. |
| b. | Bank clients maintain cash on deposit in a | Cardholders maintain a sub-account of a |
| | regular bank account in the name of the | master trust account at the fiduciary |
| | card holder at the card-issuing institution. | institution. Deposits are made to a trust |
| | | account rather than a bank account. The |
| | | institutional Trustee issues the card which |
| | | is automatically linked to the trust account |
| | | instead of a traditional bank account. |
| c. | Client accounts are only protected against | Because a Trustee operates in a fiduciary |
| | bank insolvency up to a maximum of | capacity, trust laws do not permit a trust |
| | $100,000 (FDIC insurance). In Canada and | bank to book trust funds as assets |
| | other countries of the world, the insured | belonging to the institution. Therefore, trust |
| | amount is much less. In the event of the | funds are completely protected from |
| | bank's default, clients with deposits in | creditors in the event the parent of the |
| | excess of the insured amount risk losing the | institutional Trustee becomes insolvent. |
| | excess amount entirely. Even the insured | |
| | limit may take some time to collect from the | |
| | insurance group. | |
| d. | Cash on deposit in a regular bank account | Trust funds are not an asset of the trust |
| | is technically considered an asset of the | bank. To benefit from this leverage banks |
| | bank that can be leveraged by the bank | are willing to pay to gain access to |
| | 10:1 in the United States and up to 20:1 in | overnight funds they can show as bank |
| | Canada.³ | asset for their end-of-day reporting. |
| e. | Banks can re-lend clients' deposits as they | Unlike banks, the trust departments of |
| | become the bank's assets. For this reason, | banks act in a fiduciary capacity. They are |
| | banks decide what constitutes acceptable | only allowed to invest trust funds as |
| | risk and what does not. Though client | permitted by the trust agreement in pre- |
| | funds over $100k are at risk, the depositor | defined investment strategies and products. |
| | has no say in the lending practices of the | It is the asset manager that directs |
| | bank. | investments based on the criteria clearly |
| | | spelled out in the trust agreement. |
| f. | Globally, banks are only required to | Unlike a licensed banking institution, trust |
| | maintain a non-interest bearing reserve | banks cannot be subject to a “run on the |
| | deposit with their central bank. In the | bank”. Because trust funds are managed |
| | United States, this reserve requirement is a | by a fiduciary they are guaranteed to be |
| | maximum of 10% (less in Europe and | available at all times even if assets need to |
| | Canada). This means that in the event of a | be liquidated to satisfy the terms of the trust |
| | run on the bank, only 10% of deposits are | agreement. Hence, the action of one trust |
| | immediately available to satisfy the cash | participant does not affect that of the other |
| | withdrawals of depositors. | trust participants. Investments of the trust |
| | | are usually in investment grade marketable |
| | | securities and are readily convertible to |
| | | cash. |
| | Contrasting Investment Options | |
| g. | Because the fractional reserve banking | Funds in a trust account can only be |
| | system allows banks to leverage and re- | invested by the Trustee as permitted in the |
| | lend their customer deposits up to ten | trust agreement. Investment returns |
| | times, banks make a significant profit by | earned by the trust belong to the trust |
| | lending funds at retail and refinancing | Beneficiaries. As long as the trust |
| | themselves at wholesale rates in the inter- | agreement limits the investment risk to safe |
| | bank market or with the central bank. Little | investment practices and methods, the |
| | or none of this profit is passed on to the | upside potential can be maximized. |
| | bank customer. | |
| h. | Many banks offer corporate and high net | If permitted by the trust agreement, trust |
| | worth clients investment opportunities by | funds can also be made available to banks |
| | “sweeping” cash from deposit accounts to | for their own overnight settlements for a |
| | an overnight investment account. Funds | pre-agreed ROI. Such account “sweeps” |
| | are transferred to the bank at 5:00 PM | simply allow funds to be moved from the |
| | every night and returned to the client's | trust account/s to the benefit of the bank |
| | account when the bank reopens the next | overnight only. Sweep instructions may be |
| | business day. This process enables the | altered at any time. When trust funds are |
| | depositor to earn interest on overnight | swept to the bank, such funds become |
| | investments. Though the bank pays market | available to the bank to be booked as an |
| | rate returns (low by comparison to | asset of the bank for overnight reporting |
| | overnight settlement), any return is better | purposes. |
| | than none. | |
| i. | Many brokerage firms and/or banks offer to | If permitted by the trust agreement, trust |
| | pay high net-worth individuals, corporate | funds can be aggregated and swept to an |
| | clients and institutional funds above | overnight investment account that would |
| | average returns for the privilege of being | then permit securities firms to clear and |
| | able to sweep clients' funds for overnight | settle securities or foreign exchange |
| | settlements of securities transactions | transactions. In that a large number of |
| | involving “repo” and “reverse repo” | small accounts can be aggregated for |
| | strategies. Such agreements yield higher | overnight placement, such large pool of |
| | returns, but are normally off-limit to small | funds would quickly become an attractive |
| | investors, who are rarely even aware that | source of business for financial institutions |
| | such opportunities exist. | that compete for the trust's overnight cash |
| | | business. |
| ³Central banking regulations require each bank to maintain a portion of its cash deposits in a non-interest earning account at the central bank. This reserve set-aside is to protect depositors in case of a run on the bank. Larger banks are often required to maintain larger reserves than smaller ones due to increased liquidity risk. Bank reserves, also known as fractional reserves, are a tool of central bank monetary policy to tighten or loosen its credit policy. A reserve | | |
| # requirement of 10% simply means that the bank can only lend out $90 on a $100 deposit ($10 is kept in reserve by the bank). When re-deposited in the bank by the borrower, the $90 loan becomes a new deposit that can be re-lent again at 90% ($81). This process can continue until a net zero effect is achieved. This “multiplier” effect of money is also referred to as leverage, because a $100 cash deposit can be leveraged into loans totaling $900, so long as the bank's capital ratios | | |
| # (Tier I and Tier II capital) are within the accepted guidelines. | | |

The following sets of numbered paragraphs are provided as additional descriptions of the second-ninth embodiments of the invention:

### Second Embodiment

1. A method of producing revenue through a charge card method that also manages account balances to create an investment profit for the card holder, comprising:

forming a trust account having a trust-account balance reflecting a first amount of funds, being constructed to subsequently record debits and credits related to the balance, and being constructed for access via remote communication;

using a bank account having a bank-account balance reflecting an initial zero balance, being constructed to further record debits and credits related to the balance, and being constructed for access via remote communication;

making a debit card constructed for communication with the trust account and the bank account;

configuring a switch in communication between the trust account and bank account; and

wherein the trust account and the bank account are constructed for intercommunication via the switch so that a card user can pass debits and credits to the trust account through the bank account so that the funds of the trust account can be managed via the trust account.

2. The method of paragraph 1, wherein the making step involves issuing the debit card in the name of an entity that is not a bank.

3. The method of paragraph 2, wherein the entity is chosen from the group consisting of an individual, a non-profit entity, a for-profit entity, a governmental organization or non-governmental organization.

4. The method of paragraph 3, wherein the for-profit entity is an employer and the debit card is issued to an employee of the employer.

5. The method of paragraph 4, wherein the making step involves configuring the debit card to allow the employee to charge business travel expenses to the employer.

6. The method of paragraph 2, wherein the making step involves co-branding the debit card with the name of the entity and the name of a bank that issues the debit card.

7. The method of paragraph 1, wherein the forming step involves configuring the trust account and its dependent accounts to allow funds that remain in the trust account outside banking hours to be swept out for short term investment and swept back and posted in the account at the opening of the next banking day.

8. The method of paragraph 1, wherein the forming step involves including in the trust account a user-specific sub-trust account having a sub-trust account balance reflecting a third amount of funds and being constructed to post debits and credits to the sub-trust account.

9. The method of paragraph 8, further including the step of configuring each sub-trust account and nested sub-accounts to specify permitted investments that allow account balances to be aggregated at a trust level and to be invested in permitted investments that maximize returns through the application of pre-selected investment strategies that continuously invest funds.

10. The method of paragraph 8, further including the step of configuring the sub-trust account and each nested sub-account to: (a) receive cash for crediting the user-specific sub-account; (b) post credits for at least one of the following: cash, cash equivalent securities, non-liquid assets (e.g. equity in a home or the value of a stock portfolio), or any combination thereof; and (c) provide cash to settle charges resulting from card transactions of the cardholder.

11. The method of paragraph 10, wherein the credits of cash include regularly recurring deposits.

12. The method of paragraph 11, wherein the regularly recurring deposits comprise at least one of payroll check deposits or social security check deposits.

13. The method of paragraph 8, further including the step of configuring the user-specific sub-trust account to provide for the withdrawal of cash to settle charges resulting from retail, banking and ATM transactions executed via the use of the debit card.

14. The method of paragraph 8, wherein the using step involves configuring the bank account for pass-through activity and record-keeping only in such a way that at all times the balance in the bank account is zero and where such account is specifically set up to book a simultaneous credit and a debit for the exact amount of the charge made on the debit card.

15. The method of paragraph 14, further including the step of configuring the sub-trust accounts and plural nested sub-accounts to: (a) receive cash for crediting the user-specific sub-account; (b) post credits for at least one of the following: cash, cash equivalent securities, non-liquid assets (e.g. equity in a home or the value of a stock portfolio), or any combination thereof; and (c) provide cash to settle charges resulting from card transactions of the corresponding cardholder.

16. The method of paragraph 15, wherein the using step involves configuring the bank account to report information regarding debit card usage for the debit card linked to that bank account.

17. The method of paragraph 16, further including the step of configuring the bank account to report all debit card transactions for the debit card linked to that bank account on a regularly recurring basis.

18. The method of paragraph 10, further including the step of configuring the bank account to regularly report the profits of the corresponding sub-trust account on a recurring basis.

19. The method of paragraph 10, wherein the forming step involves having a trust account with plural sub-trust accounts, wherein the sub-trust accounts are respectively connected to a corresponding bank account via the switch; wherein funds of the sub-trust accounts are seamlessly aggregated on a regular basis; and wherein the aggregated amount of all sub-account balances can be invested to earn revenue from investing in permitted investments and for overnight permitted sweep investments.

20. The method of paragraph 19, further involving the step of configuring at least one of the sub-trust accounts of the multiple sub-trust accounts to have their own sub-trust accounts that can be nested by the at least one sub-trust accounts.

21. The method of paragraph 20, further including the step of configuring at least one of the nested sub-trust accounts to have their funds aggregated on a regular basis to earn revenue from investing the aggregate amount of the funds.

22. The method of paragraph 21, further including the step of connecting the debit card corresponding to a particular bank account to a nesting sub-trust account to earn a return from the aggregation of funds for investment in the nesting sub-trust.

23. The method of paragraph 19, further including the step of configuring the debit card to a particular bank account to earn a return from the aggregation of funds for investment at the trust level.

24. The method of paragraph 10, further including the step of adding infrastructure that connects the switch to the bank account and trust sub-account, to allow information and/or debits and credits to flow among the connected accounts and between the connected accounts and a temporary transaction settlement account.

25. The method of paragraph 24, wherein the adding step involves infrastructure that includes a Transaction Processing Backbone that includes the switch.

26. The method of paragraph 24, wherein the adding step involves configuring the settlement transaction account to receive credits from multiple sub-trust accounts and to settle debit card transactions for debit cards linked to corresponding bank accounts.

27. The method of paragraph 1, wherein the using step involves having a bank account with at least one of the following: a demand deposit account; a money market account; a savings account; or a business bank account.

28. The method of paragraph 1, wherein the using step involves having a bank account with a check writing capability.

29. The method of paragraph 24, wherein the forming step involves configuring the trust account to include a user-specific sub-trust account that is set up to segregate: (a) a reserve which is available at all times for settlement of debit card transactions, and (b) an investment account for funds in the sub-trust account beyond the reserve to be aggregated at the trust level and to be invested in permitted investments of the trust.

30. The method of paragraph 24, wherein the adding step involves infrastructure to connect plural user-specific sub-trust accounts having different names and/or legal beneficiaries.

31. The method of paragraph 24, wherein the adding step involves infrastructure that is configured to allow a deposit to a sub-trust account to be posted as follows: (a) a credit to the particular sub-trust account of the depositor; (b) a debit to a master cash account of the trust; and (c) a debit and an immediately offsetting credit to the corresponding bank account linked to the particular sub-trust account via the switch.

32. The method of paragraph 24, wherein the adding step involves infrastructure that is configured to allow a charge made on a debit card to be posted as follows: (a) a debit to the sub-trust account linked to the bank account corresponding to the debit card; (b) a credit to the merchant settlement account; and (c) a debit and an offsetting credit to the bank account corresponding to the debit card and linked to the sub-trust account via the switch.

33. The method of paragraph 24, wherein the adding step involves method infrastructure that is configured, for a debit card purchase transaction, to access via the switch the available balance of the sub-trust account connected to the bank account corresponding to the particular debit card and to compare the available balance with the amount of the debit card purchase transaction for authentication and acceptance based upon the sufficiency of the available balance.

34. The method of paragraph 33, wherein, as between the bank account and the sub-trust account connected by the infrastructure of the adding step, the configuring-a-switch step involves configuring the switch to route debit card purchase transactions to the account with a higher available balance.

35. The method of paragraph 1, wherein the forming step involves a trust account with at least one of the following: a general, all-purpose unit participation trust, a trust for auction participants, a trust for real estate equity, a real estate trust, a trust for commercial equipment leasing, a trust for college savings plans, a a trust for holders of stocks and bonds, a trust for a retirement fund, a trust for an endowment fund, a trust to hold probate funds, a trust to hold escrow deposits, and/or a trust to hold health savings accounts.

36. The method of paragraph 1, wherein the making step includes a charge card chosen from the group consisting of a debit card, a prepaid card, a stored value card, a gift card, a payroll card, and a health savings card.

37. The method of paragraph 28, wherein the bank account is also configured to provide an optional credit card to the account holder that is connected to the bank account.

38. The method of paragraph 28, wherein the bank account is also configured to provide an optional credit card to the account holder that is not connected to the bank account.

39. The method of paragraph 28, wherein the bank account is also configured to provide to the account holder, a card chosen from the group consisting of a prepaid card, a stored-value card, and a gift card, and the card is connected to the bank account.

40. The method of paragraph 28, wherein the bank account is configured to provide to the account holder, a card chosen from the group consisting of a prepaid card, a stored-value card, and a gift card, and the card is not connected to the bank account.

### Third Embodiment

1. A revenue-producing machine for users of bank accounts, comprising:

a trust account component that has daytime and overnight balances, is configured to allow balances to be invested, and includes a user-specific trust sub-account that is configured to provide cash required to settle transactions of the user;

a transaction actuator connected to the trust account and constructed to allow a user to make transactions chosen from the group consisting of debit and credit transactions;

a bank-account component configured for pass-through activity only so as to always provide access to a zero balance bank account, and is pre-set to post a simultaneous offsetting debit and credit to the bank account each time the user uses the transaction actuator;

communication structure for allowing communication between the bank account, the debit card, and the trust account.

2. The machine of paragraph 1, wherein the communication structure includes control circuitry that allows a user to access and manage the trust sub-account and the bank-account component.

3. The machine of paragraph 1, wherein the communication structure is connectable to plural types of accounts chosen from the group consisting of banking accounts, financial accounts, demand bank deposit accounts, savings accounts, mutual fund accounts, and stock brokerage accounts.

4. The machine of paragraph 2, wherein the communication structure is connectable to plural types of accounts chosen from the group consisting of banking accounts, financial accounts, demand bank deposit accounts, savings accounts, mutual fund accounts, and brokerage accounts.

5. The machine of paragraph 1, wherein the communication structure includes control circuitry for allowing the user to receive desired monetary transfers into the trust sub-account automatically, and to make desired monetary payments by using money in the trust sub-account.

6. The machine of paragraph 1, wherein the communication structure includes control circuitry that follows pre-selected investment criteria to control how much of the trust sub-account balance is available for aggregation at the trust level for investment purposes.

7. The machine of paragraph 6, wherein the pre-selected investment criteria are user-defined.

8. The machine of paragraph 6, wherein the communication structure includes control circuitry that follows pre-selected investment criteria to control how much of the trust sub-account should be reserved to settle user transactions.

9. The machine of paragraph 6, wherein the communication structure includes control circuitry that follows pre-selected investment criteria to control what types of investments are made with the money in the trust sub-account.

10. The machine of paragraph 1, wherein the communication structure includes control circuitry that follows pre-selected instructions to store and report characteristics of transaction actuator usage by the user.

11. The machine of paragraph 1, wherein the communication structure includes control circuitry that allows a user to access the user's trust sub-account to view transaction history, current balances, fee schedules, and returns from investments.

### Fourth Embodiment

1. A revenue-producing, debit-card system for a user who has a bank account, comprising:

a trust-like structure that has daytime and overnight balances; and

a debit card connected to the trust-like structure.

2. The system of paragraph 1, wherein the trust-like structure is configured to allow balances to be invested.

3. The system of paragraph 1, further including communication structure for allowing communication between the bank account, the debit card, and the trust-like structure.

4. The system of paragraph 3, wherein the bank account is configured for pass-through activity to provide a net-zero-balance feature.

5. The system of paragraph 2 wherein the trust-like structure includes a user-specific sub-structure that is configured to handle cash.

6. The system of paragraph 5, wherein the user-specific sub-structure is configured to provide cash required to settle charges resulting from card transactions of the user.

7. The system of paragraph 5, wherein the user-specific sub-structure is configured to receive cash for crediting the user-specific sub-account.

8. The system of paragraph 6, wherein the user-specific sub-structure is configured to receive cash for crediting the user-specific sub-account.

9. The system of paragraph 3 wherein the bank account is configured to book a simultaneous debit and credit each time the user uses the debit card.

10. The system of paragraph 9, wherein the bank account is also configured to report characteristics of card usage by the user.

11. The system of paragraph 2, further including plural users, each with bank accounts configured for pass-through activity to provide a net-zero-balance feature, plural debit cards usable by the corresponding plural users, with each debit card connected to the trust-like structure, and with the trust-like structure configured with a user-specific sub-structure for each user that is configured to provide cash required to pay charges resulting from card transactions of each user and is configured to receive cash for crediting the user-specific sub-account.

12. The system of paragraph 11, further including communication structure between the bank account of each user, the debit card of each user, and the trust sub-structure of each user.

13. The system of paragraph 12, wherein each bank account is configured to book a simultaneous debit and credit each time the corresponding user uses the user's debit card.

14. The system of paragraph 13, wherein each bank account is also configured to report characteristics of card usage by corresponding users.

15. The system of paragraph 11, wherein the trust sub-structures are configured to be aggregated on a regular basis into an aggregate amount to maximize the capability of each sub-account to earn revenue from investing from the group consisting of intra-day trading, short-term, medium-term, and long-term investments, and overnight sweep investments.

16. The system of paragraph 15, wherein the system is configured so that when a user uses a corresponding debit card to perform an activity from the group consisting of purchasing an item from a merchant and making a cash withdrawal, the use simultaneously causes a debit to be posted directly to the trust sub-structure of the user, a credit to be posted to a temporary merchant settlement account, and posting of both a credit and a debit of the same amount to the pass-through, net-zero bank account of the user.

17. The system of paragraph 2 wherein the trust-like structure is chosen from the group consisting of an auction participation trust, a home equity loan participation trust, a real estate deposit participation trust, a commercial equipment lease deposit participation trust, a college savings plan participation trust, a brokerage cash participation trust, a retirement fund participation trust, an endowment fund participation trust, a probate funds participation trust, an escrow participation trust, a health savings participation trust.

### Fifth Embodiment

1. For use with a networked trust account and a networked bank account that are capable of communicating via a network, a controller for maximizing revenue to the holder of both accounts, comprising:

an account actuator constructed to communicate with the trust account and bank account as the holder desires so that the holder can actuate both via the network to make transactions.

2. The controller of paragraph 1, further including a trust-account originator and a bank-account originator.

3. The controller of paragraph 2, wherein the trust-account originator is constructed to make a trust account that has daytime and overnight balances, directs overnight balances to be invested according to pre-selected investment criteria, and includes a user-specific trust sub-account that is configured to provide cash required to pay charges resulting from card transactions of each user and is configured to receive cash for crediting the user-specific sub-account.

4. The controller of paragraph 2, wherein the bank-account originator is constructed to make a bank account configured for pass-through activity to provide a net-zero-balance feature, and is configured to book a simultaneous debit and credit each time the user uses the debit actuator.

5. The controller of paragraph 3, wherein the bank-account originator is constructed to make a bank account configured for pass-through activity to provide a net-zero-balance feature, and is configured to book a simultaneous debit and credit each time the user uses the debit actuator.

6. The controller of paragraph 1, wherein the account actuator includes control circuitry that allows a user to access and manage the trust account and the bank account.

7. The controller of paragraph 5, wherein the account actuator includes control circuitry that allows a user to access and manage the trust sub-account and the bank account.

8. The controller of paragraph 1, wherein the account actuator is constructed for communication with plural accounts chosen from the group consisting of banking accounts, financial accounts, demand bank deposit accounts, savings accounts, mutual fund accounts, and brokerage accounts.

9. The controller of paragraph 5, wherein the account actuator is constructed for communication with plural accounts chosen from the group consisting of banking accounts, financial accounts, demand bank deposit accounts, savings accounts, mutual fund accounts, and stock brokerage accounts.

10. The controller of paragraph 7, wherein the account actuator is constructed for communication with plural accounts chosen from the group consisting of banking accounts, financial accounts, demand bank deposit accounts, savings accounts, mutual fund accounts, and stock brokerage accounts.

11. The controller of paragraph 6, wherein the account actuator includes control circuitry for allowing the user to receive desired monetary transfers into the trust sub-account, and to make desired monetary payments by using money in the trust sub-account.

12. The controller of paragraph 7, wherein the account actuator includes control circuitry for allowing the user to receive desired monetary transfers into the trust sub-account, and to make desired monetary payments by using money in the trust sub-account.

13. The controller of paragraph 1, wherein the account actuator includes control circuitry that follows pre-selected instructions to report characteristics of account actuator usage by the user.

14. The controller of paragraph 7, wherein the account actuator includes control circuitry that follows pre-selected instructions to report characteristics of account actuator usage by the user.

15. The controller of paragraph 12, wherein the account actuator includes control circuitry that follows pre-selected instructions to report characteristics of account actuator usage by the user.

16. The controller of paragraph 1, wherein the account actuator includes control circuitry that allows a user to access the holder's trust sub-account to view transaction history, current balances, fee schedules, and returns from investments.

17. The controller of paragraph 7, wherein the account actuator includes control circuitry that allows a user to access the holder's trust sub-account to view transaction history, current balances, fee schedules, and returns from investments.

18. The controller of paragraph 12, wherein the account actuator includes control circuitry that allows a user to access the holder's trust sub-account to view transaction history, current balances, fee schedules, and returns from investments.

19. The controller of paragraph 1, further including plural account actuators for corresponding plural holders, each account actuator being constructed to communicate with the corresponding trust account and corresponding bank account of the corresponding holder as desired to allow the holder to actuate both the trust account and bank account via the network to make transactions.

20. The controller of paragraph 7, further including plural account actuators for corresponding plural holders, each account actuator being constructed to communicate with the corresponding trust account and corresponding bank account of the corresponding holder as desired to allow the holder to actuate both the trust account and bank account via the network to make transactions.

21. The controller of paragraph 12, further including plural account actuators for corresponding plural holders, each account actuator being constructed to communicate with the corresponding trust account and corresponding bank account of the corresponding holder as desired to allow the holder to actuate both the trust account and bank account via the network to make transactions.

### Sixth Embodiment

1. A method of maximizing revenue to the holder of a networked trust account and a networked bank account that are capable of communicating via a network, comprising:

selecting a networked trust account and a networked bank account;

making and using a controller for maximizing revenue to the holder of both accounts.

2. The method of paragraph 1, wherein the making step includes constructing an account actuator to communicate with the trust account and bank account as the holder desires so that the holder can actuate both via the network to make transactions.

3. The method of paragraph 2, further including originating a trust account and originating a bank account.

4. The method of paragraph 3, wherein the originating step includes constructing a trust account that has daytime and overnight balances, directs overnight balances to be invested according to pre-selected investment criteria, and includes a user-specific trust sub-account that is configured to provide cash required to pay charges resulting from card transactions of each user and is configured to receive cash for crediting the user-specific sub-account.

5. The method of paragraph 3, wherein the originating step includes constructing a bank account that is configured for pass-through activity to provide a net-zero-balance feature, and is configured to book a simultaneous debit and credit each time the user uses the debit actuator.

6. The method of paragraph 4, wherein the originating step includes constructing a bank account that is configured for pass-through activity to provide a net-zero-balance feature, and is configured to make a simultaneous debit and credit each time the user uses the debit actuator.

7. The method of paragraph 2, wherein the making step includes constructing an account actuator with control circuitry that allows a user to access and manage the trust account and the bank account.

8. The method of paragraph 6, wherein the making step includes constructing an account actuator with control circuitry that allows a user to access and manage the trust sub-account and the bank account.

9. The method of paragraph 2, wherein the making step includes constructing an account actuator for communication with plural accounts chosen from the group consisting of banking accounts, financial accounts, demand bank deposit accounts, savings accounts, mutual fund accounts, and brokerage accounts.

10. The method of paragraph 6, wherein the making step includes constructing an account actuator for communication with plural accounts chosen from the group consisting of banking accounts, financial accounts, demand bank deposit accounts, savings accounts, mutual fund accounts, and brokerage accounts.

11. The method of paragraph 6, wherein the making step includes constructing an account actuator that includes control circuitry for allowing the user to receive desired monetary transfers into the trust sub-account, and to make desired monetary payments by using money in the trust sub-account.

12. The method of paragraph 2, wherein the making step includes constructing an account actuator that includes control circuitry that follows pre-selected instructions to report characteristics of account actuator usage by the user.

13. The method of paragraph 6, wherein the making step includes constructing an account actuator that includes control circuitry that follows pre-selected instructions to report characteristics of account actuator usage by the user.

14. The method of paragraph 6, wherein the making step includes constructing an account actuator that includes control circuitry that allows a user to access the holder's trust sub-account to view transaction history, current balances, fee schedules, and returns from investments.

15. The method of paragraph 6, further including the step of adding plural account actuators for corresponding plural holders, and constructing each account actuator to communicate with the corresponding trust account and corresponding bank account of the corresponding holder as desired to allow the holder to actuate both the trust account and bank account via the network to make transactions.

### Seventh Embodiment

1. A principal-protected, revenue-producing investment system comprising:

an investment mechanism consisting of a unit-participation trust having funds to invest and being divisible into plural trust units, each being ownable by a trust unit holder;

a master trust that includes plural sub-trusts;

a funds-flow mechanism constructed to permit the pooling of investment funds from the sub-trusts to the master trust;

a trust-ownership-conversion structure that converts ownership units into any number of demand deposit sub-accounts and nested sub-accounts;

an ownership-interest-determining mechanism for computing the beneficial ownership interest of each trust unit holder at any point in time and for apportioning profits proportionally to trust unit holders; and

an implementation mechanism in communication with the investment mechanism, the master trust, the funds-flow mechanism, the trust-ownership-conversion structure and the ownership-interest-determining mechanism to provide for investment of funds that produce revenue.

2. The system of paragraph 1, wherein the implementation mechanism includes a selection subsystem for selecting and appointing plural investment professionals for the funds on deposit in the trust and its sub-trusts; an allocation system for allocating pooled trust assets to plural investment managers; a rule-based controller constructed to govern all investment functions according to pre-selected rules.

3. The system of paragraph 2, wherein the rule-based controller is constructed to validate whether an investment is a permitted investment of the trust and whether all the safety and profitability parameters of each proposed investment transaction is met, and to compute and guarantee the locked-in profitability of each permitted investment prior to execution of any investment.

4. The system of paragraph 3, further including a revolving call-option feature, and wherein the trust-ownership-conversion structure converts ownership units into demand sub-accounts through the revolving call-option feature.

5. The system of paragraph 2, wherein the investment mechanism is constructed as a trust-like legal entity that functions independently.

6. The system of paragraph 2, wherein the investment mechanism is constructed as a trust-like legal entity that functions dependently to the master trust.

7. The system of paragraph 2, further including a trust-relationship structure that creates a dependency between a single master trust and plural sub-trusts.

8. The system of paragraph 2, further including a legal mechanism that is constructed to permit the assets associated with dependent trusts to flow upstream to the master trust so that the assets of sub-trusts can be aggregated from a nested sub-accounts to a primary sub-account; from a primary sub-account to the trust's consolidated account; and from the trust's consolidated account directly to its own custodial account or to the master trust's consolidated custodial account

9. The system of paragraph 8, wherein the legal mechanism is constructed to allow the assets of the sub-trusts to be aggregated in desired groups.

10. The system of paragraph 8, wherein the legal mechanism is constructed to allow the assets of the sub-trusts to be aggregated for the establishment of a single short-term secured credit facility.

11. The system of paragraph 9, wherein the legal mechanism is constructed to allow the assets of the sub-trusts to be aggregated in the master trust, invested and then redistributed back to the sub-trusts with proportionate profits.

12. The system of paragraph 2, wherein the investment mechanism includes a unit participation trust including multiple trust-unit holders, and wherein there is an individual, uniquely-designated, trust account for each trust-unit holder that allows the trust-unit holder to embed therein a desired numbered of nested sub-accounts.

13. The system of paragraph 12, wherein the individual uniquely-designated trust account allows the trust-unit holder to embed therein a desired number of nested sub-accounts for multiple family members, groups, asset types, and currencies.

14. The system of paragraph 2, wherein the investment mechanism includes a unit participation trust structure that permits assets to be held in any desired currency.

15. The system of paragraph 2, wherein the ownership-interest-determining structure is constructed to maintain the trust-unit ownership interest of each unit holder at a particular point in time so as to be able to calculate and distribute the fractional investment returns owed each unit holder under the dividend distribution provisions of the trust agreement.

16. The system of paragraph 15, further including an ownership-interest-managing system constructed to segregate the ownership interests of each trust unit holder into two uniquely identified accounts, one for cash balances and one for non-cash assets.

17. The system of paragraph 16, wherein the ownership-interest-managing system is constructed to segregate further the account balances of each trust-unit holder into like-kind asset pools and the funds-flow mechanism is constructed to aggregate, at any point in time, all individual account balances of a unit participation trust into a single like-kind asset account.

18. The system of paragraph 17, wherein the ownership-interest-managing system is constructed to segregate further the account balances of each trust-unit holder to show a separate balance of cash for each item in the group consisting of currency, stocks & bonds, savings, time deposit, equity ownership in real estate, and life insurance values.

19. The system of paragraph 18, wherein the rule-based controller is constructed to invest the aggregated pooled assets into permitted investments of the trust, and to calculate and redistribute the principal and accrued profits back to each sub-account of the trust.

20. The system of paragraph 3, wherein the selection system is constructed to delegate investment responsibilities to plural investment managers and to authorize the managers to direct investments of the aggregated cash balance available at a particular point in time in a master trust account.

21. The system of paragraph 20, wherein the funds-flow mechanism is constructed to segregate and apportion pooled funds from the group consisting of a master trust and sub-trusts to investment managers who are controlled by the rule-based controller.

22. The system of paragraph 14, wherein the rule-based controller includes a trigger mechanism that authorizes a particular investment is validated as a permitted investment, and denies the investment if it is not validated.

23. The system of paragraph 22, wherein the rule-based controller is constructed to receive and analyze the terms and conditions of a transaction to validate the transaction by comparing the particular terms and conditions of the transaction with pre-selected criteria.

24. The system of paragraphs 23, wherein the rule-based controller is constructed to receive and analyze the terms and conditions of a global master repurchase agreement to validate whether the agreement should be entered into with a third-party buyer.

25. The system of paragraph 3, wherein the rule-based controller is constructed with a system for computing and guaranteeing the profitability of a permitted investment based upon pre-selected criteria.

26. The system of paragraph 25, wherein the pre-selected criteria include the use of an intra-day credit leverage if available and permitted, the buying and selling prices in a securities transaction, the mark-to-market reserves to cover potential loss of values of a security, stop-loss limits, and premium amounts set aside and committed to secure a non-recourse repo sale execution.

27. The system of paragraph 3, wherein the funds-flow mechanism is constructed to maintain plural custodial and prime brokerage accounts in the master trust for each sub-trust.

28. The system of paragraph 3, wherein the master account is constructed to be in a desired currency.

29. The system of paragraph 3, further including plural master trusts, each constructed with plural sub-trusts legally interconnected to facilitate the aggregation of account balances in a single master account where the aggregated pool of trust assets can be invested according to the rule-based controller.

30. The system of paragraph 7, wherein the funds-flow mechanism is constructed to move funds upstream from the dependent sub-trusts to the master trust via the issuance of one item chosen from the group consisting of a secured note, an unsecured note, a pledge of a security, a pledge of collateral, and an accounting entry pursuant to a standby agreement between the master trust and the sub-trust.

31. The system of paragraph 9, wherein the ownership-interest-determining mechanism is constructed to hold balance information for liquid asset values and illiquid asset values of trusts and sub-trusts.

32. The system of paragraph 29, wherein the ownership-interest-determining mechanism is constructed to classify illiquid trust assets that are aggregated in the master account as secured credit when they are pledged.

33. The system of paragraph 6, wherein the ownership-interest-determining mechanism is constructed to allow individual account holders to join a desired networked group so that individual accounts of group members can be aggregated and pooled for investment purposes.

34. The system of paragraph 14, wherein the ownership-interest-determining mechanism is constructed to have a default currency and to permit sub-account balances to be converted and held in any currency other than the default currency.

35. The system of paragraph 16, wherein the ownership-interest-managing system is constructed to redistribute investment profits to each original sub-trust account.

36. The system of paragraph 16, wherein the ownership-interest-managing system is constructed to facilitate the aggregation of the balances of all illiquid asset accounts into a single like-kind master illiquid equity account.

37. The system of paragraph 16, wherein the ownership-interest-managing system is constructed to allow trusts to hold plural cash and securities accounts of plural sub-trusts.

38. The system of paragraph 16, wherein the ownership-interest-managing system is constructed to group plural like-kind master illiquid equity accounts in one of the group consisting of plural master trusts and sub-trusts.

39. The system of paragraph 27, further including a communication structure for allowing communication between a master bank account, a custodial account and a brokerage account.

40. The system of paragraph 21, wherein the rule-based controller is constructed to define a particular rule applicable to an investment as a critical rule so that if a critical rule is not met the investment will be automatically declined.

41. The system of paragraph 40, wherein the rule-based controller is constructed to permit the underwriting by the trust of fixed income securities that are designed to deliver pre-selected conditions and yields.

42. The system of paragraph 22, wherein the rule-based controller is constructed to transmit an authorization of a proposed investment to a trustee.

43. The system of paragraph 42, wherein the rule-base controller is constructed to transmit the authorization to an asset manager, a custodian and a trust grantor.

44. The system of paragraph 22, wherein the rule-based controller is constructed to transmit the confirmation of the execution of an investment order to a trustee.

45. The system of paragraph 44, wherein the rule-based controller is constructed to transmit the confirmation to an asset manager, a custodian and a trust grantor.

46. The system of paragraph 22, wherein the rule-based controller is constructed for electronic communication with investment professionals.

47. The system of paragraph 46, wherein the rule-based controller is constructed to utilize an electronic numbering system to attach a unique identification code to an authorized investment transaction.

48. The system of paragraph 47, wherein the unique numbering system allows the rule-based controller electronically to access, display and send commercially available information supporting a particular permitted investment transaction.

49. The system of paragraph 47, wherein all the information pertaining to a particular permitted investment can be communicated to inquirers via the communication capability of the rule-based controller following an electronic request using the unique identification number of investment.

50. The system of paragraph 23, wherein the rule-based controller is constructed to compare data between a global master repo/reverse repo database and a database of proposed investments.

51. The system of paragraph 23, wherein the rule-based controller is constructed to compare, select and match a particular permitted investment transaction with a repo buyer that offers terms and conditions for the particular investment that meet pre-selected criteria.

52. The system of paragraph 23, wherein the rule-based controller is constructed to allow execution of a repo sale of a security belonging to a master trust to a repo buyer.

53. The system of paragraph 52, wherein the rule-based controller is constructed to determine the terms and conditions of a desired repurchase of a security and to pre-establish the interest carry based upon a fixed or variable rate.

54. The system of paragraph 52, wherein the rule-based controller is constructed to calculate a profit using the difference in cash flows between the sales proceeds and the buying price, and accounting for deduction of a reserve set aside to cover a pre-set maximum loss established by standing stop-loss liquidation order price.

55. The system of paragraph 24, wherein the rule-based controller is constructed to determine whether a permitted investment should be executed as a matched-trade to guarantee an immediate profit and no ongoing repurchase obligations of any kind.

56. The system of paragraph 24, wherein the rule-based controller is constructed to determine whether a permitted investment should be executed as a repo sale that has an ongoing repurchase obligation.

57. The system of paragraph 55, wherein the rule-based controller is constructed to calculate the profitability of a proposed permitted investment before the rule-based controller sends an execution order to an investment professional.

58. The system of paragraph 57, wherein the buying and selling prices of a fixed income security in a permitted investment can be converted from a discount or premium relative to its face value into a yield to maturity (reflected as an annual percentage), and vice-versa.

59. The system of paragraph 57, wherein the rule-based controller is constructed to calculate the difference in yields-to-maturity of a security and between two prices (buying and selling) that either reflect a discount or a premium from the face value of a security.

60. The system of paragraph 57, wherein the rule-based controller is constructed to permit the arbitrage of relative yields or price differentials of fixed income instruments in a buy and resell trade transaction.

61. The system of paragraph 57, wherein the rule-based controller is constructed to use income from the group consisting of profits from a matched trade and cash flow differences from a buy-resell transaction involving a repo sale of a security and apply the income the group consisting of trade settlement expenses, bank charges, brokerage fees, mark-to-market reserve set-aside, repayment of intra-day or longer term credit used in a leveraged trade, interest costs, and premium paid for non-recourse repo sale

62. The system of paragraph 56, wherein there is a system in place to assess the commitment of a target buyer in a matched trade transaction or in a contemplated repo sale.

63. The system of paragraph 56, wherein there is a system in place to determine whether the settlement proposed in a matched trade is one of the group consisting of a delivery-versus-payment basis or a payment-versus-delivery basis.

64. The system of paragraph 63, wherein there is a system in place to allow an investment professional to select a method of buying and settling a securities transaction by choosing one from the group consisting of a delivery-versus-payment basis and a payment-versus-delivery basis.

65. The system of paragraph 56, wherein there is a system in place to ascertain the desirability and feasibility of using an intra-day credit facility to leverage a desired matched trade securities transaction.

66. The system of paragraph 56, wherein there is a system in place to compute the potential risk of loss of value of a specified fixed income security, and to deduct from the gross trade profits, a pre-set amount that is sufficient to cover a mark-to-market margin call if the security offered as collateral in a repo sale declines in value over time.

67. The system of paragraph 66, wherein the rule-based controller is constructed to ascertain at any moment in time the up-to-date repricing of a fixed income security relative to the current prevailing interest rate market.

68. The system of paragraph 67, wherein the rule-based controller is constructed to calculate and electronically communicate the up-to-date mark-to-market repricing of securities and the delivery of the repricing data.

69. The system of paragraph 66, wherein the rule-based controller is constructed to allow a reserve set-aside to be deducted from trade profits upon execution of a trade in order to cover the potential future loss of value of a security in a rising interest rate market from the time a repo sale is executed to the time the security is repurchased from the repo buyer.

70. The system of paragraph 55, wherein the rule-based controller is constructed to calculate a desirable and pre-determined stop-loss limit in a repo sale of a fixed income security to establish the maximum permitted loss of pre-earned profits in any given repo transaction.

71. The system of paragraph 70, wherein the rule-based controller is constructed to deduct from trade profits an amount sufficient to cover at least one market-to-market margin call up to the amount established by the stop-loss limit.

72. The system of paragraph 70, wherein the rule-based controller is constructed to aggregate the stop-loss reserves into at least one master account that is pledged to at least one repo buyer until a time when the repurchase obligation in a repo trade is met.

73. The system of paragraph 70, further including a trigger mechanism to force the liquidation of a security whenever either: (a) the market-to-market price equals the stop-loss liquidation price, or (b) the mark-to-market price equals the sum of the stop-loss liquidation price plus the premium agreed for a non-recourse liquidation.

74. The system of paragraph 55, wherein the rule-based controller is constructed to calculate, deduct from trade profits, and set aside an amount sufficient for each trade transaction to guarantee that the repo buyer will have no further recourse to the original repo seller in a repo sale transaction, beyond the forfeiture of the set-aside reserve for the transaction in the event the stop-loss order triggers a liquidation sale due to a loss of value of the security.

75. The system of paragraph 74, further including a legal mechanism that is constructed to pledge the premium to a repo buyer supported by the undertaking of the repo buyer to liquidate a collateral security in a repo transaction when the falling market-to-market price of a security reaches the stop-loss limit, on the condition that the liquidation of the security by the repo buyer, when executed, completely relieves the original repo seller from any and all liabilities and obligations to the repo buyer.

76. The system of paragraph 1, wherein the unit participation trust is replaced by a structured finance architecture involving a bankruptcy-remote special purpose company designed to accommodate any number of stockholders; a trust indenture; a trustee; a custodian; the issuance by the legal entity of callable notes or debentures which may be called at any time and in any fractional amount and where the option to call is revolving so as to give birth to a new call option each time a call is made by withdrawing cash from the stockholder's account; and wherein the architecture is designed for the ultimately purpose of providing a revenue-producing debit card to end users.

76. The system of paragraph 1, wherein the unit participation trust structure is replaced by a mutual fund, a mutual banking institution, a unit participation fund or any form of a unit trust.

77. The system of paragraph 8, further including a system for the aggregated investment funds of the trust or its master trust to flow downstream to each trust, then to each primary sub-account, then to each nested sub-account.

78. The system of paragraph 77, wherein a system for the investment profits and interest earned by the master trust or its dependent sub-trusts can flow downstream, first to the sub-trust's consolidated custodial account, then to the primary sub-account of each unit holder, then to each nested sub-account based on the fractional trust units owned at each account holder at a particular point in time relative to the total trust units outstanding at that same point in time.

79. The system of paragraph 78, wherein holders of primary sub-accounts of a trust can share in the aggregate investment profits attributable to, and distributable to each if its dependent nested sub-account at any point in time and where the revenue sharing mechanism is engineered be pay a set percentage established by the trust sponsor, promoter or grantor, or left to the discretion of each holder of the primary sub-account.

80. The system of paragraph 1, wherein the trust agreement of the master trust or its dependent sub-trusts are written so as to provide for different classes of unit holders wherein each unit class can be further structured so as to share in the overall investment profits of the trust in any manner desired by the trust sponsor, grantor or promoter for payment by the trust to the sponsor, grantor, promoter, as well as the holders of primary sub-accounts and nested-sub accounts.

81. The system of paragraph 80, wherein the investment profit sharing percentage can be different for each trust and may be changed from time to time.

82. The system of paragraph 80, wherein holders of primary sub-accounts and nested sub-accounts can be allocated different classes of trust units that have different dividend-sharing benefits and percentages.

83. The system of paragraph 80, wherein the sponsors, grantors, promoters of a trust can hold a different class of units that have a different revenue-sharing feature than that of holders of primary sub-accounts and nested sub-accounts.

### Eighth Embodiment

1. An international financial system, comprising:

trust structure that has daytime and overnight balances available for investment purposes;

network-communication structure that is constructed to allow national and international communication between the trust structure and conventional banks having plural bank accounts; and

transaction-communication structure connected to the trust structure and constructed for communication via the network-communication structure.

2. The system of paragraph 1, wherein the trust structure is configured to allow balances to be invested.

3. The system of paragraph 1, wherein the network-communication structure affords communication to and from a bank account of one of the conventional banks, and the bank account is configured for pass-through activity to provide a net-zero-balance feature.

4. The system of paragraph 2 wherein the trust structure includes a user-specific sub-structure that is configured to handle cash.

5. The system of paragraph 4, wherein the user-specific sub-structure is configured to provide cash required to settle charges resulting from transactions of the user.

6. The system of paragraph 4, wherein the user-specific sub-structure is configured to receive cash for crediting the user-specific sub-account.

7. The system of paragraph 5, wherein the user-specific sub-structure is configured to receive cash or any other form of cash-equivalent instruments or securities for crediting the user-specific sub-account.

8. The system of paragraph 3 wherein the bank account is configured to book a simultaneous offsetting debit and credit each time the user uses the transaction-communication structure.

9. The system of paragraph 8, wherein the bank account is also configured to report characteristics of card usage by the user.

10. The system of paragraph 3, further including plural users, each with bank accounts configured for pass-through activity to provide a net-zero-balance feature, wherein the transaction-communication structure is constructed as plural transaction cards usable by the corresponding plural users, with each transaction card connected to the trust structure, and with the trust structure configured with a user-specific sub-structure for each user that is configured to provide cash required to pay charges resulting from card transactions of each user and is configured to receive cash for crediting the user-specific sub-account.

11. The system of paragraph 10, wherein each bank account is configured to book a simultaneous offsetting debit and credit each time the corresponding user uses the user's transaction card.

12. The system of paragraph 11, wherein each bank account is also configured to report characteristics of card usage by corresponding users.

13. The system of paragraph 10, wherein the user-specific sub-structures of the trust structure are configured to be aggregated on a regular basis into an aggregate amount to maximize the capability of each sub-account to earn revenue from investing from the group consisting of intra-day trading, short-term, medium-term, and long-term investments, and overnight sweep investments.

14. The system of paragraph 13, wherein the system is configured so that when a user uses a corresponding transaction card to perform an activity from the group consisting of purchasing an item from a merchant and making a cash withdrawal, the use simultaneously causes a debit to be posted directly to the user-specific sub-structure of the trust associated with the user, a credit to be posted to a temporary merchant settlement account, and posting of offsetting entries consisting of both a credit and a debit of the same amount to the pass-through, net-zero bank account of the user.

15. The system of paragraph 2 wherein the trust structure is chosen from the group consisting of an auction participation trust, a home equity loan participation trust, a real estate deposit participation trust, a commercial equipment lease deposit participation trust, a college savings plan participation trust, a brokerage cash participation trust, a retirement fund participation trust, an endowment fund participation trust, a probate funds participation trust, an escrow participation trust, a health savings participation trust.

18. The system of paragraph 1, wherein the trust structure is constructed to include a master trust and dependent sub-trusts which are subdivided into plural trust units, with each trust unit corresponding to a user, and a unit-participation trust constructed to control distribution of the wealth of the master trust among each trust for the benefit of the respective trust beneficiaries.

19. The system of paragraph 7, wherein the user-specific sub-structure is configured to be subdivided into sub-sub-accounts for user-permitted uses.

20. The system of paragraph 1, wherein the trust structure consists of a unit participation trust where unit holders have a fractional ownership interest in the trust corpus relative to their unit ownership interest relative to the total units of trust issued and outstanding at any point in time.

21. The system of paragraph 20, wherein an alternative structure to a unit participation trust is chosen from the group consisting of a mutual fund, a mutual banking institution, a unit participation fund, and any form of a unit trust.

22. The system of paragraph 20, further including a system for the aggregated investment funds of the trust or its master trust to flow downstream to each trust, then to each unit holder of that trust.

23. The system of paragraph 20, wherein a system for investment profits and interest earned by the master trust or its dependent sub-trusts from investment activities to flow downstream to its dependent trusts and the dependent trust's unit holders/beneficiaries.

24. The system of paragraph 20, wherein holders of primary sub-accounts of a trust can share in the aggregate investment profits attributable to, and distributable to each if its dependent nested sub-account at any point in time and where the revenue sharing mechanism is engineered be pay a set percentage established by the trust sponsor, promoter or grantor, or left to the discretion of each holder of the primary sub-account.

25. The system of paragraph 20, wherein the trust agreement of the master trust or its dependent sub-trusts are written so as to provide for different classes of unit holders wherein each unit class can be further structured so as to share in the overall investment profits of the trust in any manner desired by the trust sponsor, grantor or promoter for payment by the trust to the sponsor, grantor, promoter, as well as the holders of primary sub-accounts and nested-sub accounts.

26. The system of paragraph 25, wherein the investment profit sharing percentage can be different for each trust and may be changed from time to time.

27. The system of paragraph 25, wherein holders of primary sub-accounts and nested sub-accounts can be allocated different classes of trust units that have different dividend-sharing benefits and percentages.

28. The system of paragraph 25, wherein the sponsors, grantors, promoters of a trust can hold a different class of units that have a different revenue-sharing feature than that of holders of primary sub-accounts and nested sub-accounts.

29. The system of paragraph 1, wherein the trust structure is replaced by a structured finance architecture involving a bankruptcy-remote special purpose company designed to accommodate any number of stockholders; a trust indenture; a trustee; a custodian; the issuance by the legal entity of callable notes or debentures which may be called at any time and in any fractional amount and where the option to call is revolving so as to give birth to a new call option each time a call is made by withdrawing cash from the stockholder's account; and wherein the architecture is designed for the ultimately purpose of providing participation in the financial system.

30. The system of paragraph 3, wherein a custodial or fiduciary account replaces a conventional bank account.

### Ninth Embodiment

1. A method of providing an alternative international fiduciary financial system that manages investments and risks associated with the transfer of funds between different entities while enabling non-banking entities to provide traditional banking services without violating per say national and international banking laws, comprising:
providing plural unit participation trusts, with having a trust corpus, having similar terms and conditions defined in a trust agreement, being configured as sub-trust accounts of a trust, and being connected to corresponding bank accounts, with the corresponding bank accounts being further connected to corresponding check writing facilities and debit cards;
supplying plural account holders;
configuring trust units as plural units of ownership of the trust;
selecting plural trust beneficiaries, and constructing at least one sub-trust—with choosing plural service providers to the trust and a non-bank promoter of the trust.

2. The method of paragraph 1, wherein the providing step includes making a master trust agreement that governs the trust and is executed between a trust grantor and a trustee.

3. The method of paragraph 2, further including the step of providing a legal and fiduciary structure that creates a dependency between the trust and at least one sub-trusts.

4. The method of paragraph 3, further including the step of aggregating the funds of each sub-trust into the trust to construct an aggregated pool of assets that can be invested by the trust for the benefit of the sub-trusts.

5. The method of paragraph 2, wherein the trust is chosen from the group consisting of a trust fund, a bankruptcy-remote special purpose company, a structured investment vehicle, and a unit participation trust.

6. The method of paragraph 1, wherein the configuring step involves having purchasers of trust units contribute assets to the trust and receive in exchange a trust note evidencing the fractional ownership interest of each purchaser in the trust based upon the value of the contributed assets.

7. The method of paragraph 3, wherein the configuring step involves converting assets contributed by purchasers into trust units.

8. The method of paragraph 1, wherein the providing step involves providing a unit participation trust governed by a trust agreement that is structured to enable trust beneficiaries to become fractional beneficial owners of the trust corpus and where one unit of the trust equals one unit of a particular currency.

9. The method of paragraph 4, further including the step of providing a legal and fiduciary structure that allows trust units owned by trust-note holders to be redeemed up to the aggregated principal sub-trust account balance.

10. The method of paragraph 9, wherein trust units are redeemed by allowing the exercise of a revolving put option which is defined in the trust agreement.

11. The method of paragraph 9, wherein the step of providing a legal and fiduciary structure requires that the redeemable face value of each trust note is equal at any point in time to the balance in a trust note holder's trust account.

12. The method of paragraph 9, wherein step of providing a legal and fiduciary structure requires that the exercise of a put option equates to the withdrawal of assets from a trust note holder's account.

13. The method of paragraph 9, wherein the step of providing a legal and fiduciary structure requires that the posting of a credit to the trust sub-account of a trust note holder automatically increases the face value of the note by the amount of the credit.

14. The method of paragraph 9, wherein the step of providing a legal and fiduciary structure requires that the posting of a debit to the trust sub-account of the note automatically decreases the value of the note by the amount of the debit.

15. The method of paragraph 9, wherein the step of providing a legal and fiduciary structure requires that the exercise of a put option at any point in time automatically makes another put option that is legally binding on the trust.

16. The method of paragraph 9, wherein the step of providing a legal and fiduciary structure requires that the a put option is exercisable at any time and in any amount, up to the account balance;

17. The method of paragraph 9, wherein the step of providing a legal and fiduciary structure requires that the exercise of a put option does not require the presentation of the original trust note and can be executed electronically by the posting or a debit to the account.

18. The method of paragraph 1, further including the step of providing a trust-like structure to accommodate a plurality of trust beneficiaries, each having individual sub-trust accounts that further permit the embedding of nested sub-accounts for desired users.

19. The method of paragraph 18, further including the step of configuring an account/sub-account structure that is designed to hold balance information for asset values.

20. The method of paragraph 19, wherein the aggregating step allows pre-selected assets to be pledged to obtain a secured credit facility.

21. The method of paragraph 18, further including the step of configuring an account/sub-account structure that is designed to allow individual account holders to join desired networked groups with shared objectives so that individual accounts of group members can be aggregated for investment purposes according to the shared objectives.

22. The method of paragraph 18, further including the step of forming a master trust with a master account that is associated to plural sub-trusts, whereby each sub-trust is configured to facilitate the aggregation of daily account balances into the master account so that the balance thereof can be invested according to a pre-selected strategy.

23. The method of paragraph 22, wherein the forming step involves forming a master account in a desired currency.

24. The method of paragraph 23, wherein the forming step involves forming sub-accounts of a master account in a desired currency.

25. The method of paragraph 1, further including the step of selecting a group of service providers to the trust chosen from the group consisting of an institutional trustee, a custodian, a registrar, a paying agent, a transfer agent, an exchange rate agent, an underwriter, an investment manager, a prime broker/dealer, a credit or debit card issuing bank, a global transaction processor, and a transaction processing settlement vendor and/or platform.

26. The method of paragraph 25, further including the step of providing a communication system that allows each user of the financial system to execute desired orders.

27. The method of paragraph 25, further including the step of providing a legal structure that segregates the duties, responsibilities and authority of each customer and defines them in the trust agreement.

28. The method of paragraph 25, further including the step of providing a communication system for the exchange of data with the customer.

29. The method of paragraph 25, further including the step of providing a system that effects transfer of funds with the customer.

30. The method of paragraph 1, further including the step of selecting a bank or a non-bank promoter who promotes its own brand of revenue-producing debit cards with a demand deposit checking account feature.

31. The method of paragraph 30, wherein the promoter is a non-banking institution chosen from the group consisting of a business entity, an affinity group, a consumer group, an employer, a labor union, a retailer, a church, a non-profit organization, and a hospital.

32. The method of paragraph 30, wherein the promoter establishes a trust, chosen from the group consisting of a unit participation trust and a sub-trust of a master unit participation trust, for the purpose of operating a bank to be able to offer bank customers an alternative money-making banking product.

33. The method of paragraph 30, further including the step of providing a system to create an independent trust for each trust sponsor.

34. The method of paragraph 33, wherein each independent trust is chosen from the group consisting of a unit participation trust and a sub-trust of a master unit participation trust.

35. The method of paragraph 32, wherein the promoter engages in banking through the adoption of a pre-selected master trust agreement.

36. The method of paragraph 33, wherein the promoter is chosen from the group of bank and non-banking entities, employers, affinity groups, labor unions, retailers, church organizations, non-profit organizations, and governmental entities.

37. The method of paragraph 30, further including a legal structure that allows each trust to become a sub-trust of the master trust.

38. The method of paragraph 37, further including the step of creating a trust sub-account for each trust note holder.

39. The method of paragraph 37, wherein the constructing step involves constructing the sub-account with two balances, one for cash and one for illiquid assets.

40. The method of paragraph 37, wherein the constructing step involves constructing the sub-account in a desired currency.

41. The method of paragraph 37, further including the step of using a switch to connect the sub-account with a debit card.

42. The method of paragraph 37, further including the step of using a switch to connect each sub-account with a corresponding net-zero, pass-through bank account.

43. The method of paragraph 37, further including the step of using a switch to connect each net-zero, pass-through bank account to one of the group consisting of a debit card and a check, that may be presented for payment against the net-zero pass-through bank account.

44. The method of paragraph 30, further including the step of aggregating the assets of each trust account into the master trust account.

45. The method of paragraph 30, further including the step of disaggregating the assets of each trust account into the master trust account.

46. The method of paragraph 45, wherein the disaggregating includes the initial balance of each trust account and any additional proportional profit earned on the investments of each trust.

47. The method of paragraph 30, further including the step of aggregating the assets of each trust account and sub-account to the trust.

48. The method of paragraph 30, further including the step of disaggregating the assets of each trust account and sub-account to the trust.

49. The method of paragraph 45, wherein the disaggregating includes the initial balance of each trust account and any additional proportional profit earned on the investments of each trust.

50. The method of paragraph 30, further including the step of consolidating the assets of each sub trust into the master trust.

51. The method of paragraph 1, further including the step of providing a trust that facilitates the swap of assets in exchange for trust units.

52. The method of paragraph 51, wherein the fractional beneficial interest of a trust unit is evidenced by the issuance of a trust note which is delivered to the account holder upon the opening of an account.

53. The method of paragraph 51, wherein each trust unit is transferable and redeemable by the note holder at any time, in whole or in part.

54. The method of paragraph 51, wherein note holders of one of the trusts are fractional beneficial owners of the corresponding trust up to the value of initial contribution of the note holder.

55. The method of paragraph 51, wherein each note holder has the right to purchase additional trust units by depositing assets to the account of the note holder.

56. The method of paragraph 51, wherein the face value of a note changes with each transaction that is posted to it.

57. The method of paragraph 51, wherein the face value of a note is determined at any point in time by deducting the total of all debits posted to the account of the trust unit holder from the total of all credits posted to it.

58. The method of paragraph 1, wherein the financial system includes plural unit participation trusts that are interconnected with each other by the adoption of a standardized set of pre-selected agreements, terms and conditions, including a trust agreement.

59. The method of paragraph 1, wherein funds of the plural unit participation trusts are capable of being aggregated regularly to earn revenue on the aggregate amount in the master trust.

60. The method of paragraph 1, wherein each unit participation trust has identical rules regarding permitted investments.

61. The method of paragraph 1, wherein excess liquidity in one unit participation trust is capable of being transferred to another unit participation trust without incurring significantly different investment risk.

62. The method of paragraph 1, wherein the transferor unit participation trust has excess liquidity.

63. The method of paragraph 1, wherein the transferee unit participation trust has a liquidity deficit.

64. The method of paragraph 1, wherein the unit participation trusts are capable of holding both liquid and illiquid assets.

The specific embodiments of the invention as disclosed and illustrated herein are not to be considered in a limiting sense as numerous variations are possible. The subject matter of this disclosure includes all novel and non-obvious combinations and sub-combinations of the various features, elements, methods, functions and/or properties disclosed herein. No single feature, function, element or property of the disclosed embodiments is essential. The following paragraphs define certain combinations and sub-combinations which are regarded as novel and non-obvious. Other combinations and sub-combinations of features, functions, elements, methods and/or properties may be paragraphed through amendment of the present paragraphs or presentation of new paragraphs in this or a related application. Such paragraphs, whether they are different, broader, narrower or equal in scope to the original paragraphs, are also regarded as included within the subject matter of the disclosure.

I claim:

1. A revenue-producing, charge card system that also manages account balances to create an investment profit for the card holder, comprising:
a trust account having a trust-account balance reflecting a first amount of funds, being constructed to subsequently record debits and credits related to the balance, and being constructed for access via remote communication;
a bank account having a bank-account balance reflecting an initial zero balance, being constructed to further record debits and credits related to the balance, and being constructed for access via remote communication;
a debit card constructed for communication with the trust account and the bank account;
a switch in communication between the trust account and bank account; and
wherein the trust account and the bank account are constructed for intercommunication via the switch so that a card user can pass debits and credits to the trust account through the bank account so that the funds of the trust account can be managed via the trust account.

2. The system of claim 1, wherein the debit card is issued by a licensed banking institution but the promoter, marketer, distributor, or sponsoring entity is not a bank.

3. The system of claim 2, wherein the entity is chosen from the group consisting of an individual, a non-profit entity; a for-profit entity; a governmental organization or non-governmental organization.

4. The system of claim 3, wherein the for-profit entity is an employer and the debit card is issued to an employee of the employer.

5. The system of claim 4, wherein the debit card is configured to allow the employee to charge business travel expenses to the employer.

6. The system of claim 2, wherein the debit card is co-branded with the name of the entity and the name of a bank that issues the debit card.

7. The system of claim 1, wherein the trust account and its dependent accounts are configured to allow funds that remain in the trust account outside banking hours to be swept out for short term investment and swept back and posted in the account at the opening of the next banking day.

8. The system of claim 1, wherein the trust account includes a user-specific sub-trust account having a sub-trust account balance reflecting a third amount of funds and being constructed to post debits and credits to the sub-trust account.

9. The system of claim 8, wherein each sub-trust account is configured to accommodate an unlimited number of nested sub-accounts and where each primary sub-account and nested sub-account specify permitted investments that allow funds to be aggregated at a trust level and invested in permitted investments that maximize returns through the application of pre-selected investment strategies that continuously invest funds.

10. The system of claim 8, wherein the sub-trust account and each nested sub-account is set up and configured to: (a) receive cash for crediting the user-specific sub-account; (b) post credits for at least one of the following: cash, cash equivalent securities, non-liquid assets (e.g. equity in a home or the value of a stock portfolio), or any combination thereof; and (c) is configured to provide cash to settle charges resulting from card transactions of the cardholder.

11. The system of claim 10, wherein the credits of cash include regularly recurring deposits.

12. The system of claim 13, wherein the regularly recurring deposits (credits) comprise at least one of payroll check deposits or social security check deposits.

13. The system of claim 8, wherein the user-specific sub-trust account is also set up to provide for the withdrawal of cash to settle charges resulting from retail, banking and ATM transactions executed via the use of the debit card.

14. The system of claim 8, wherein the bank account is configured for pass-through activity and record-keeping only in such a way that at all times the balance in the bank account is zero and where such account is specifically set up to book a simultaneous credit and a debit for the exact amount of the charge (debit) made on the debit card.

15. The system of claim 14, wherein plural sub-trust accounts and plural nested sub-accounts are set up and configured to: (a) receive cash for crediting the user-specific sub-account; (b) post credits for at least one of the following: cash, cash equivalent securities, non-liquid assets (e.g equity in a home or the value of a stock portfolio), or any combination thereof; and (c) are configured to provide cash to settle charges resulting from card transactions of the corresponding cardholder.

16. The system of claim 15, wherein the bank account is configured to report information regarding debit card usage for the debit card linked to that bank account.

17. The system of claim 16, wherein the bank account is further set up to report all debit card transactions for the debit card linked to that bank account on a regularly recurring basis.

18. The system of claim 10, wherein the bank account is further set up to regularly report the profits of the corresponding sub-trust account on a recurring basis.

19. The system of claim 10, wherein the trust account includes multiple sub-trust accounts;
wherein the sub-trust accounts are respectively linked to a corresponding bank account via said switch; and
wherein funds of the sub-trust accounts are seamlessly aggregated on a regular basis; and
wherein the aggregated amount of all sub-account balances can be invested to earn revenue from investing in “permitted investments” and for overnight permitted sweep investments.

20. The system of claim 19, wherein one or more sub-trust accounts of the multiple sub-trust accounts are respectively set up to have their own sub-trust accounts so as to be nested by the one or more sub-trust accounts.

21. The system of claim 20, wherein one or more of the nested sub-trust accounts are set up to have their funds aggregated on a regular basis to earn revenue from investing the aggregate amount of the funds.

22. The system of claim 21, wherein the debit card corresponding to a particular bank account linked to a nesting sub-trust account earns a return from the aggregation of funds for investment at the nesting sub-trust level.

23. The system of claim 19, wherein the debit card corresponding to a particular bank account earns a return from the aggregation of funds for investment at the trust level.

24. The system of claim 10, further including system infrastructure that includes said switch to link the bank account and trust sub-account so as to allow information and/or debits and credits to flow among the linked accounts and between the linked accounts and a temporary transaction settlement account.

25. The system of claim 24, wherein the system infrastructure includes a Transaction Processing Backbone that includes said switch.

26. The system of claim 24, wherein the settlement transaction account is set up to receive credits from multiple sub-trust accounts and to settle debit card transactions for debit cards linked to corresponding bank accounts.

27. The system of claim 1, wherein the bank account comprises at least one of the following: a demand deposit account; a money market account; a savings account; or a business bank account.

28. The system of claim 1, wherein the bank account comprise a bank account with a check writing capability.

29. The system of claim 24, wherein the trust account includes a user-specific sub-trust account set up so as to segregate: (a) a reserve which is available at all times for settlement of debit card transactions, and (b) an investment account for funds in the sub-trust account beyond the reserve to be aggregated at the trust level and to be invested in permitted investments of the trust.

30. The system of claim 24, wherein the system infrastructure is set up to link multiple user-specific sub-trust accounts having different names and/or legal beneficiaries.

31. The system of claim 24, wherein said system infrastructure is further set up to allow a deposit to a sub-trust account to be posted as follows: (a) a credit to the particular sub-trust account of the depositor; (b) a debit to a master cash account of the trust; and (c) a debit and an immediately offsetting credit to the corresponding bank account linked to the particular sub-trust account via said switch.

32. The system of claim 24, wherein said system infrastructure is further configured and set up to allow a charge made on a debit card to be posted as follows: (a) a debit to the sub-trust account linked to the bank account corresponding to the debit card; (b) a credit to the merchant settlement account; and (c) a debit and an offsetting credit to the bank account corresponding to the debit card and linked to the sub-trust account via said switch.

33. The system of claim 24, wherein said system infrastructure is further set up, for a debit card purchase transaction, to access via said switch the available balance of the sub-trust account linked to the bank account corresponding to the particular debit card and to compare the available balance with the amount of the debit card purchase transaction for authentication and acceptance, if the available balance is sufficient, or, for denial, if the available balance is not sufficient.

34. The system of claim 33, wherein, as between the bank account and the sub-trust account linked by said system infrastructure, said switch of said system infrastructure is set up to route debit card purchase transactions to the account with a higher available balance.

35. The system of claim 1, wherein the trust account comprises at least one of the following: a general, all-purpose unit participation trust, an auction participation trust, a home equity loan participation trust, a real estate deposit participation trust, a commercial equipment lease deposit participation trust, a college savings plan participation trust, a brokerage cash participation trust, a retirement fund participation trust, an endowment fund participation trust, a probate funds participation trust, an escrow participation trust, and/or a health savings participation trust.

36. The system of claim 1, wherein the charge card is chosen from the group consisting of a debit card, a prepaid card, a stored value card, a gift card, a payroll card, and a health savings card.

37. The system of claim 28, wherein the bank account is configured to provide a credit card to the account holder that is connected to the bank account.

38. The system of claim 28, wherein the bank account is configured to provide a credit card to the account holder that is not connected to the bank account.

39. The system of claim 28, wherein the bank account is configured to provide to the account holder, a card chosen from the group consisting of a prepaid card, a stored-value card, and a gift card, and the card is connected to the bank account.

40. The system of claim 28, wherein the bank account is configured to provide to the account holder, a card chosen from the group consisting of a prepaid card, a stored-value card, and a gift card, and the card is not connected to the bank account.
